(19) United States
(12) Patent Application Publication
(10) Pub. No.: US 2026/0220200 A1
(43) Pub. Date: Jul. 30, 2026

(54) GRAPH-BASED MODELS WITH PROXY NODES

(71) Applicant: Infosys Limited, Bangalore (IN)

(72) Inventor: Steven SCHILDERS, Columbus, IN (US)

(73) Assignees: Infosys Limited, Bangalore, KA (IN); InvertIT INC., Columbus, IN (US)

(21) Appl. No.: 19/041,388

(22) Filed: Jan. 30, 2025

(51) Int. Cl. G06F 16/901

(52) U.S. Cl. CPC G06F 16/9024

(57) ABSTRACT

An overlay system is provided that includes a storage element and processing circuitry coupled thereto. The storage element stores an executable graph-based model having various active nodes. The processing circuitry may receive a stimulus associated with the overlay system and identify, based on the stimulus, an active node. Further, the processing circuitry may generate a proxy node for the active node. The proxy node includes a reference to the active node. The processing circuitry may implement the proxy node in the executable graph-based model by way of an actor interface. Further, the processing circuitry may store the first proxy node in a primary storage of the storage element. Additionally, as a response to the first stimulus, the processing circuitry may unload the first active node from the executable graph-based model.

### FIELD OF THE DISCLOSURE

Various embodiments of the present disclosure relate generally to graph-based models. More specifically, various embodiments of the present disclosure relate to loading and unloading of nodes in executable graph-based models.

### BACKGROUND

Graph-based models have become a cornerstone of modern technology, offering an intuitive and efficient way to represent complex systems in various domains such as marketing, research, social networks, and recommendation engines. These graph-based models encapsulate entities as nodes and their interconnections as edges, enabling seamless visualization and analysis of relationships and dependencies. However, practical implementations of such models often demand the representation of countless entities, which results in an exponentially high number of nodes. For example, in a marketing application, customers, products, and transactions may each correspond to separate nodes. Similarly, in social networks, every user, post, and interaction could be modeled as distinct elements. This sheer scale of nodes presents significant implementation challenges.

One of the primary issues with large-scale graph-based models is their excessive consumption of computational and storage resources. Each node, along with its associated data and relationships, requires considerable storage space. Furthermore, operations such as querying, traversals, and updates become computationally intensive, leading to increased processing times, higher latency, and elevated energy costs. Scaling these models to accommodate growing datasets often necessitates complex system architectures and distributed processing, which further amplifies resource requirements. Consequently, these factors drive up the overall cost of implementation, making such graph-based technologies impractical for many real-world applications, especially those with limited budgets or operating in resource-constrained environments.

Additionally, the need to keep all nodes loaded and accessible at all times exacerbates the inefficiencies of graph-based systems. Continuous accessibility increases memory usage, making it challenging to manage systems with large datasets. These limitations reduce the scalability and usability of graph models, as the cost of deployment and maintenance often outweighs the benefits of their application.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating proxy nodes in executable graph-based models are provided substantially as shown in, and described in connection with, at least one of the figures.

The methods and systems described herein provide an overlay system. The overlay system includes processing circuitry and a storage element coupled to the processing circuitry. The storage element is configured to store an executable graph-based model that includes a plurality of active nodes. The processing circuitry is configured to receive a first stimulus associated with the overlay system. The processing circuitry is further configured to identify, based on the first stimulus, a first active node of the plurality of active nodes. The processing circuitry is further configured to generate a first proxy node for the first active node. The first proxy node includes a reference to the first active node. The processing circuitry is further configured to implement the first proxy node in the executable graph-based model by way of a first actor interface. The processing circuitry is further configured to store the first proxy node in a primary storage of the storage element. The processing circuitry is further configured to unload, as a response to the first stimulus, the first active node from the executable graph-based model.

In some embodiments, the reference to the first active node corresponds to a storage location of a node state of the first active node. The node state includes data required to load the first active node in the executable graph-based model.

In some embodiments, the first active node is unloaded from the executable graph-based model to a secondary storage of the storage element.

In some embodiments, the processing circuitry is further configured to receive a second stimulus associated with the overlay system. The second stimulus is indicative of a loading operation. The processing circuitry is further configured to identify the first active node associated with the second stimulus. The processing circuitry is further configured to access the first actor interface based on the identification of the first active node. The processing circuitry is further configured to identify the first proxy node based on the first actor interface. The processing circuitry is further configured to retrieve a node state of the first active node based on the first proxy node. The processing circuitry is further configured to load, as a response to the second stimulus, the first active node in the primary storage of the executable graph-based model based on the retrieved node state.

In some embodiments, the processing circuitry is further configured to identify a second active node that is associated with the first active node. The processing circuitry is further configured to load, based on the loading of the first active node, the second active node in the primary storage of the executable graph-based model.

In some embodiments, the executable graph-based model further includes a plurality of overlay nodes. The processing circuitry is further configured to identify, from the plurality of overlay nodes, a first overlay node that is associated with the first active node. The processing circuitry is further configured to generate a second proxy node for the first overlay node. The processing circuitry is further configured to implement the second proxy node in the executable graph-based model by way of a second actor interface. The processing circuitry is further configured to store the second proxy node in the primary storage of the storage element. The processing circuitry is further configured to unload, based on the unloading of the first active node, the first overlay node from the executable graph-based model.

In some embodiments, based on the first active node being loaded in the executable graph-based model, the processing circuitry is further configured to associate the first active node with the second actor interface.

In some embodiments, based on the first active node being loaded in the executable graph-based model, the processing circuitry is further configured to load the first overlay node in the primary storage of the executable graph-based model using the second actor interface.

In some embodiments, the first active node is associated with an overlay manager. The overlay manager is configured to maintain an overlay ledger including an entry for the second actor interface linked with a functionality of the first overlay node that is associated with the second proxy node.

In some embodiments, the first proxy node is associated with a corresponding node status indicator. The node status indicator indicates one of a group consisting of (i) a storage location of a node state of the first active node which includes data required to load the first active node, or (ii) a load status indicative of the first active node being stored in the primary storage.

In some embodiments, based on the storage location of the node state of the first active node being included in the node status indicator, the node status indicator indicates that the first active node is unloaded and stored in a secondary storage of the storage element. Based on the load status being included in the node status indicator, the node status indicator indicates that the first active node is loaded in the executable graph-based model.

In some embodiments, the first active node corresponds to one of a group consisting of a generic node, a generic run-time node, a bi-directional node, or a run-time bi-directional node.

In some embodiments, the processing circuitry is further configured to identify at least a first attribute associated with the first active node. The processing circuitry is further configured to generate an attribute proxy for the first attribute. The processing circuitry is further configured to implement the attribute proxy in the executable graph-based model by way of an attribute actor interface. The processing circuitry is further configured to store the attribute proxy in the primary storage. The processing circuitry is further configured to unload, based on the unloading of the first active node, the first attribute from the executable graph-based model.

In some embodiments, based on the first active node being loaded in the executable graph-based model, the processing circuitry is further configured to associate the first active node with the attribute actor interface.

In some embodiments, based on the first active node being loaded in the executable graph-based model, the processing circuitry is further configured to load the first attribute in the primary storage of the executable graph-based model using the attribute actor interface.

In some embodiments, the processing circuitry is further configured to identify, from the plurality of active nodes, a second active node that is associated with the first active node. The processing circuitry is further configured to unload, based on the unloading of the first active node, the second active node.

In some embodiments, the executable graph-based model further includes a plurality of overlay nodes. The processing circuitry is further configured to identify, from the plurality of overlay nodes, a second overlay node that is associated with the second active node. The processing circuitry is further configured to unload, based on the unloading of the second active node, the second overlay node from the executable graph-based model.

In some embodiments, the processing circuitry is further configured to identify at least a second attribute associated with the second active node. The processing circuitry is further configured to unload, based on the unloading of the second active node, the second attribute from the executable graph-based model.

In some embodiments, the first active node inherits the second active node.

In some embodiments, the first active node has a dependency with the second active node. The dependency is one of a group consisting of an own-owned dependency, a share-shared dependency, or a use-used dependency.

In some embodiments, the first active node corresponds to a first node instance that corresponds to an implementation of a predefined node structure, and the second active node corresponds to a first node template that corresponds to the predefined node structure. The first active node and the second active node, collectively, constitute a run-time node.

In some embodiments, the first proxy node includes a reference to a third proxy node and the first actor interface includes a reference to a third actor interface. The third proxy node is generated for the first node template, and the third proxy node is implemented in the executable graph-based model by way of the third actor interface.

In some embodiments, based on the first active node being loaded in the executable graph-based model, the processing circuitry is further configured to load the second active node in the primary storage of the executable graph-based model using the third actor interface.

In some embodiments, the executable graph-based model further includes a plurality of connection links. The first active node corresponds to a bi-directional node, and is associated with the second active node by way of a connection link, of the plurality of connection links. The connection link includes an outward connection object that is associated with the first active node and an inward connection object that is associated with the second active node. The outward connection object is indicative of a primary role associated with the first active node and the inward connection object is indicative of a secondary role associated with the second active node. The primary role and the secondary role, collectively, indicate a capacity in which the first active node is associated with the second active node.

In some embodiments, the processing circuitry is further configured to identify the connection link associated with the first active node. The processing circuitry is further configured to generate an outward connection object proxy for the outward connection object, and an inward connection object proxy for the inward connection object. The processing circuitry is further configured to implement the outward connection object proxy and the inward connection object proxy in the executable graph-based model by way of a fourth actor interface and a fifth actor interface, respectively. The processing circuitry is further configured to store the outward connection object proxy and the inward connection object proxy in the primary storage. The processing circuitry is further configured to unload, based on the unloading of the first active node, the outward connection object and the inward connection object from the executable graph-based model.

In some embodiments, the second active node is unloaded further based on the unloading of the outward connection object and the inward connection object.

In some embodiments, at least one of the group consisting of the outward connection object or the inward connection object is associated with a set of attributes. The set of attributes associated with the outward connection object pertains to a first loading strategy associated with the first active node. The set of attributes associated with the inward connection object pertains to a second loading strategy associated with the second active node. The first loading strategy and second loading strategy are one of a group consisting of a proactive loading strategy or a lazy loading strategy.

In some embodiments, a method is provided. The method comprises receiving, by processing circuitry of an overlay system, a stimulus associated with the overlay system. The method comprises an executable graph-based model that is stored in a storage element of the overlay system. The storage element is coupled with the processing circuitry. The executable graph-based model includes a plurality of active nodes. The method further comprises identifying, by the processing circuitry, based on the stimulus, a first active node of the plurality of active nodes. The method further comprises generating, by the processing circuitry, a proxy node for the first active node. The proxy node includes a reference to the first active node. The method further comprises implementing, by the processing circuitry, the proxy node in the executable graph-based model by way of an actor interface. The method further comprises storing, by the processing circuitry, the proxy node in a primary storage of the storage element. The method further comprises unloading, by the processing circuitry, as a response to the stimulus, the first active node from the executable graph-based model.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, consistent with disclosed embodiments of the present disclosure;

FIG. 2 is a block diagram that illustrates a system environment of an overlay system for execution, management, and configuration of the executable graph-based model, consistent with disclosed embodiments of the present disclosure;

FIG. 3A is a block diagram that illustrates a standard structure of a generic node within the executable graph-based model, consistent with disclosed embodiments of the present disclosure;

FIG. 3B is a block diagram that illustrates a standard structure of a generic run-time node within the executable graph-based model, consistent with disclosed embodiments of the present disclosure;

FIG. 3C is a block diagram that illustrates a standard structure of a bi-directional node within the executable graph-based model, consistent with disclosed embodiments of the present disclosure;

FIG. 3D is a block diagram that illustrates a standard structure of a run-time bi-directional node within the executable graph-based model, consistent with disclosed embodiments of the present disclosure;

FIG. 4A is a block diagram that illustrates an executable generic node within the executable graph-based model, consistent with disclosed embodiments of the present disclosure;

FIG. 4B is a block diagram that illustrates an executable generic run-time node within the executable graph-based model, consistent with disclosed embodiments of the present disclosure;

FIG. 4C is a block diagram that illustrates an executable bi-directional node within the executable graph-based model, consistent with disclosed embodiments of the present disclosure;

FIG. 5 is a block diagram that illustrates a composition of the executable generic node that enables persistent storage of data and processing logic associated therewith, consistent with disclosed embodiments of the present disclosure;

FIG. 6 illustrates a graph that depicts a concept of unloading generic nodes from the executable graph-based model based on associated proxy nodes, consistent with disclosed embodiments of the present disclosure;

FIG. 7 illustrates a graph that depicts a concept of unloading generic run-time nodes based on associated proxy nodes, consistent with disclosed embodiments of the present disclosure;

FIG. 8 illustrates a graph that depicts a concept of unloading bi-directional nodes based on associated proxy nodes, consistent with disclosed embodiments of the present disclosure;

FIG. 9 illustrates a graph that depicts various features of unloading of run-time bi-directional nodes based on associated proxy nodes, consistent with disclosed embodiments of the present disclosure;

FIG. 10 illustrates a graph that depicts a security system implemented using the executable graph-based model, consistent with disclosed embodiments of the present disclosure;

FIG. 11 shows an example computing system for carrying out methods of the present disclosure, consistent with disclosed embodiments of the present disclosure;

FIG. 12 illustrates a flowchart of a method of unloading a first active node based on a proxy node, consistent with disclosed embodiments of the present disclosure; and

FIG. 13 illustrates a flowchart of a method of loading the first active node based on the proxy node, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

With technological advancements, graph-based models have become a vital tool for representing complex systems and their interconnections. Widely used in fields such as marketing, research, social networks, recommendation systems, and logistics, these models efficiently represent entities as nodes and their relationships as edges. This structure facilitates effective visualization and querying of patterns, dependencies, and interactions. However, implementing such models in real-world scenarios often necessitates a vast number of nodes to accurately represent entities and their connections. For instance, in marketing, individual nodes might represent customers, products, and transactions, while in research or social networking, nodes could correspond to documents, keywords, or users.

As the scale of these systems increases, the number of nodes expands dramatically, presenting significant challenges. Managing a graph with an immense number of nodes requires substantial computational and storage resources, often overwhelming modern graph databases and processing systems. The need for real-time accessibility and constant updates intensifies resource demands, leading to bottlenecks. Additionally, each node's data and connections occupy considerable storage, driving up costs. Operations such as querying and traversals become increasingly time-consuming and resource-intensive, impacting system performance and scalability. Expanding these models to handle larger datasets often requires complex architectures and distributed systems, further adding to the expense and complexity of implementation.

Presently, the graph-based models allow for a node, that is not being used currently, to be unloaded from the executable graph-based model. The node may be loaded again in the executable graph-based model based on a requirement thereof. For loading the node in the executable graph-based model, the node may be re-generated using a manifest thereof that includes a storage address of a node state of the node. The node state may include information required for the re-generation of the node. However, loading the node using such an approach may lead to wait time and induce latency in operations associated with the node.

These limitations make graph-based models less practical for applications constrained by resources or budgets, as the costs of implementation outweigh the benefits. Addressing these issues requires innovative strategies to reduce resource consumption without compromising performance.

The present disclosure is directed to facilitation of proxy nodes in an executable graph-based model of an overlay system. The executable graph-based model is a customized hypergraph with hyper-edges that are realized by way of executable nodes. Each executable node is associated with a particular node-type. For example, an edge node corresponds to a base node with an edge node-type. Nodes (for example, base nodes and executable nodes) are connected with other nodes by way of roles included in an edge node therebetween. In some embodiments, roles are represented by way of nodes of role node-type. A role node between two nodes may be indicative of a context regarding an association therebetween. The executable graph-based model also includes a plurality of overlay nodes that incorporate in-situ features in the overlay system. Each overlay node is associated with one or more nodes (for example, a vertex node, an edge node, or the like) of the executable graph-based model and includes a corresponding processing logic that when executed implements a functionality thereof on the associated nodes. Hence, the processing logic is implemented within the executable graph-based model and is not required to be retrieved from any external system.

The overlay system disclosed herein facilitates proxy nodes in the executable graph-based model. The executable graph-based model may include a plurality of nodes (for example, a plurality of active nodes) such that each node may be associated with corresponding data and/or processing logic. Therefore, the node may consume a significant number of resources (for example, storage, processing capacity, or the like) while being loaded in the executable graph-based model. In order to reduce such excessive use of resources without inducing any latency in the overlay system, the disclosed system allows for the generation of a proxy node for the node. The proxy node may represent the node in the executable graph-based model. Further, the proxy node may be implemented in the executable graph-based model by way of an associated actor interface. The actor interface may act as an interface to the proxy node. Therefore, a user of the overlay system may access the node by way of the actor interface. Therefore, the user has an illusion that the node is loaded in the executable graph-based model when in actuality the node may be unloaded from the executable graph-based model and stored in a secondary storage element of the overlay system. An operation associated with the node may cause the node to be loaded in the executable graph-based model. For loading the node, based on the user accessing the actor interface, the proxy node may be accessed. The proxy node may include a reference to the node in the form of a storage location of a node state of the node. The node state may be used to re-generate the node in the executable graph-based model.

Thus, even when the node may be unloaded from the executable graph-based model, the proxy node implemented by way of the actor interface gives an illusion of the node being loaded in the executable graph-based model. Therefore, the node may be unloaded from the executable graph-based model without having to induce any significant latency, associated with the loading of the node, in the executable graph-based model, every time the node may be referred to. Notably, the node may be loaded only when an operation may be required to be executed thereon. Therefore, by way of the implementation of the proxy node, the node may be loaded as and when required while having the illusion of the node being already loaded. Therefore, the overlay system may exhibit optimal utilization of the resources (for example, the processing capability, storage capacity, time, or the like).

### Figure Description

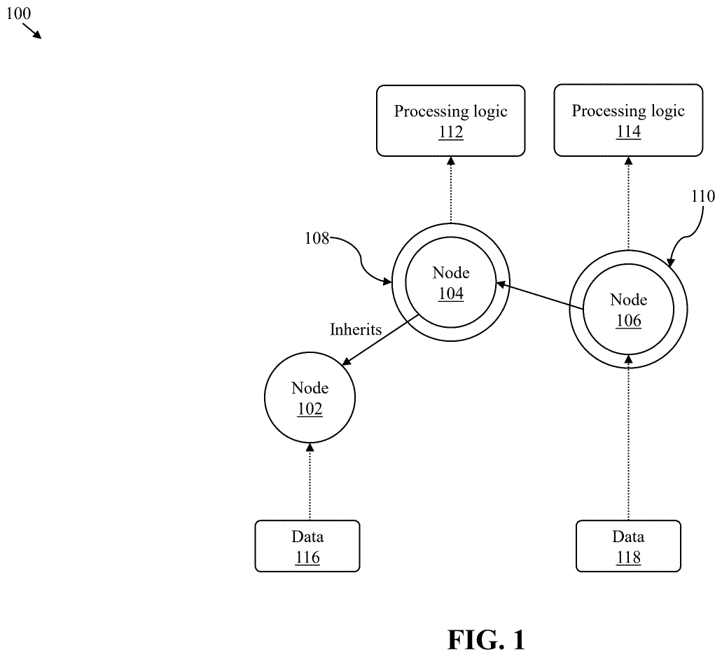

FIG. 1 is a graph that illustrates a composition of an executable graph-based model 100, consistent with disclosed embodiments of the present disclosure. Referring to FIG. 1, the executable graph-based model 100 is generally formed of a data structure (e.g., a graph-based model or a graphical model) comprising a plurality of nodes 102-106 which can be functionally extended with processing logic via the use of overlays. For example, as shown in FIG. 1, the nodes 104 and 106 are functionally extended with processing logic via the use of overlay nodes 108 and 110, respectively. Although not shown, the node 102 can be similarly extended with processing logic via the use of one or more overlays. Each overlay includes processing logic, such as processing logic 112 and 114 which are associated with the overlay nodes 108 and 110, respectively. At run-time, data, such as data 116 and 118, is associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

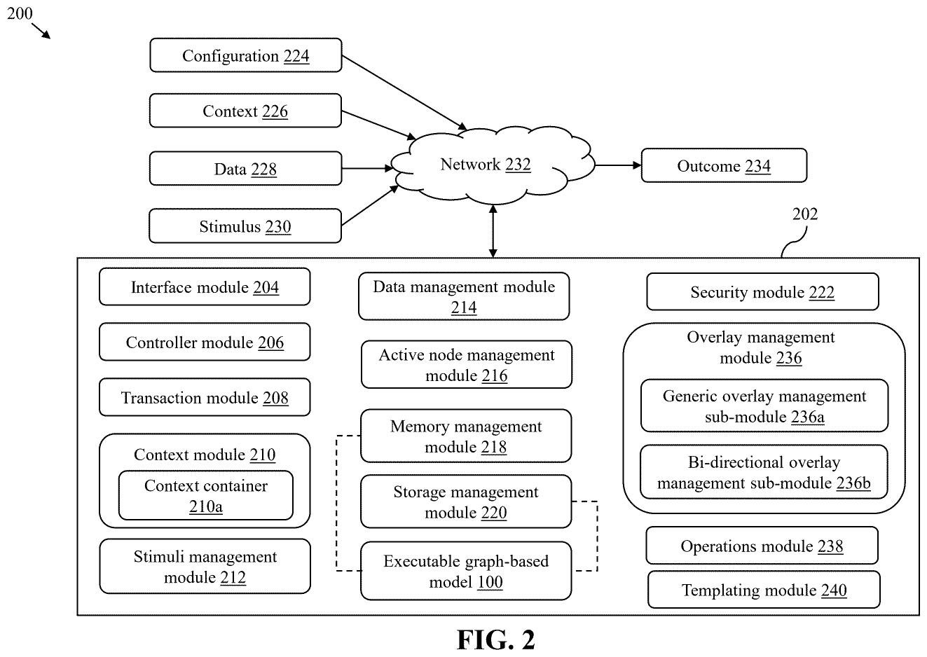

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2). Throughout the description, the terms “overlay node” and “overlay” are used interchangeably.

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 applies to a range of time-critical systems where efficient processing of the stimuli is required.

FIG. 2 is a block diagram that illustrates a system environment 200 of an overlay system 202 for execution, management, and configuration of the executable graph-based model 100, consistent with disclosed embodiments of the present disclosure. Referring to FIG. 2, the overlay system 202 includes the executable graph-based model 100. The overlay system 202 further includes an interface module 204, a controller module 206, a transaction module 208, a context module 210, a stimuli management module 212, a data management module 214, an active node management module 216, a memory management module 218, a storage management module 220, and a security module 222. FIG. 2 further shows a configuration 224, a context 226, data 228, a stimulus 230, a network 232, and an outcome 234. Additionally, the overlay system 202 of the present disclosure includes an overlay management module 236, an operations module 238, and a templating module 240. In some embodiments, all the modules of the overlay system 202 except for the executable graph-based model 100 may collectively form processing circuitry that facilitates operations associated with a plurality of active nodes of the executable graph-based model 100. The plurality of active nodes may include generic nodes, generic run-time nodes, bi-directional nodes, and bi-directional run-time nodes.

A generic node may refer to a node, in the executable graph-based model 100, with an edge node-type, a role node-type, an overlay node-type, or a vertex node-type. A generic node with the vertex node-type is coupled to another generic node with the vertex node-type by way of a node with the edge node-type indicative of a role of the generic node. A generic run-time node may include a node template and a node instance. The node template may be a predefined node structure and the node instance may be an implementation of the predefined node structure. The generic run-time node may have an edge node-type, a role node-type, an overlay node-type, or a vertex node-type. A generic run-time node with the vertex node-type is coupled to another generic run-time node with the vertex node-type by way of a node with the edge node-type indicative of a role of the generic run-time node. A bi-directional node refers to a node with an edge node-type that associates with another bi-directional node by way of a connection link that includes a primary role for the bi-directional node and a secondary role for the other bi-directional node. In addition to the edge node-type, the bi-directional node may also have a vertex node-type, a role node-type, or an overlay node-type. A run-time bi-directional node may include a node template and a node instance. The node template may be a predefined node structure of the run-time bi-directional node and the node instance may be an implementation of the predefined node structure. The run-time bi-directional node refers to a node with an edge node-type that associates with another run-time bi-directional node by way of a run-time connection link that may include a primary role for the run-time bi-directional node and a secondary role for the other run-time bi-directional node. In addition to the edge node-type the run-time bi-directional node may also have a vertex node-type, a role node-type, or an overlay node-type.

The overlay system 202 may include suitable logic, circuitry, interfaces, and/or code, executable by the circuitry, that may be configured to facilitate one or more operations associated with the active nodes in the executable graph-based model 100.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts (such as the context 226) provide the basis for all interactions within the executable graph-based model 100. Processing of such stimuli may lead to the execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to the processing of the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. Maintaining system integrity via the controller module 206 and the transaction module 208 allows a transaction to be rolled back in an event of an expected or unexpected software or hardware fault or failure. The controller module 206 is configured to handle the processing of the stimulus 230 and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 is associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as username, password, access token, device information, time stamp, one or more relevant identifiers (IDs), or the like, that are required for processing of the stimulus 230 within the executable graph-based model 100. Each context within the overlay system 202 may be extended to include additional information that is required for the processing of the stimulus (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context. In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

As shown, the context module 210 includes a context container 210a that includes a set of defined contexts. Each defined context of the set of defined contexts pertains to a context that is associated with one or more operations for facilitating application and management of the plurality of nodes (for example, the bi-directional nodes) in the overlay system 202. That is to say that one or more contexts of the set of defined contexts are indicative of the one or more operations to be executed by way of one or more bi-directional nodes in the overlay system 202. The one or more operations are executed when a context of a corresponding stimuli matches one of the set of defined contexts.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IOT) device. As previously stated, a stimulus (such as the stimulus 230) can be either externally or internally generated. In an example, the stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another example, the stimulus 230 may be externally triggered and may be generated based on an input received via a user interface associated with the controller module 206. The externally triggered stimulus 230 may be received in the form of a signal, a textual, audio, or visual input. The externally triggered stimulus 230 may be associated with the intent of a user to execute an operation indicated by the stimulus 230. The operation is executed in accordance with information included in the context 226 associated with the stimulus 230.

The stimuli management module 212 may receive the stimuli (such as the stimulus 230) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of data associated with each stimulus. In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on processing of data by any of its nodes. In some examples, the processing of a stimulus (such as the stimulus 230) results in the generation, communication, or processing of data that further results in one or more outcomes (e.g., the outcome 234) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 238 of the overlay system 202.

The data management module 214 may include suitable logic, circuitry, interfaces, and/or code, executable by the circuitry, configured to manage all data or information within the overlay system 202 (e.g., the data 228) for a given application. Operations performed by the data management module 214 include data loading, data unloading, data modeling, and data processing. The data management module 214 is communicatively coupled (e.g., connected either directly or indirectly) to one or more other modules within the overlay system 202 to complete some or all of these operations. For example, data storage is handled by the data management module 214 in conjunction with the storage management module 220.

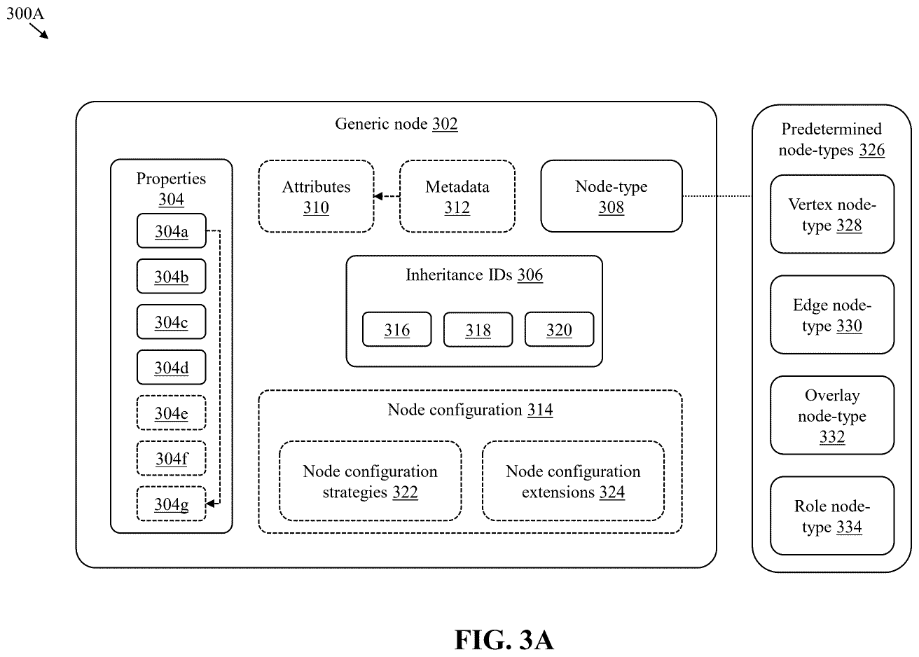

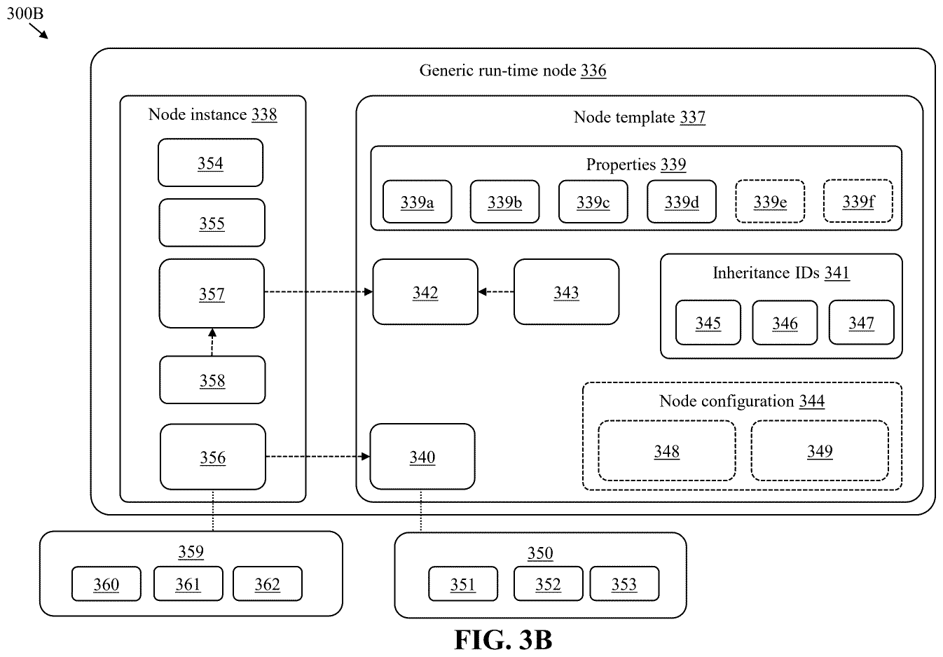

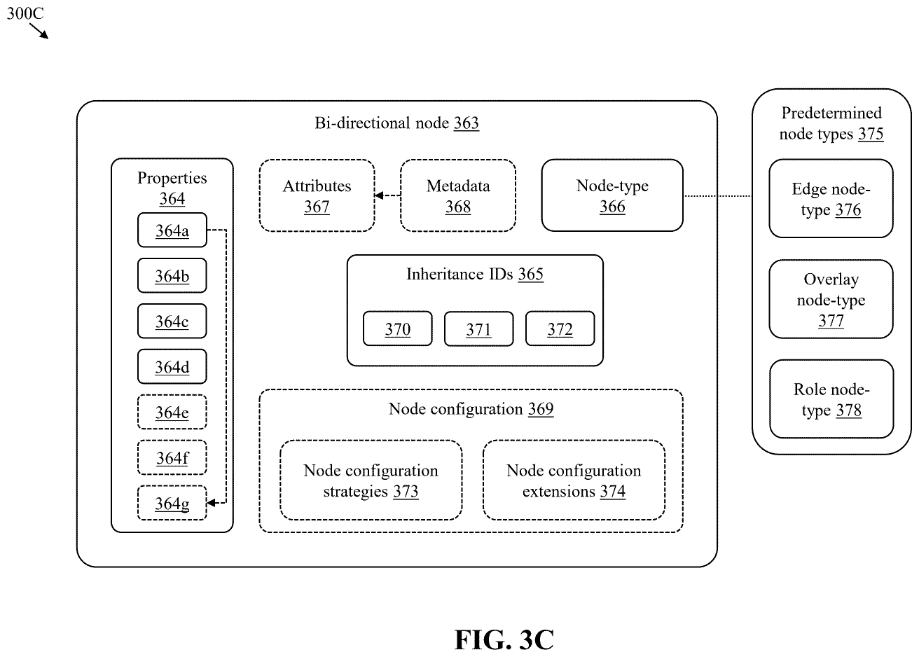

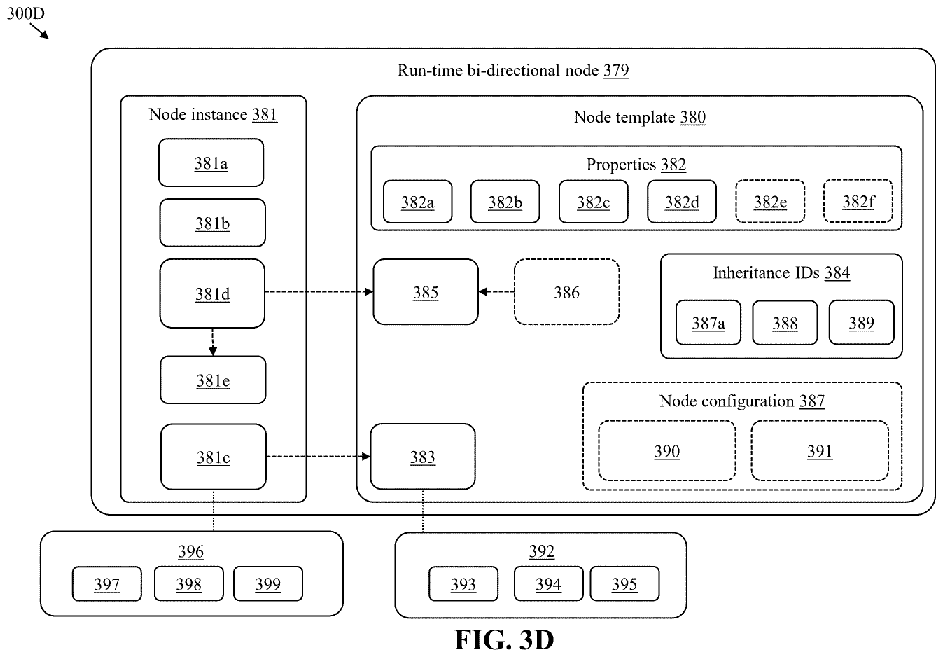

The active node management module 216 may include suitable logic, circuitry, interfaces, and/or code, executable by the circuitry, configured to manage, design, and implement the plurality of active nodes in the overlay system 202. The active nodes may include the generic nodes, the generic run-time nodes, the bi-directional nodes, and the bi-directional run-time nodes. Further, each active node may have a vertex node-type, an edge node-type, a role node-type, or an overlay node-type (described in conjunction with FIGS. 3A-3D). The active node management module 216 is further configured to facilitate operations associated with the execution of one or more transactions using the active nodes.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independent of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100.

The storage management module 220 may include suitable logic, circuitry, interfaces, and/or code, executable by the circuitry, configured to manage the temporary or permanent storage of data associated with the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100. Throughout the description, the term ‘storage device’ is used interchangeably with the term ‘storage element’.

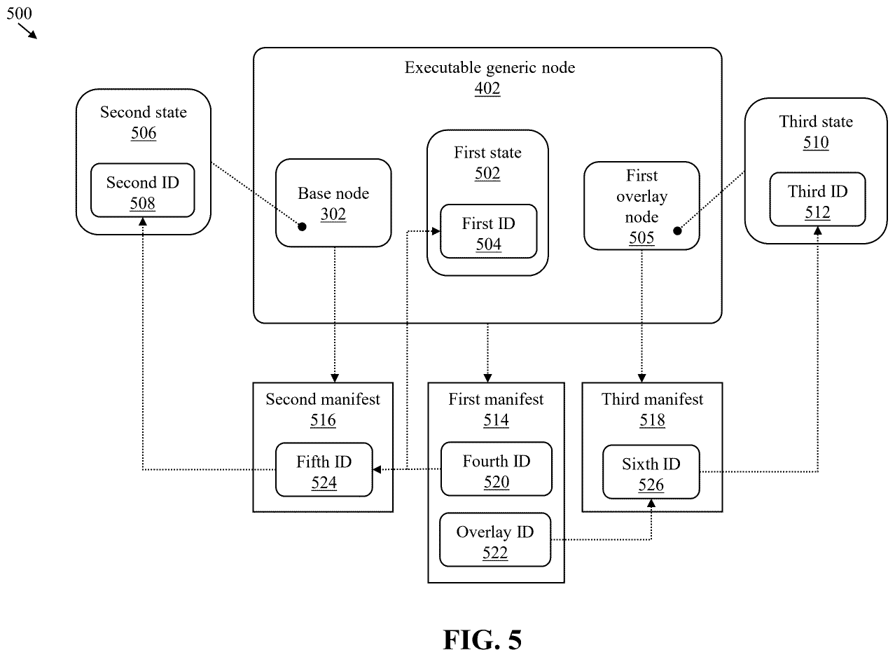

As described, storage, loading, and unloading of the executable graph-based model 100 or one or more components thereof is facilitated by the memory management module 218 and the storage management module 220. The memory management module 218 and the storage management module 220 may facilitate such operations by interacting with the storage device that stores the executable graph-based model 100. The overlay system 202 further includes a plurality of manifest storages. The manifest storages are used by the memory management module 218 and the storage management module 220 to facilitate storage of manifest states (including manifest template states and manifest instance states) of nodes. The storage element may include a primary storage and a secondary storage. The primary storage may store the executable graph-based model 100 and may also store nodes that are loaded in the executable graph-based model 100. The secondary storage may store node states, manifests, and manifest states associated with nodes that are unloaded from the executable graph-based model 100. Storage and retrieval of nodes are described in detail in conjunction with FIG. 5.

The security module 222 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the data associated with the overlay system 202 contains Personally Identifiable Information (PII) or Protected Health Information (PHI), the security module 222 can implement one or more layers of data protection to ensure that the PII or PHI are correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the overlay management module 236 for managing and executing security-based overlays.

The overlay management module 236 may include suitable logic, circuitry, interfaces, and/or code, executable by the circuitry, configured to manage all overlays within the overlay system 202. The overlays may be generic overlays, generic run-time overlays, bi-directional overlays, or run-time bi-directional overlays. Bi-directional overlays are nodes that are associated with one or more bi-directional nodes by way of a direct connection or a connection link. A bi-directional overlay may be associated with a bi-directional node by extending the functionality of the bi-directional node. Alternatively, the bi-directional overlay node may be associated with the bi-directional node by way of a connection link such that the connection link includes a primary role for the bi-directional node and a secondary role for the bi-directional overlay. A run-time bi-directional overlay node is the same as the bi-directional overlay node. In addition, the run-time bi-directional overlay node may include a node template and a node instance. Generic nodes are nodes of the executable graph-based model 100 that are not bi-directional nodes. Generic overlays are associated with generic nodes and/or bi-directional nodes and extend the functionality of the generic nodes and/or bi-directional nodes. Operations performed by the active node management module 216 include overlay storage management, overlay structure modeling, overlay logic creation and execution, and overlay loading and unloading (within the executable graph-based model 100). The active node management module 216 is communicatively coupled (e.g., connected either directly or indirectly) to one or more other modules within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

The overlay management module 236 may include a generic overlay management sub-module 236a and a bi-directional overlay management sub-module 236b. The generic overlay management sub-module 236a is configured to perform operations of the overlay management module 236 that are associated with the generic overlays and generic run-time overlays. The bi-directional overlay management sub-module 236b is configured to perform operations of the overlay management module 236 that are associated with the bi-directional overlays and run-time bi-directional overlays. The generic run-time overlay node may be overlay nodes that may be generic run-time nodes whereas bi-directional run-time overlay nodes may be run-time overlay nodes that may be bi-directional nodes.

The operations module 238 may include suitable logic, circuitry, interfaces, and/or code, executable by the circuitry, configured to track operational metrics and the behavior of all modules of the overlay system 202. Operational metrics of a module are indicative of statistics associated with the performance of the module while performing an operation (for example, communication, data processing, stimulus processing, or the like).

The templating module 240 may include suitable logic, circuitry, interfaces, and/or code, executable by the circuitry, configured to enable the overlay system 202 to implement a templated version of one or more nodes of the executable graph-based model 100. The templating module 240 may be configured to create one or more predefined templates in the executable graph-based model 100. The templating module 240 may be further configured to generate one or more node instances of the predefined node templates for the implementation of the templated version of the executable graph-based model 100. Notably, the templating module 240 ensures ontology integrity by enforcing the structure and rules of a template when generating instances of the template at run-time. Ontology integrity refers to the consistency, accuracy, and correctness of an ontology. Thus, the templating module 240 ensures that the consistency, accuracy, and correctness of the ontology of the executable graph-based model 100 are maintained while generating the instances of the template at run-time. The templating module 240 may be communicatively coupled (i.e., connected either directly or indirectly) to one or more nodes and/or one or more overlays within the executable graph-based model 100.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. Such a module as a unit or in combination with one or more other modules of the overlay system 202 may form processing circuitry of the overlay system 202.

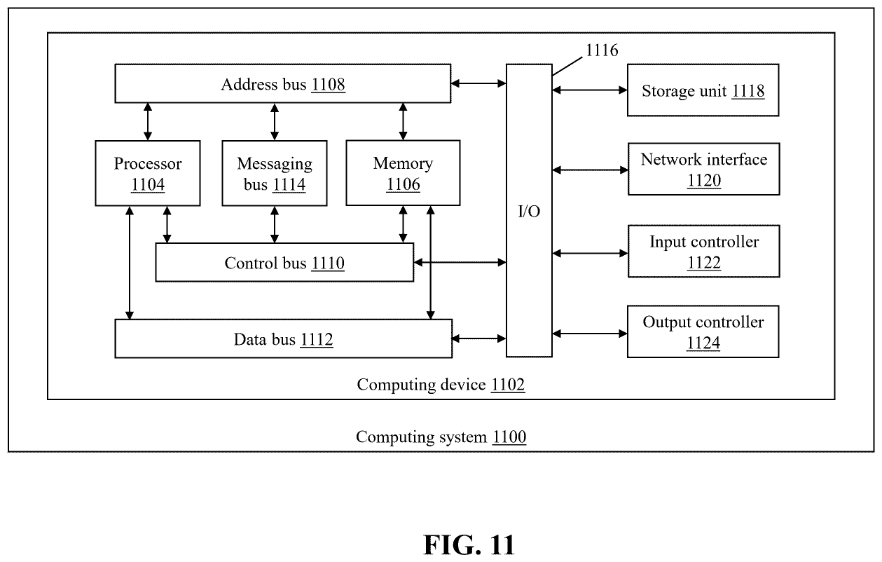

Beneficially, various features of the overlay system 202 support the processing circuitry and a computing system (shown in FIG. 11) implementing the overlay system in significantly enhancing its performance. The significant enhancement in performance may include significantly increased throughput and efficiency, as well as significantly reduced cost complexity, processing complexity, time complexity, latency, waiting time, turnaround time, or the like.

The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or functional programming languages.

Although it is described that the overlay system 202 includes a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model, specifically, the concept of a node. Unlike conventional graph-based systems, all elements (e.g., data, overlays, etc.) within the executable graph-based model 100 are implemented as nodes. As will become clear, this allows executable graph-based models to be flexible, extensible, and highly configurable.

FIG. 3A is a block diagram 300A that illustrates a standard structure of a generic node 302 within the executable graph-based model 100, consistent with disclosed embodiments of the present disclosure. Referring to FIG. 3A, the generic node 302 corresponds to a generic node of the executable graph-based model 100. The generic node 302 further corresponds to the core structure of the executable graph-based model 100 and forms the foundational building block for all data and processing logic within the executable graph-based model 100. The generic node 302 includes properties 304, inheritance IDs 306, and a node-type 308. The generic node 302 optionally includes one or more attributes 310, metadata 312 associated with the attributes 310, and a node configuration 314.

The properties 304 of the generic node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the generic node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the generic node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the generic node 302 is incremented when the generic node 302 undergoes transactional change. This allows the historical changes between versions of the generic node 302 to be tracked by modules or overlays within the overlay system 202. The namespace 304c of the generic node 302, along with the name 304d of the generic node 302, is used to help organize nodes within the executable graph-based model 100. That is, the generic node 302 is assigned a unique name 304d within the namespace 304c such that the name 304d of the generic node 302 need not be unique within the entire executable graph-based model 100, only within the context of the namespace 304c to which the generic node 302 is assigned. The generic node 302 optionally includes one or more icons 304e which are used to provide a visual representation of the generic node 302 when visualized via a user interface. The one or more icons 304e can include icons at different resolutions and display contexts such that the visualization of the generic node 302 is adapted to different display settings and contexts. The generic node 302 also optionally includes one or more labels 304f which are used to override the name 304d when the generic node 302 is rendered or visualized.

The generic node 302 supports the concept of inheritance of data and processing logic associated with any other node of the executable graph-based model 100 that is inherited by the generic node 302. This allows the behavior and functionality of the generic node 302 to be extended or derived from the inherited node of the executable graph-based model 100. The inheritance IDs 306 of the generic node 302 indicate the inheritance-based information, which may apply to the generic node 302. The inheritance IDs 306 comprise a set of Boolean flags that identify the inheritance structure of the generic node 302. The abstract flag 316 allows the generic node 302 to support the construct of abstraction. When the abstract flag 316 takes a value ‘true’, the generic node 302 is flagged as abstract that is to say that it cannot be instantiated or created within an executable graph-based model (e.g., the executable graph-based model 100). Thus, in an instance when the generic node 302 has the abstract flag 316 set to ‘true’, the generic node 302 may only form the foundation of other nodes that inherit therefrom. By default, the abstract flag 316 of the generic node 302 is set to ‘false’. The leaf flag 318 is used to indicate whether any other node may inherit from the generic node 302. If the leaf flag 318 is set to ‘true’, no other node may inherit from the generic node 302 (but unlike an abstract node, a node with the leaf flag 318 set may be instantiated and created within the executable graph-based model 100). The root flag 320 is used to indicate whether the generic node 302 inherits from any other node. If the root flag 320 is set to ‘true’, the generic node 302 does not inherit from any other node. The generic node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node-type. The node-type 308 of the generic node 302 is used to extend the functionality of the generic node 302. All nodes within the executable graph-based model 100 comprise a node-type that defines additional data structures and implements additional executable functionality. A node-type thus includes data structures and functionality that are common across all nodes that share that node-type. Therefore, the composition of a node with a node-type improves extensibility by allowing the generation of specialized node functionalities for specific application areas. Such extensibility is not present in prior art graph-based models. As illustrated in FIG. 3A, the generic node 302 and the node-type 308 are one logical unit that is not separated in the context of an executing system at run-time (e.g., in the context of execution of an executable graph-based model).

FIG. 3A further shows the plurality of predetermined node-types 326 which provides a non-exhaustive list of node-types for the node-type 308 associated with the generic node 302. The plurality of predetermined node-types 326 includes a vertex node-type 328 and an edge node-type 330. The vertex node-type 328 (also referred to as a data node-type or a value node-type) includes common data structures and functionality related to the ‘things’ modeled in the graph (e.g., the data). The edge node-type 330 includes common data structures and functionality related to coupling/linking/associating two or more nodes. A node having the edge node-type 330 may connect two or more nodes and thus the edge node-type 330 constructs associations and connections between nodes (for example, objects or ‘things’) within the executable graph-based model 100. The edge node-type 330 is not restricted to the number of nodes that can be associated or connected by a node having the edge node-type 330. The data structures and functionality of the edge node-type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined node-types 326 further includes an overlay node-type 332 and a role node-type 334. As will be described in more detail below, a node with the overlay node-type 332 is used to extend the functionality of a node, such as the generic node 302, to incorporate processing logic. Unlike non-overlay nodes, an overlay node (e.g., a node having the overlay node-type 332) includes processing logic which determines the functionality of the overlay node. The processing logic of an overlay node includes a block of executable code, or instructions, which carries out one or more operations associated with the communication of data within the executable graph-based model 100. The block of executable code is pre-compiled code, code that requires interpretation at run-time, or a combination of both. Different overlay nodes provide different processing logic to realize different functionality. For example, an encryption overlay node includes an encryption technique using which an associated node is to be protected/secured and processing logic for facilitating such security/protection of the associated node.

The role node-type 334 defines a connective relationship between two nodes, for example, an edge node and a first vertex node. A node with the role node-type 334 defines a relationship without expressly defining the first vertex node to which the edge node connects. A number of roles (and thus a number of connections) that an edge node-type can have is not limited.

The one or more attributes 310 correspond to the data associated with the generic node 302 (e.g., the data represented by the generic node 302 within the executable graph-based model 100 as handled by the data management module 214). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, or a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the generic node 302 shown in FIG. 3A). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the generic node 302 further includes the metadata 312 (e.g., data stored as a name, a confidentiality indicator for indicating data as sensitive and/or confidential, an average processing time required for processing data, or the like) which is associated with either the generic node 302 or an attribute (for example, the one or more attributes 310) of the generic node 302. An attribute within the one or more attributes 310 may either have an independent state or a shared state. That is to say, an attribute may be a value-shared attribute or a non-value-shared attribute. An independent attribute has data that is not shared with any other node within the executable graph-based model 100. Conversely, a shared attribute has data that is shared with one or more other nodes within the executable graph-based model 100. For example, if two nodes within the executable graph-based model 100 comprise a shared-data attribute with a value state shared by both nodes, updating the data (e.g., the value) of this shared attribute will be reflected across both nodes.

The node configuration 314 provides a high degree of configurations for the different elements of the generic node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the generic node 302, which creates message source IDs. A further example of a concrete node configuration strategy 322 is a versioning strategy, associated with the configuration of the version ID 304b of the generic node 302, which supports major and minor versioning (depending on the type of transactional change incurred by the generic node 302). The versioning strategy may be adapted to a native filing system of a user device hosting the overlay system 202 or a third-party data storage (for example, Snowflake®, or the like) associated with the overlay system 202. All attribute configurations may be examples of node configuration extensions 324.

FIG. 3B is a block diagram 300B that illustrates a standard structure of a generic run-time node 336 within the executable graph-based model 100, consistent with disclosed embodiments of the present disclosure. Referring to FIG. 3B, the generic run-time node 336 corresponds to the core structure of the executable graph-based model 100 and forms the foundational building block for all data and processing logic within the executable graph-based model 100. The generic run-time node 336 is shown to include a node template 337 and a node instance 338. The node instance 338 is generated according to the node template 337. The node template 337 forms a data structure for the node instance 338. The generic run-time node 336 is shown in FIG. 3B is a compositional structure that is generated and executed, at run-time as part of the executable graph-based model 100. In other words, the node template 337 is defined as ‘offline’ and the node instance 338 and the generic run-time node 336 may be run-time structures that may be dynamically generated during execution of the executable graph-based model 100.

The node template 337 comprises a predetermined node structure. Further, the node template 337 defines one or more rules that govern the generation of the node instance 338. The node instance 338 is an implementation of the node template 337. In other words, the node instance 338 is generated based on the predetermined node structure and the one or more rules of the node template 337. The node template 337 cannot be modified during the execution but may be modified during offline mode or at rest. During execution, only the node instance 338 of the generic run-time node 336 may be modified.

The node template 337 may include properties 339, a node type template 340, inheritance IDs 341, and a set of attribute templates 342. The node template 337 may optionally include metadata 343 and node configuration 344. The properties 339 of the node template 337 include a unique identifier (ID) 339a, a version ID 339b, a namespace 339c, a name 339d, and optionally include one or more icons 339e and a set of labels 339f. The inheritance IDs 341 comprise an abstract flag 345, a leaf flag 346, and a root flag 347. The node configuration 344 optionally comprises one or more node configuration strategies 348 and/or one or more node configuration extensions 349. FIG. 3B further shows a plurality of predetermined node type templates 350. The plurality of predetermined node type templates 350 may include a vertex node type template 351, an edge node type template 352, and an overlay node type template 353. Further, the node instance 338 may include a unique ID 354, a version ID 355, a node type instance 356, and a set of attribute instances 357. The node instance 338 may optionally include metadata 358. FIG. 3B further shows a plurality of predetermined node type instances 359. The plurality of predetermined node type instances 359 include a vertex node type instance 360, an edge node type instance 361, and an overlay node type instance 362.

The unique ID 339a is unique for each node template within the executable graph-based model 100. Similarly, the unique ID 354 is unique for each node instance within the executable graph-based model 100. The unique ID 339a and the unique ID 354 may be used to register, manage, and reference the node template 337 and the node instance 338, respectively, within the overlay system 202. The version ID 339b of the node template 337 represents a version of the node template 337. The version ID 339b gets incremented when the node template 337 undergoes a transactional change. Similarly, the version ID 355 of the node instance 338 represents a version of the node instance 338. The version ID 355 gets incremented when the node instance 338 undergoes a transactional change. The namespace 339c of the node template 337, along with the name 339d of the node template 337, is used to organize node templates within the executable graph-based model 100. That is, the node template 337 is assigned a unique name 339d within the namespace 339c such that the name 339d of the node template 337 need not be unique within the entire executable graph-based model 100, only within the context of the namespace 339c to which the node template 337 is assigned. The node template 337 optionally comprises one or more icons 339e which may be used to provide a visual representation of the node template 337. The one or more icons 339e can include icons at different resolutions and display contexts such that the visualization of the node is adapted to different display contexts and settings. The node template 337 also optionally comprises the set of labels 339f which may be used to override the name 339d when the node template 337 is rendered or visualized.

The node template 337 supports the software development feature of multiple inheritance by maintaining references (not shown) to zero or more other node templates, which then act as the base of the node template 337. This allows the behavior and functionality of a node template to be extended or derived from one or more other node templates within an executable graph-based model. The node instance 338 likewise supports multiple inheritance because it is an instance representation of the node template 337. The multiple inheritance structure of the node instance 338 is, however, limited to the corresponding instance realization of the multiple inheritance structure defined by the node template 337, i.e., one node instance 338 is created and managed for each node template 337 defined in the inheritance hierarchy for a node instance of a node template.

The inheritance IDs 341 of the node template 337 provide an indication of the inheritance-based information, which is applicable, or can be applicable, to the node template 337. The node template 337 supports the concept of inheritance of data and processing logic associated with any other node template of the executable graph-based model 100 that is inherited by the node template 337. This allows the behavior and functionality of the node template 337 to be extended or derived from the inherited node template of the executable graph-based model 100. The inheritance IDs 341 of the node template 337 indicate the inheritance-based information, which may apply to the node template 337. The inheritance IDs 341 comprise a set of Boolean flags that identify the inheritance structure of the generic run-time node 336. The abstract flag 345 allows the node template 337 to support the construct of abstraction. When the abstract flag 345 takes a value ‘true’, the node template 337 is flagged as abstract that is to say that it cannot be instantiated or created within an executable graph-based model (e.g., the executable graph-based model 100). Thus, in an instance when the node template 337 has the abstract flag 345 set to ‘true’, the node template 337 may only form the foundation of other node templates that inherit therefrom. By default, the abstract flag 345 of the node template 337 is set to ‘false’. The leaf flag 346 is used to indicate whether any other node template may inherit from the node template 337. If the leaf flag 346 is set to ‘true’, then no other node template may inherit from the node template 337 (but unlike an abstract node, a node with the leaf flag 346 set may be instantiated and created within the executable graph-based model 100). The root flag 347 is used to indicate whether the node template 337 inherits from any other node template. If the root flag 347 is set to ‘true’, the node template 337 does not inherit from any other node. The node template 337 is flagged as leaf (e.g., the leaf flag 346 is set to ‘true’) and/or root (e.g., the root flag 347 is set to ‘true’), or neither (e.g., both the leaf flag 346 and the root flag 347 may be set to ‘false’). It will be apparent to a person skilled in the art that a node cannot be flagged as both abstract and leaf (e.g., the abstract flag 345 cannot be set to ‘true’ whilst the leaf flag 346 is set to ‘true’).

All elements within the executable graph-based model 100 may be defined as node templates or node instances. The functionality of the node template 337 and the node instance 338 may be realized due to the use of the node type template 340 and the node type instance 356. The node type template 340 of the node template 337 is used to extend the functionality of the node template 337 by defining the standard set of capabilities, including data and associated behavior. The vertex node type template 351 (also referred to as a data node type) may include a template of common data structures and functionality related to the ‘things’ modeled in the graph (e.g., the data). The vertex node type instance 360 may include the common data structures and functionality related to the ‘things’ modeled in the graph based on the vertex node type template 351. The edge node type template 352 may include a template of common data structures and functionality related to joining two or more nodes. A node instance having the edge node type instance 361 may connect two or more nodes and thus the edge node type instance 361 constructs associations and connections between nodes (for example objects or ‘things’) within the executable graph-based model 100. The edge node type instance 361 is not restricted to the number of nodes that can be associated or connected by a node having the edge node type instance 361. The data structures and functionality of the edge node type instance 361 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The plurality of predetermined node type templates 350 further may include the overlay node type template 353. The overlay node type template 353 is used to extend the functionality of a node template (e.g., the node template 337) to incorporate processing logic. Similarly, the overlay node type instance 362 is used to extend the functionality of a node instance (e.g., the node instance 338) to incorporate processing logic.

The set of attribute templates 342 corresponds to the data defined by the node template 337. For example, the set of attribute templates 342 may define the names and value types (e.g., integer, string, float, etc.) of one or more attributes but not the values of these attributes. The values of the set of attribute templates 342 may be defined by the set of attribute instances 357 of the node instance 338 through one or more values or instance values. For example, the node template 337 may define a string attribute ‘surname’ and the corresponding node instance 338 may assign the instance value ‘Bell-Richards’ to this string attribute. Each attribute instance of the set of attribute instances 357 may be associated with an attribute template of the set of attribute templates 342. The node template 337 may define one or more default values for the set of attribute templates 342. The default values correspond to the values that the attributes take if no value is assigned. The metadata 343 (e.g., data stored as a name, a value type, and a value triplet) may be associated with either the node template 337 or one or more of the set of attribute templates 342 of the node template 337. Similarly, the node instance 338 also optionally comprises the metadata 358 (e.g., data stored as a name, a value type, and a value triplet) which may be associated with either the node instance 338 or one or more of the set of attribute instances 357.

The node configuration 344 provides a high degree of configurability for the different elements of a node template and/or a node instance. An example of a concrete node configuration strategy is an ID strategy, associated with the configuration of the unique ID 339a of the node template 337. A further example of a concrete node configuration strategy is a versioning strategy, associated with the configuration of the version ID 339b of the node template 337 which supports major and minor versioning (depending on the type of transactional change incurred). The versioning strategy may be adapted to a native filing system of a user device hosting the overlay system 202 or a third-party data storage (for example, Snowflake®, or the like) associated with the overlay system 202.

It will be apparent to a person skilled in the art that each generic run-time node of the executable graph-based model 100 has a standard structure that is similar to the generic run-time node 336 of FIG. 3B.

Throughout the description, the node template of a generic run-time node may be referred to as a generic node template and the node instance of a generic run-time node may be referred to as a generic node instance.

FIG. 3C is a block diagram 300C that illustrates a standard structure of a bi-directional node 363 within the executable graph-based model 100, consistent with disclosed embodiments of the present disclosure. Referring to FIG. 3C, the bi-directional node 363 corresponds to the core structure of the executable graph-based model 100 and forms the foundational building block for various data and processing logics within the executable graph-based model 100. The bi-directional node 363 includes properties 364, inheritance IDs 365, a node-type 366, attributes 367, metadata 368, and a node configuration 369.

The properties 364 include a unique ID 364a, a version ID 364b, a namespace 364c, a name 364d, one or more icons 364e, one or more labels 364f, and one or more alternative IDs 364g. The properties 364 of the bi-directional node 363 is the same as the properties 304 of the generic node 302. In other words, the unique ID 364a, the version ID 364b, the namespace 364c, the name 364d, the one or more icons 364e, the one or more labels 364f, and the one or more alternative IDs 364g are same as the unique ID 304a, the version ID 304b, the namespace 304c, the name 304d, the one or more icons 304e, the one or more labels 304f, and the one or more alternative IDs 304g, respectively, of the generic node 302.

The inheritance IDs 365 of the bi-directional node 363 include an abstract flag 370, a leaf flag 371, and a root flag 372. The inheritance IDs 365 of the bi-directional node 363 is the same as the inheritance IDs 306 of the generic node 302. In other words, the abstract flag 370, the leaf flag 371, and the root flag 372 are the same as the abstract flag 316, the leaf flag 318, and the root flag 320, respectively, of the generic node 302.

The node configuration 369 of the bi-directional node 363 includes node configuration strategies 373 and node configuration extensions 374. The node configuration 369 is the same as the node configuration 314 of the generic node 302. In other words, the node configuration strategies 373 and the node configuration extensions 374 of the bi-directional node 363 are the same as the node configuration strategies 322 and the node configuration extensions 324, respectively, of the generic node 302.

The bi-directional node 363 may have the node-type 366 which may be one of predetermined node types 375. The predetermined node types 375 of the bi-directional node 363 may include an edge node-type 376, an overlay node-type 377, and a role node-type 378. The edge node-type 376 is the same as the edge node-type 330. The overlay node-type 377 is the same as the overlay node-type 332, whereas the role node-type 378 is the same as the role node-type 334. Notably, the bi-directional node 363 has the edge node-type 376. In some embodiments, the bi-directional node 363 may be a combination of the edge node-type 376 and the overlay node-type 377. In such embodiments, the bi-directional node 363 may exhibit properties of the edge node-type 376 as well as the overlay node-type 377. Also, in such embodiments, the bi-directional node 363 may be a bi-directional overlay node. In some embodiments, the bi-directional node 363 may be a combination of the edge node-type 376 and the role node-type 378. In such embodiments, the bi-directional node 363 may exhibit properties of the edge node-type 376 as well as the role node-type 378. Also, in such embodiments, the bi-directional node 363 may be a connection node and form a part (for example, an inward connection object, an outward connection object, or the like) of a connection link that couples an associated bi-directional node with another bi-directional node. In some embodiments, the bi-directional node 363 may be associated with another bi-directional node by way of a connection link that includes an inward connection object and an outward connection object. The bi-directional node 363 may be associated with the inward connection object or the outward connection object such that the bi-directional node may own the associated inward connection object or outward connection object. Further, the associated inward connection object or the outward connection object may also be indicative of a primary role or secondary role associated with the bi-directional node 363.

For the sake of brevity, a node of the executable graph-based model 100, that is not a bi-directional node, is referred to as a generic node. Additionally, an overlay node of the executable graph-based model 100 that is a bi-directional node is referred to as a bi-directional overlay node.

FIG. 3D is a block diagram 300D that illustrates a standard structure of a run-time bi-directional node 379 within the executable graph-based model 100, consistent with disclosed embodiments of the present disclosure. Referring to FIG. 3D, the run-time bi-directional node 379 corresponds to the core structure of the executable graph-based model 100 and forms the foundational building block for all data and processing logic within the executable graph-based model 100. The run-time bi-directional node 379 is shown to include a node template 380 and a node instance 381. The node instance 381 is generated according to the node template 380. The node template 380 forms a data structure for the node instance 381. Notably, the node template 380 corresponds to a predefined bi-directional node structure. That is to say that the node template 380 being the predefined bi-directional node structure includes a reference (for example, a pointer, an identifier, or the like) to each associated bi-directional node template. As the node instance 381 may be an implementation of the node template 380, the node instance 381 may also include a reference (for example, a pointer, an identifier, or the like) to each associated node instance. Similarly, when the run-time bi-directional node 379 may be a run-time bi-directional overlay node, the node template 380 may be an overlay node template and the node instance may be an overlay node instance. The overlay node template may correspond to a predefined bi-directional overlay node template. The overlay node instance may be an implementation of the overlay node template and may include a reference (for example, a pointer, an identifier, or the like) to the overlay node template. The overlay node template may include references to each run-time bi-directional overlay node template associated therewith and the run-time bi-directional overlay node instance may include references to each run-time bi-directional overlay node instance associated therewith each run-time bi-directional node that may be associated therewith by way of a corresponding run-time connection link. The run-time connection link may include a run-time outward connection object and a run-time inward connection object. The run-time outward connection object when associated with a run-time bi-directional node, enables the run-time bi-directional node to send a message (for example, a signal, an instruction, a command, an event, or the like) to a run-time bi-directional node coupled to a run-time inward connection object associated with the run-time outward connection object. The run-time outward connection object may include an outward connection object template that defines a structure of the run-time outward connection object. The run-time inward connection object may further include an inward connection object instance that may be an implementation of the outward connection object.

The run-time bi-directional node 379 shown in FIG. 3D is a compositional structure that is generated and executed, at run-time as part of the executable graph-based model 100. In other words, the node template 380 is defined as ‘offline’ and the node instance 381 and the run-time bi-directional node 379 may be run-time structures that may be dynamically generated during the execution of the executable graph-based model 100.

The node template 380 is the same as the node template 337 described in conjunction with FIG. 3B whereas the node instance 381 is the same as the node instance 338 described in conjunction with FIG. 3B.

The node template 380 may include properties 382, a node type template 383, inheritance IDs 384, and a set of attribute templates 385. The node template 380 may optionally include metadata 386 and node configuration 387. The properties 382 of the node template 380 include a unique identifier (ID) 382a, a version ID 382b, a namespace 382c, a name 382d, and optionally include one or more icons 382e and a set of labels 382f. The inheritance IDs 384 comprise an abstract flag 387a, a leaf flag 388, and a root flag 389. The node configuration 387 optionally comprises one or more node configuration strategies 390 and/or one or more node configuration extensions 391. FIG. 3D further shows a plurality of predetermined node type templates 392. The plurality of predetermined node type templates 392 may include a role node type template 393, an edge node type template 394, and an overlay node type template 395. Further, the node instance 381 may include a unique ID 381a, a version ID 381b, node type instances 381c, and a set of attribute instances 381d. The node instance 381 may optionally include metadata 381e. FIG. 3D further shows a plurality of predetermined node type instances 396. The plurality of predetermined node type instances 396 include a role node type instance 397, an edge node type instance 398, and an overlay node type instance 399.

The properties 382 of the node template 380 have a description that is similar to the description of the properties 339 described in conjunction with FIG. 3B. In other words, the unique identifier (ID) 382a, the version ID 382b, the namespace 382c, the name 382d, the icons 382e, and the set of labels 382f have descriptions that may be similar to descriptions of the unique identifier (ID) 339a, the version ID 339b, the namespace 339c, the name 339d, the icons 339e, and the set of labels 339f, respectively, shown in FIG. 3B.

The inheritance IDs 384 of the node template 380 has a description that is similar to the inheritance IDs 341 of the node template 337. In other words, the abstract flag 387a, the leaf flag 388, and the root flag 389 have descriptions that may be similar to the abstract flag 345, the leaf flag 346, and the root flag 347, respectively, shown in FIG. 3B.

All elements within the executable graph-based model 100 may be defined as node templates or node instances. The functionality of the node template 380 and the node instance 381 may be realized due to the use of the node type templates 392 and the node type instances 396, respectively. The node type template 392 has a description that is similar to the node type template 350 of the node template 337 shown in FIG. 3B. In other words, the edge node type template 394 is the same as edge node type template 352 shown in FIG. 3B and the overlay node type template 395 is the same as the overlay node type template 353 shown in FIG. 3B. Similarly, the edge node type instance 398 is same as the edge node type instance 361 shown in FIG. 3B whereas the overlay node type instance 399 is the same as the overlay node type instance 362 shown in FIG. 3B. The node type template 392 also may include the role node type template 393 that may include a template of roles and associations of the node template 380. The role node type template 393 may be used to associate the node template 380 with one or more other node templates. The role node type template 393 may include roles, role attributes, and descriptions for the roles by way of which the node template 380 may be associated with one or more other node templates. The role node type instance 397 may be used to associate the node instance 381 with one or more other node instances. The role node type instance 397 may include roles, role attributes, and descriptions for the roles by way of which the node instance 381 may be associated with one or more other node instances. Notably, a run-time bi-directional node (for example, the run-time bi-directional node 379) has an edge node-type. That is to say that a node template (for example, the node template 380) and a node instance (for example, the node instance 381) may have an edge node template (for example, the edge node type template 394) and edge node instance (for example, the edge node type instance 398), respectively. Additionally, the run-time bi-directional node (for example, the run-time bi-directional node 379) may have a role node-type or an overlay node-type. That is to say that a node template (for example, the node template 380) may have a role node template (for example, the role node type template 393) or overlay node template (for example, the overlay node type template 395). Additionally, the node instance (for example, the node instance 381) may have a role node instance (for example, the role node type instance 397) or overlay node instance (for example, the overlay node type instance 399).

The set of attribute templates 385 has a description that is similar to the description of the set of attribute templates 342 described in conjunction with FIG. 3B. The metadata 386 has a description that is similar to the metadata 343 depicted in FIG. 3B. Similarly, the set of attribute instances 381d has a description that is similar to the set of attribute instances 357 of FIG. 3B and the metadata 381e have a description that is similar to the metadata 358 of FIG. 3B.

The node configuration 387 has a description that may be similar to the node configuration 344 of FIG. 3B. In other words, the description of the node configuration strategies 390 may be similar to the description of the node configuration strategies 348, and the description of the node configuration extensions 391 is similar to the description of the node configuration extensions 349.

In some embodiments, the run-time bi-directional node 379 may be a combination of the edge node-type and the overlay node-type. In such embodiments, the run-time bi-directional node 379 may exhibit properties of the edge node-type as well as the overlay node-type. Also, in such embodiments, the run-time bi-directional node 379 may be a run-time bi-directional overlay node.

In some embodiments, the run-time bi-directional node 379 may be a combination of the edge node-type and the role node-type. In such embodiments, the run-time bi-directional node 379 may exhibit properties of the edge node-type as well as the role node-type. Also, in such embodiments, the run-time bi-directional node 379 may be a connection node and form a part (for example, an inward connection object, an outward connection object, or the like) of a run-time connection link that couples an associated run-time bi-directional node with another run-time bi-directional node.

In some embodiments, the run-time bi-directional node 379 may be associated with another run-time bi-directional node by way of a run-time connection link that may include an inward connection object and an outward connection object. The run-time connection link may be composed of a connection link template and a connection link instance such that the inward connection object may include an inward connection object template and an inward connection object instance and the outward connection object may include an outward connection object template and an outward connection object instance. The run-time bi-directional node 379 may be associated with the inward connection object or the outward connection object such that the run-time bi-directional node may own the associated inward connection object or outward connection object. Further, the associated inward connection object or the outward connection object may also be indicative of a primary role or secondary role associated with the run-time bi-directional node 379. In an instance, the run-time bi-directional node 379 may be associated with the inward connection object. In such an instance, the inward connection object instance may be associated with a node instance of the run-time bi-directional node 379 and the inward connection object template may be associated with a node template of the run-time bi-directional node 379. In another instance, the run-time bi-directional node 379 may be associated with the outward connection object. In such an instance, the outward connection object instance may be associated with the node instance of the run-time bi-directional node 379 and the outward connection object template may be associated with the node template of the run-time bi-directional node 379.

For the sake of brevity, a run-time node of the executable graph-based model 100, that is not a run-time bi-directional node, is referred to as a generic run-time node. Additionally, an overlay node of the executable graph-based model 100 that is a run-time bi-directional node is referred to as a run-time bi-directional overlay node.

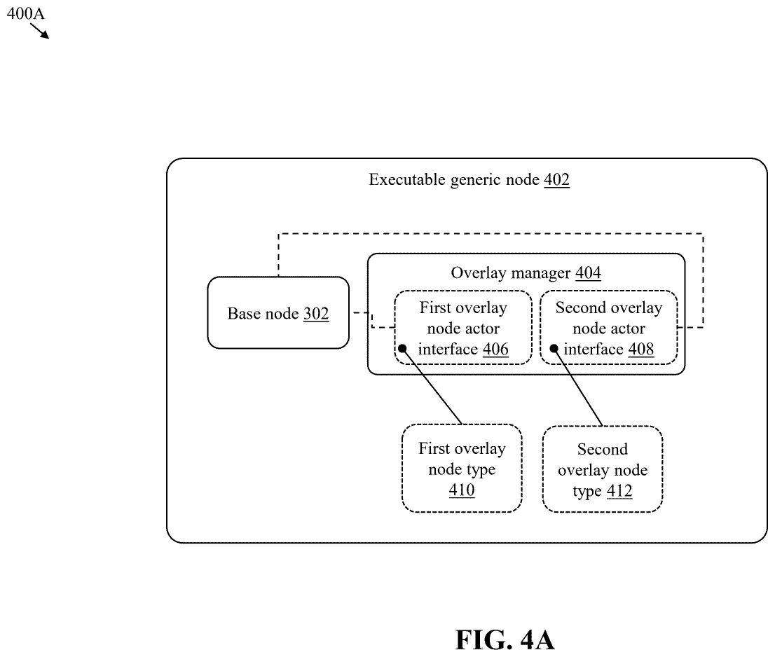

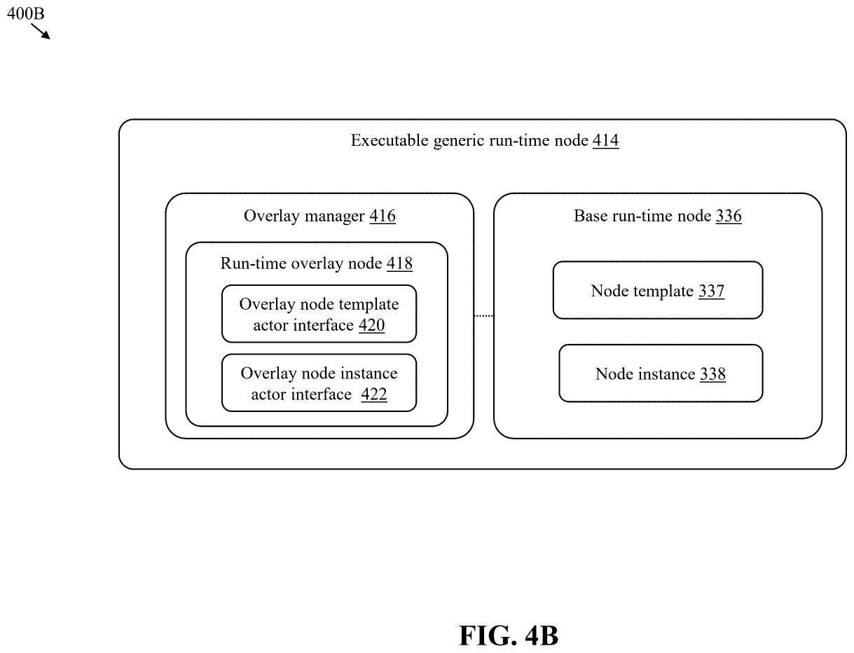

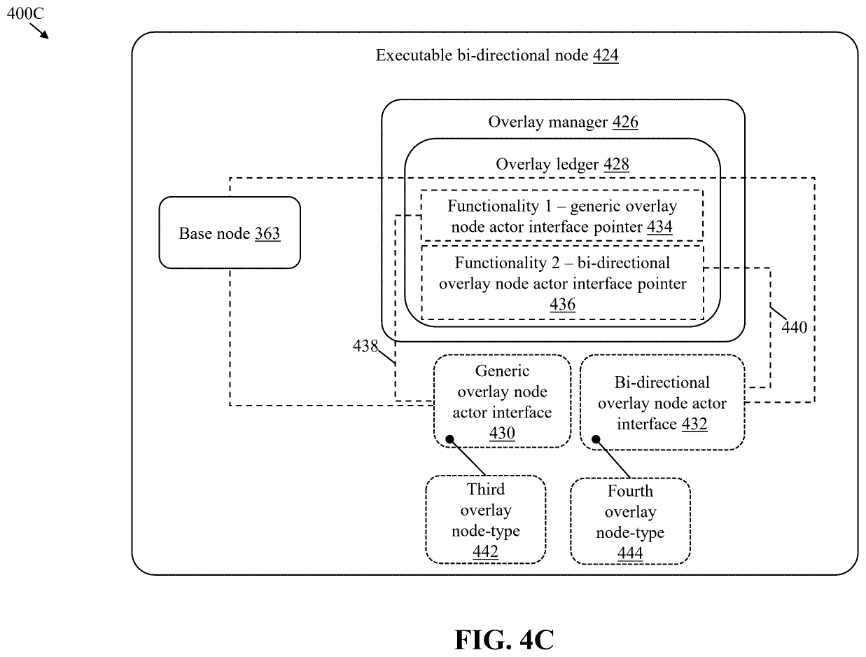

FIG. 4A is a block diagram 400A that illustrates an executable generic node 402 within the executable graph-based model 100, consistent with disclosed embodiments of the present disclosure. Referring to FIG. 4A, the executable generic node 402 is shown to include a base node (e.g., the generic node 302) and an overlay manager 404. For the sake of ongoing discussion, the base node corresponds to the generic node 302, and is hereinafter referred to as the “base node 302”. The base node 302 when extended by way of one or more overlay nodes becomes the executable generic node 402.

The executable generic node 402 may have a first overlay node (not shown) and a second overlay node (not shown) associated therewith. The first and second overlay nodes may be unloaded from the executable graph-based model 100. The first and second overlay nodes may be represented in the executable graph-based model 100 by way of corresponding proxy nodes. The proxy nodes of the first and second overlay nodes may be implemented in the executable graph-based model 100 by way of a first overlay node actor interface 406 and a second overlay node actor interface 408. For the sake of brevity, the first and second overlay nodes and corresponding proxy nodes are not shown herein.

The overlay manager 404 maintains an overlay ledger including entries for the first overlay node actor interface 406 and the second overlay node actor interface 408 such that the first overlay node actor interface 406 represents a first overlay node associated with the base node 302 and the second overlay node actor interface 408 represents a second overlay node associated with the base node 302.

The executable generic node 402 provides processing functionality (e.g., processing logic) to the base node 302 via one or more associated overlay nodes (for example, the first and second overlay nodes). Beneficially, the data and processing capability of the base node 302 may be dynamically and significantly extended using the concept of an executable node (for example, the executable generic node 402). As shown, the first overlay node has a first overlay node-type 410, and the second overlay node has a second overlay node-type 412. Therefore, the first overlay node actor interface 406 is associated with the first overlay node-type 410 and the second overlay node actor interface 408 is associated with the second overlay node type 412. Examples of overlay node-type include, but are not limited to, a subscriber overlay node, a publisher overlay node-type, and an encryption overlay node-type.

A node with the subscriber overlay node-type is a subscriber overlay node that is indicative of an operation of receiving an input from an associated node. The subscriber overlay node also includes processing logic to receive the input. A node with the publisher overlay node-type is a publisher overlay node that is indicative of an operation of publishing an output of an associated node. The publisher overlay node also includes processing logic to publish the output. A node with the encryption overlay node-type is an encryption overlay node that is indicative of an encryption technique using which an associated node is to be secured. The encryption overlay node also includes processing logic to secure a corresponding node. Examples of the encryption technique include a symmetric encryption algorithm, an asymmetric encryption algorithm, a combination of these, or any other encryption technique.

Although the executable generic node 402 is assumed to include two overlay nodes, in other embodiments, the executable generic node 402 may include any number of overlay nodes, without deviating from the scope of the present disclosure.

The executable generic node 402 extends the base node 302 (or is a subtype of the base node 302) such that all the functionality and properties of the base node 302 are accessible to the executable generic node 402. The executable generic node 402 also dynamically extends the functionality of the base node 302 by associating the overlay nodes maintained by the overlay manager 404 with the base node 302. The executable generic node 402 may thus be considered a combination of the base node 302 and the first and second overlay nodes. The executable generic node 402 may be alternatively referred to as a node with overlay(s). Therefore, the executable generic node 402 acts as a decorator of the base node 302 adding the functionality of the overlay manager 404 to the base node 302.

It will be apparent to a person skilled in the art that the base node 302 refers to any suitable node within the executable graph-based model 100. As such, the base node 302 may be a node having a node-type such as a vertex node-type, an edge node-type, an overlay node-type, a role node-type, or the like. Alternatively, the base node 302 may be an executable node such that the functionality of the (executable) base node 302 is dynamically extended. In this way, complex and powerful processing functionality can be dynamically generated by associating and extending overlay nodes.

The overlay manager 404 registers and maintains one or more overlay nodes (such as the first overlay node and the second overlay node) associated with the base node 302. The overlay manager 404 may register and maintain the one or more overlay nodes using one or more associated overlay node actor interfaces. For example, the overlay manager 404 may register (i) the first overlay node using the first overlay node actor interface 406 and (ii) the second overlay node using the second overlay node actor interface 408. The assignment of the first and second overlay nodes to the base node 302 (via the overlay manager 404) endows the base node 302 with processing logic and executable functionality defined within the first and second overlay nodes. The first and second overlay nodes may be accessed using the first and second overlay node actor interfaces 406 and 408 as described throughout the description.

Extending the functionality of a base node through one or more overlay nodes is at the heart of the overlay system 202. As illustrated in FIG. 2, the data (e.g., a vertex node as represented by the base node 302 in FIG. 4A) and the functionality that acts upon that data (e.g., an overlay node) can be separated and independently maintained offline, but at run-time, an association between the data node and the overlay node is determined and an executable node is generated (e.g., the executable generic node 402 shown in FIG. 4A).

It will be apparent to a person skilled in the art that functionalities of the first and second overlay nodes may be performed by a single overlay node that includes processing logic associated with both the first and second overlay nodes.

It will be apparent to a person skilled in the art that the list of overlay types is not exhaustive and the number of different overlay types that can be realized is not limited. Because an overlay node is itself a node, all functionality of a node described in relation to the base node 302 is thus applicable to an overlay node. For example, an overlay node includes a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

An overlay node, such as the first overlay node or the second overlay node, is not bound to a single executable node or a single executable graph-based model (unlike nodes that have non-overlay node-types). This allows overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays. Also, a single overlay node may be associated with multiple executable nodes. Thus, the overlay node and functionality thereof may be shared among the multiple executable nodes.

The overlay manager 404 of the executable generic node 402 is responsible for executing all overlays registered therewith. The overlay manager 404 also coordinates the execution of all associated overlay nodes. As shown in FIG. 4A, the executable generic node 402 associates the base node 302 with two overlay nodes, that is the first overlay node and the second overlay node. Thus, the overlay manager 404 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 404 and are associated with an overlay via a node configuration extension for the overlay.

FIG. 4B is a block diagram 400B that illustrates an executable generic run-time node 414 within the executable graph-based model 100, consistent with disclosed embodiments of the present disclosure. Referring to FIG. 4B, the executable generic run-time node 414 is shown to include the generic run-time node 336 (hereinafter referred to as ‘the base run-time node 336’) and an overlay manager 416. The overlay manager 416 may include a run-time overlay node 418. The executable generic run-time node 414 provides processing functionality (e.g., processing logic) to the base run-time node 336 via one or more associated overlay nodes (for example, the run-time overlay node 418). Beneficially, the data and processing capability of the base run-time node 336 may be dynamically and significantly extended using the concept of an executable run-time node (for example, the executable generic run-time node 414).

Although, the executable generic run-time node 414 is shown to include a single run-time overlay node 418, in other embodiments, the executable generic run-time node 414 may include any number of run-time overlay nodes. The run-time overlay node 418 may be unloaded from the executable graph-based model 100. The run-time overlay node 418 may include an overlay node template and an overlay node instance. The overlay node template and the overlay node instance may, collectively, constitute the run-time overlay node 418.

As mentioned previously, the run-time overlay node 418 is assumed to be unloaded from the executable graph-based mode 100. Therefore, the node template and the node instance of the run-time overlay node 418 may be represented in the executable graph-based model 100 by way of an overlay node template actor interface 420 and an overlay node instance actor interface 422, respectively. The overlay node template actor interface 420 may be used to access the node template of the run-time overlay node 418 and the overlay node instance actor interface 422 may be used to access the node instance of the run-time overlay node 418. The node template and the node instance may be loaded in the executable graph-based model 100 using the overlay node template actor interface 420 and the overlay node instance actor interface 422, respectively, to access the run-time overlay node 418.

The executable generic run-time node 414 extends the base run-time node 336 (or is a subtype of the base run-time node 336) such that all the functionality and properties of the base run-time node 336 may be accessible to the executable generic run-time node 414. The executable generic run-time node 414 also dynamically extends the functionality of the base run-time node 336 by associating the run-time overlay nodes maintained by the overlay manager 416 with the base run-time node 336. The executable generic run-time node 414 may thus be considered a composition of the base run-time node 336 and the run-time overlay node 418. The executable generic run-time node 414 may be alternatively referred to as a generic run-time node with overlay(s). Therefore, the executable generic run-time node 414 acts as a decorator of the base run-time node 336 adding the functionality of the overlay manager 416 to the base run-time node 336.

It will be apparent to a person skilled in the art that the base run-time node 336 refers to any suitable run-time node within the executable graph-based model 100. As such, the base run-time node 336 may be a generic run-time node having a type such as a vertex node type, an edge node type, or the like. Alternatively, the base run-time node 336 may itself be an executable node such that the functionality of the (executable) base run-time node 336 is dynamically extended. In this way, complex and powerful processing functionality can be dynamically generated by associating and extending overlay nodes.

The overlay manager 416 registers and maintains one or more run-time overlay nodes (such as the run-time overlay node 418) associated with the base run-time node 336. The overlay manager 416 may register and maintain the one or more run-time overlay nodes using one or more overlay node template actor interfaces and one or more overlay node instance actor interfaces. For example, the overlay manager 416 may register the run-time overlay node 418 using the overlay node template actor interface 420 and the overlay node instance actor interface 422. The assignment of the run-time overlay node 418 to the base run-time node 336 (via the overlay manager 416) endows the base run-time node 336 with processing logic and executable functionality defined within the run-time overlay node 418. In other words, the run-time overlay node 418 may interact at run-time, with the overlay node template and/or the overlay node instance of the base run-time node 336. In an example, the node template 337 and the node instance 338 may be not executable nodes. That is, neither the node template 337 nor the node instance 338 comprises an overlay manager with one or more run-time overlay nodes. In another example, the node template 337 and/or the node instance 338 may be executable nodes thereby extending the functionality, complexity, and configurability of executable run-time nodes.

Extending the functionality of a base run-time node through one or more run-time overlay nodes is at the heart of the overlay system 202. As illustrated in FIG. 2, the data (e.g., a vertex node as represented by the base run-time node 336 in FIG. 4B) and the functionality that acts upon that data (e.g., an overlay node) can be separated and independently maintained offline, but at run-time, an association between the data node and the run-time overlay node is determined and an executable run-time node is generated (e.g., the executable generic run-time node 414).

Each run-time overlay node comprises an overlay node template and an overlay node instance. The overlay node template is a node template with the overlay node type template. Similarly, the overlay node instance is a node instance with the overlay node type instance. The overlay node instance is an implementation of the overlay node template. The overlay node template comprises one or more generic rules that may be implemented by the processing logic of the overlay node instance. For example, a rule may be defined in an overlay node template specifying that a hashing algorithm is to be used and an overlay instance associated with the overlay template provides a specific implementation of a hashing algorithm (e.g., Message-Digest Algorithm 5 (MD5), Secure Hash Algorithm-1 (SHA-1), SHA-2, etc.). Based on the overlay node template being unloaded from the executable graph-based model 100, the overlay node template may be represented in the executable graph-based model 100 by way of an overlay node template proxy and the overlay node instance may be represented in the executable graph-based model 100 by way of an overlay node instance proxy. The overlay node template proxy is represented in the executable graph-based model 100 by way of an overlay node template actor interface whereas the overlay node instance proxy is represented in the executable graph-based model 100 by way of an overlay node instance actor interface. The overlay node template actor interface and the overlay node instance actor interface may be used to access (namely, load) the overlay node template and the overlay node instance as described throughout the description. The terms ‘proxy’ and ‘proxy node’ are used interchangeably throughout the description.

A run-time overlay node, such as the run-time overlay node 418, is a node having an overlay node type (alternatively referred to as an overlay type) assigned to its node type. Examples of overlay node types include an encryption overlay node type, an obfuscation overlay node type, an audit overlay node type, an analytics overlay node type, a handler overlay node type, a publisher overlay node type, or the like. It will be apparent to a person skilled in the art that the list of overlay types is not exhaustive and the number of different overlay types that can be realized is not limited.

Because an overlay node is itself a node, all functionality of a node described in relation to the base run-time node 336 is thus applicable to an overlay node. For example, an overlay node may include a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node type of the node to which the overlay node is applied.

A run-time overlay node, such as the run-time overlay node 418, is not bound to a single executable node or a single executable graph-based model (unlike nodes that have non-overlay node types). This allows run-time overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays.

Unlike non-run-time overlay nodes, a run-time overlay node may include processing logic (not shown in FIG. 4B) which determines the functionality of the run-time overlay node. The processing logic of a run-time overlay node may include a block of executable code, or instructions, which carries out one or more operations associated with the facilitation of indexing within the executable graph-based model 100. The block of executable code is pre-compiled code, code that requires interpretation at run-time, or a combination of both. Different run-time overlay nodes provide different processing logic to realize different functionality. The overlay manager 416 of the executable generic run-time node 414 is responsible for executing all overlays registered therewith. The overlay manager 416 also coordinates the execution of all associated overlay nodes. As shown in FIG. 4B, the executable generic run-time node 414 associates the base run-time node 336 with the run-time overlay node 418.

In some embodiments, the overlay manager 416 employs a strategy to manage potentially cascading execution flow of overlays such that one overlay may be associated with one or more other overlays. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies may be defined and registered with the overlay manager 416 and may be associated with an overlay via a node configuration extension for the overlay.

FIG. 4C is a block diagram 400C that illustrates an executable bi-directional node 424 within the executable graph-based model 100, consistent with disclosed embodiments of the present disclosure. Referring to FIG. 4C, the executable bi-directional node 424 is shown to include a base node (for example, the bi-directional node 363) and an overlay manager 426. Hereinafter, the base node is referred to as the base node 363. The base node 363 being a bi-directional node may have the edge node-type 376. The base node 363 may be associated with a generic overlay node and/or a bi-directional overlay node. The overlay manager 426 has a description that is similar to the description of the overlay manager 404. The overlay manager 426 creates and maintains an overlay ledger 428.

The overlay ledger 428 may maintain a list of overlay node actor interfaces associated with overlay nodes of the base node 363 and functionalities associated with each of the overlays. The overlay ledger 428 further includes a pointer associated with each entry in the overlay ledger 428 that points to a corresponding overlay node actor interface associated with overlay nodes of the base node 363. The overlays associated with the base node 363 may be accessed based on associated actor interfaces as described later in the description.

The base node 363 may be extended by way of a generic overlay node and/or a bi-directional overlay node. Based on the generic overlay nodes and the bi-directional overlay nodes being unloaded from the executable graph-based model 100, the generic overlay node and the bi-directional overlay node may be represented by corresponding proxy nodes in the executable graph-based model 100. The proxy nodes of the generic overlay node and the bi-directional overlay node may be implemented in the executable graph-based model 100 by way of a generic overlay node actor interface 430 and a bi-directional overlay node actor interface 432, respectively.

Based on the association of the generic overlay node and the bi-directional overlay node with the base node 363 and an unloaded state of the generic overlay node and the bi-directional overlay node, the overlay manager 426 creates entries 434 and 436 for the generic overlay node actor interface 430 and the bi-directional overlay node actor interface 432, respectively. As shown, the entries 434 and 436 include functionalities and pointers 438 and 440 that point to the generic overlay node actor interface 430 and the bi-directional overlay node actor interface 432, respectively. For example, the pointer 438 associated with the entry 434 points to the generic overlay node actor interface 430, and the pointer 440 associated with the entry 436 points to the bi-directional overlay node actor interface 432.

An association of the generic overlay node actor interface 430 with a third overlay node-type 442 may indicate that the generic overlay node may have the third overlay node-type 442. Similarly, an association of the bi-directional overlay node actor interface 432 with a fourth overlay node-type 444 may indicate that the bi-directional overlay node may have the fourth overlay node-type 444. The third overlay node-type 442 and the fourth overlay node-type 444 may be the same as the first and second overlay node-types 410 and 412 as described in conjunction with FIG. 4A. Notably, the structure of the bi-directional overlay node may be the same as the bi-directional node 363 whereas processing logic associated with the bi-directional overlay node may be similar to generic overlay nodes (for example, the first overlay node and the second overlay node) shown in FIG. 4A. In other embodiments, processing logic associated with the bi-directional overlay node may be different from generic overlay nodes in the executable graph-based model 100.

In an instance, the generic overlay node and/or the bi-directional overlay node may be required to be executed. In such an instance, the overlay manager 426 may identify one or more relevant overlay node actor interfaces (for example, the generic overlay node actor interface 430 and the bi-directional overlay node actor interface 432) based on the functionality of one of the generic overlay node and the bi-directional overlay node as per the overlay ledger 428. Upon identification of the one or more relevant overlay node actor interfaces (for example, the generic overlay node actor interface 430 and the bi-directional overlay node actor interface 432), the processing circuitry (for example, the memory management module 218 and the storage management module 220) may be configured to load one or more overlay nodes associated with the one or more relevant overlay node actor interfaces. For example, the processing circuitry (for example, the memory management module 218 and the storage management module 220) may be configured to load the generic overlay node and the bi-directional overlay node using the generic overlay node actor interface 430 and the bi-directional overlay node actor interface 432, respectively. Subsequently, the overlay manager 426 may trigger the loaded overlay nodes (for example, the generic overlay node and/or the bi-directional overlay node) to execute processing logic associated therewith.

In some embodiments, when a base node may be a run-time bi-directional node, the association of the base node with one or more run-time overlay nodes may form an executable run-time bi-directional node. The run-time overlay nodes may be a generic run-time overlay node or a run-time bi-directional overlay node. For the sake of brevity, it is assumed that the base node may be associated with a single run-time overlay node. Based on the run-time overlay node being unloaded, the executable graph-based model 100 may include an overlay node template actor interface and an overlay node instance actor interface for an overlay node template and an overlay node instance of the run-time overlay node, respectively. An overlay manager of the executable run-time bi-directional node may maintain an overlay ledger including entries of the overlay node template actor interface and the overlay node instance actor interface. Further, each entry may be associated with a pointer pointing towards an associated actor interface (for example, the overlay node template actor interface or the overlay node instance actor interface).

In an instance, when a run-time overlay node associated with the executable run-time bi-directional node may have to be accessed, a relevant overlay node instance actor interface may be identified based on an associated functionality. The overlay node instance actor interface may point to an associated overlay node template actor interface. Therefore, the overlay node template actor interface may be used to load the overlay node template and the overlay node instance actor interface may be used to load the overlay node instance as described later in the description. Hence, the run-time overlay node may get loaded and triggered to execute the processing logic associated therewith.

In some embodiments, the data and the processing logic associated with overlays (for example, generic overlays, generic run-time overlays, bi-directional overlays, and run-time bi-directional overlays) may be non-persistent. Such overlays are known as stateless overlays. Notably, processing logic and outputs associated with stateless overlays cease to exist based on unloading of the overlays and require to be recreated as and when required.

In some embodiments, the data and the processing logic associated with overlays (for example, generic overlays, generic run-time overlays, bi-directional overlays, and run-time bi-directional overlays) may be persistent. Such overlays are known as stateful overlays. Notably, processing logic and outputs associated with stateful overlays are stored in the storage element of the overlay system 202 and may be loaded in the executable graph-based model 100 and used as and when required. The persistent nature of the data and the processing logic associated with an executable node and an associated generic overlay node are described in detail in conjunction with FIG. 5.

Throughout the description, an executable node (for example, the executable generic node 402 and the executable bi-directional node 414) is represented by way of two concentric circles. In other words, the executable node is represented by way of an inner circle encircled by an outer circle, where the incircle represents a base node and the outer circle represents an overlay node associated with the base node.

FIG. 5 is a block diagram 500 that illustrates a composition of the executable generic node 402 that enables persistent storage of data and the processing logic associated therewith, consistent with disclosed embodiments of the present disclosure.

As described in conjunction with FIG. 4A, the executable generic node 402 includes the base node 302 and one or more overlay nodes (e.g., the first and second overlay nodes). For the brevity of the ongoing description, the persistent storage is explained for the executable generic node 402 including only the first overlay node. One or more operations performed to ensure the persistence of the first overlay node may be performed for the second overlay node as well.

Referring to FIG. 5, the executable generic node 402 includes the base node 302 and the first overlay node (hereinafter, referred to as the first overlay node 505). The executable generic node 402 has a corresponding first state 502 having a first ID 504. The base node 302 has a second state 506 having a second ID 508, and the first overlay node 505 has a third state 510 having a third ID 512. A manifest (for example, first through third manifests 514-518) is generated for each of the base node 302, the executable generic node 402, and the first overlay node 505. In an embodiment, the manifests may be generated by the storage management module 220. The first manifest 514 is associated with the executable generic node 402 and has a fourth ID 520 and an overlay ID 522. The second manifest 516 is associated with the base node 302 and has a fifth ID 524. The third manifest 518 is associated with the first overlay node 505 and has a sixth ID 526. Further, the manifests are stored at respective storage locations that may be centralized or distributed storage locations associated with the overlay system 202. The manifests may be stored by the storage management module 220.

The first state 502 of the executable generic node 402 includes data required to reconstruct the executable generic node 402 (e.g., attributes, properties, etc.). The first state 502 of the executable generic node 402 is persistently stored along with the first ID 504. The first manifest 514 is generated for the executable generic node 402 and has (i) the fourth ID 520 (which is the same as the first ID 504), (ii) the storage location of the first state 502 of the executable generic node 402, and (iii) the overlay ID 522 (which is the same as the sixth ID 526). Notably, the fourth ID 520 is the same as the first ID 504 and the fifth ID 524, hence, the first manifest 514 includes the ID of the state of the base node 302 and the executable generic node 402. Further, the overlay ID 522 is the same as the sixth ID 526 of the state of the first overlay node 505. Therefore, the first manifest 514 may be used to identify and retrieve the states of the base node 302, the executable generic node 402, and the first overlay node 505. Subsequently, the retrieved states may be used to reconstruct the executable generic node 402 and the first overlay node 505. In an instance, the executable generic node 402 may be further extended to include additional overlay nodes. In such an instance, the first manifest 514 may include state IDs of the additional overlay nodes as well. A first manifest state (not shown) is then generated for the first manifest 514 and persistently stored along with the fourth ID 520.

The second state 506 of the base node 302 includes data required to reconstruct the base node 302 (e.g., attributes, properties, etc.) and is persistently stored along with the second ID 508. The second manifest 516 is generated for the base node 302 and has the fifth ID 524 and the storage location of the second state 506 of the base node 302. The second ID 508 of the second state 506 and the fifth ID 524 of the second manifest 516 are the same as the first ID 504 of the first state 502 of the executable generic node 402 (which is also the same as the fourth ID 520 of the first manifest 514 of the executable generic node 402). As mentioned above, along with the first state 502, the first manifest 514 may also be used to identify and retrieve the second manifest 516 which in turn may be used to identify the second state 506 of the base node 302. A second manifest state (not shown) is then generated for the second manifest 516 and persistently stored along with the fifth ID 524. Thus, the states, manifests, and manifest states for the executable generic node 402 and the base node 302 include the same, shared, ID. A shared ID can be used in this instance because the states, manifests, and manifest states are stored separately. The separate storage of the states, manifests, and manifest states exhibit a distributed architecture of the overlay system 202.

The third state 510 of the first overlay node 505 includes data required to reconstruct the first overlay node 505 (e.g., attributes, properties, processing logic, etc.) and is persistently stored along with the third ID 512. The third manifest 518 is generated for the first overlay node 505 and includes the sixth ID 526, which is the same as the third ID 512. Therefore, the first manifest 514 may be further used to identify and retrieve the third manifest 518 which in turn may be used to identify and retrieve the third state 510 of the first overlay node 505. A third manifest state (not shown) is then generated for the third manifest 518 and is persistently stored along with the sixth ID 526.

In operation, when the executable generic node 402 is to be loaded, the transaction module 208, in conjunction with the storage management module 220, may execute one or more operations to retrieve the first manifest state stored at a known storage location. Based on the first manifest state, the storage management module 220 may re-construct the first manifest 514 which includes the fourth ID 520 which is the same as the fifth ID 524 of the second manifest 516. Based on the fifth ID 524, the storage management module 220 may identify the second manifest state and may generate the second manifest 516 based on which the second state 506 is identified. Subsequently, the base node 302 is loaded and the storage management module 220 may determine that the base node is a node with overlay. Based on the fourth ID 520 (that is the same as the first ID 504 of the first state 502 of the executable generic node 402) of the first manifest 514, the first state 502 is identified and retrieved. Subsequently, the executable generic node 402 is loaded. Moreover, based on the overlay ID 522 (that is the same as the sixth ID 526 of the third manifest 518) of the first manifest 514, the third manifest state is identified and the third manifest 518 is generated. Subsequently, based on the sixth ID 526 (that is the same as the third ID of the third state) of the third manifest 518, the third state 510 is identified and retrieved. Based on the third state 510, the first overlay node 505 is reconstructed and loaded in the executable graph-based model 100.

Based on a context of a stimulus (for example, the stimulus 230) associated with the overlay system 202, the processing logic (such as the context module 210) may determine an ID that is the same as the fifth ID 524. Based on the determined ID, the processing logic (such as the memory management module 218 and the storage management module 220) may identify the second manifest 516. Subsequently, the processing logic (such as the memory management module 218 and the storage management module 220) may identify the second state 506 that has the second ID 508 that matches the fifth ID 524. Further, the processing logic (such as the memory management module 218 and the storage management module 220) may retrieve the second state 506 associated with the second manifest 516 from a corresponding storage element. Subsequently, the processing logic (such as the memory management module 218 and the storage management module 220) may determine, by checking the manifest storage(s) associated with the overlay system 202, whether there is another manifest (such as the first manifest of the executable generic node 402) with an ID that matches the second ID 508 and the fifth ID 524. Notably, the first manifest 514 includes storage locations of each overlay node (for example, the first overlay node 505) of the executable generic node 402. Based on the overlay ID 522 included in the first manifest 514 that matches the sixth ID 526 included in the third manifest 518, the processing logic (such as the memory management module 218 and the storage management module 220) may identify and retrieve the third manifest 518 from a manifest storage of a plurality of manifest storages of the overlay system 202. Subsequently, the processing logic (such as the memory management module 218 and the storage management module 220) may identify the third state 510 which has the third ID 512 that matches the sixth ID 526. Further, the processing logic (such as the memory management module 218 and the storage management module 220) may retrieve the third state 510 associated with the third manifest 518 from a corresponding storage element. To determine whether the first overlay node 505 has an overlay node associated therewith, the processing logic (such as the memory management module 218 and the storage management module 220) may also perform a check to determine whether any of the plurality of manifest storages of the overlay system 202 includes any other manifest with an ID that matches the sixth ID 526. Since the first overlay node 505 does not have an overlay associated therewith, no other manifest has the ID that matches the sixth ID.

Notably, the manifest (the third manifest 518) of the first overlay node 505 includes a reference (such as an identifier that is common to the second manifest 516 and the third manifest 518, a link, a path, a storage location, or the like) to the second manifest 516 of the base node 302. Therefore, the re-formation of the executable generic node 402 includes a re-creation of the first overlay node 505 prior to a re-creation of the base node 302. Subsequently, the first overlay node 505 and the base node 302 are organized by associating the base node 302 with the first overlay node 505 to re-form the executable generic node 402.

In some embodiments, the first overlay node 505 may not be loaded in case it is not required for executing the operation associated with the stimulus 230. The loaded executable generic node 402 and the first overlay node 505 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node are transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, the management and storage of manifests is managed by the controller module 206, the memory management module 218, the storage management module 220, a combination of these, or any other module of the overlay system 202. Also, all manifest states are stored together at a storage location (such as a manifest storage) that is known to the storage management module 220. Such centralized storage of the manifest states ensures that node states associated therewith are easily accessible.

It will be apparent to a person skilled in the art that although FIG. 5 illustrates only a single generic overlay node associated with a generic node, in other embodiments, the executable generic node 402 may include additional or different generic overlay nodes (for example, the second overlay node). It will also be apparent to a person skilled in the art that only those overlay nodes that are required for responding to the stimulus 230 may be loaded.

It will be apparent to a person skilled in the art that the executable bi-directional node 424 may be loaded in a manner that is similar to the loading of the executable generic node 402. Additionally, the executable bi-directional node 424 may include one or more identifiers of one or more associated bi-directional nodes. Therefore, based on the loading of the executable bi-directional node 424, the identifiers may be identified and the associated bi-directional nodes may be loaded in a similar manner.

In some embodiments, the executable generic run-time node 414 may be loaded by loading the associated node template and node instance. Each of the node template and the node instance may be loaded in a manner similar to the loading of the base node 302 as described in conjunction with FIG. 5. Additionally, the node instance may include a reference to the node template. Therefore, the node template may be identified based on the node instance and may be loaded prior to the node instance. Also, each of the node template and the node instance may include a reference to one or more node templates and one or more node instances, respectively, associated therewith. Therefore, based on the loading of the node template, the associated node templates may be loaded. Similarly, based on the loading of the node instance, the associated node instances may be loaded.

In some embodiments, the bi-directional node 363 may be loaded in a manner similar to the loading of the base node 302. Additionally, a node state of the bi-directional node 363 may include a reference (for example, an identifier, a pointer) to one or more bi-directional nodes associated therewith. Based on the reference, the one or more bi-directional nodes may also be loaded.

In some embodiments, the run-time bi-directional node 379 may be loaded by loading the node template 380 and the node instance 381. Each of the node template 380 and the node instance 381 may be loaded in a manner similar to the loading of the base node 302. A node state of the node instance 381 may include a reference (for example, an identifier, a pointer) to the node template 380. Therefore, the node template 380 may be loaded prior to the loading of the node instance 381. In addition, the node state of the node instance 381 may include a reference (for example, an identifier, a pointer) to node instances of one or more run-time bi-directional nodes associated therewith. Based on the reference, the node instances of the one or more run-time bi-directional nodes may also be loaded. Similarly, a node state of the node template 380 may include a reference (for example, an identifier, a pointer) to node templates of one or more run-time bi-directional nodes associated therewith. Based on the reference, the node templates of the one or more run-time bi-directional nodes may also be loaded.

The overlay system 202 described in conjunction with FIGS. 1-5 is used to facilitate one or more operations associated with the plurality of active nodes (for example, generic nodes, generic run-time nodes, bi-directional nodes, and run-time bi-directional nodes) in the executable graph-based model 100. Various concepts and features associated with the active nodes are described in detail later in the description.

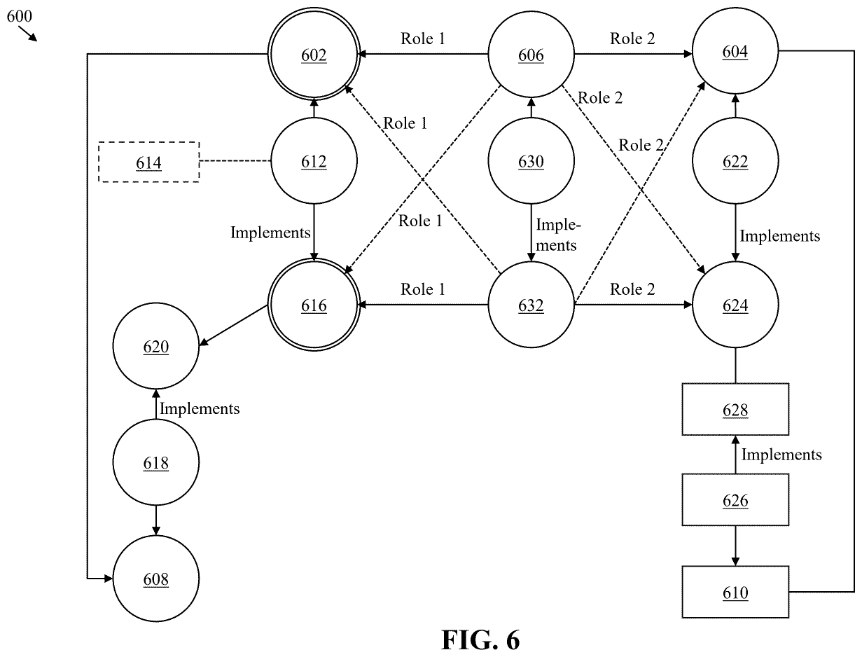

As described previously, the plurality of active nodes may include generic nodes, generic run-time nodes, bi-directional nodes, and run-time bi-directional nodes. Although FIGS. 1-5 describe loading of active nodes using manifests, such loading is performed based on the active nodes being absent from the executable graph-based model 100. However, such loading is performed for an entire logical structure of the active nodes. The logical structure of the active nodes may include attributes, overlays, and other components of its node structure. Such loading may require an unnecessary number of resources when only a certain portion of the logical structure of the active nodes may be required to be loaded. To resolve such an issue, each of the plurality of active nodes may be unloaded or loaded based on corresponding proxy nodes. FIGS. 6-9 describe in detail the unloading and loading of active nodes based on corresponding proxy nodes.

FIG. 6 illustrates a graph 600 that depicts a concept of unloading generic nodes from the executable graph-based model 100 based on associated proxy nodes, consistent with disclosed embodiments of the present disclosure. Referring to FIG. 6, shown are a plurality of active nodes in the executable graph-based model 100. The plurality of active nodes may include generic nodes 602 and 604 with the vertex node-type 328 associated by way of a generic node 606 with the edge node-type 330. The generic node 606 may include a role 1 for the generic node 602 and a role 2 for the generic node 604. Further, the generic node 602 may be associated with one or more generic overlay nodes (for example, an overlay node 608). The generic node 604 may be associated with a set of attributes. The set of attributes may constitute a standard structure of the generic node 604 as described for the generic node 302 in conjunction with FIG. 3A. For the sake of brevity, a single attribute (for example, an attribute 610) of the set of attributes is depicted herein.

The processing circuitry (for example, the stimuli management module 212) may receive a stimulus (for example, the stimulus 230). The stimulus may be associated with an operation to unload the generic node 602 from the executable graph-based model 100 by generating a proxy node. That is to say that the stimulus may be indicative of unloading the generic node 602 such that it creates an illusion of the generic node 602 still being loaded in the executable graph-based model 100. Therefore, the unloading may have to be performed by creating a proxy node for the generic node 602. The proxy node may act as a representative of the generic node 602 in the executable graph-based model 100. Therefore, with the proxy node representing the generic node 602, an illusion of the generic node 602 being loaded in the executable graph-based model 100 at all times may be created.

The processing circuitry (for example, the stimuli management module 212), based on the stimulus, may be configured to identify the generic node 602 in the executable graph-based model 100. The processing circuitry (for example, the stimuli management module 212) may identify the generic node 602 based on an identifier thereof indicated by the stimulus. In some embodiments, the processing circuitry (for example, the stimuli management module 212) may be configured to identify the generic node 602 based on one or more attributes (for example, a label, metadata, or the like) associated therewith indicated by the stimulus.

In some embodiments, based on the identification of the generic node 602, the processing circuitry (for example, the stimuli management module 212) may determine that the generic node 602 may not be currently loaded in the executable graph-based model 100. Consequently, the processing circuitry (for example, the memory management module 218 and the storage management module 220) may be configured to load the generic node 602 in the executable graph-based model 100 as described in conjunction with FIG. 5.

The processing circuitry (for example, the controller module 206, the transaction module 208, and the active node management module 216) may be configured to generate a proxy node 612 for the generic node 602. The generic node 602 may be represented by the proxy node 612 in the executable graph-based model 100. A proxy node (for example, the proxy node 612) may be a non-node structure of the executable graph-based model 100 that represents an associated active node and includes information to load/re-generate the associated active node. In some embodiments, the proxy node may include a reference (for example, a pointer) to the associated active node. In some embodiments, the reference may be a storage location of a node state of the associated active node such that the node state includes data required for loading/re-generation of the associated active node in the executable graph-based model 100. The processing circuitry (for example, the controller module 206, the transaction module 208, and the active node management module 216) may be configured to determine the storage location of the node state by accessing a manifest (described in conjunction with FIG. 5) of the associated active node. The processing circuitry (for example, the controller module 206, the transaction module 208, and the active node management module 216) may be further configured to store the determined storage location in the proxy node. In other words, the processing circuitry (for example, the controller module 206, the transaction module 208, and the active node management module 216) may be further configured to determine a storage location of a node state the generic node 602 and store the storage location in the proxy node 612. Subsequently, the processing circuitry (for example, the controller module 206, the transaction module 208, and the active node management module 216) may be configured to store the proxy node 612 in the primary storage of the storage element.

In some embodiments, the proxy node 612 may be associated with a node status indicator 614. In other words, the proxy node 612 may include the node status indicator 614. The node status indicator 614 may be a component of the proxy node 612 that may be indicative of a loaded state or an unloaded state of the generic node 602. In an instance, the generic node 602 may be in the loaded state when it may be loaded in the executable graph-based model 100 and stored in the primary storage of the storage element. In such an instance, the node status indicator 614 may be indicative of a load status that corresponds to the loaded status of the generic node 602. The load status may be a flag indicative of the generic node 602 being loaded in the executable graph-based model 100 and stored in the primary storage of the storage element. In such an instance, the load status may act as the reference to the generic node 602. The load status may include a pointer to the generic node 602 stored in the primary storage. In another instance, the generic node 602 may be in the unloaded state when it may be unloaded from the executable graph-based model 100 and stored in the secondary storage of the storage element. In such an instance, the node status indicator 614 may include the storage location of the node state of the generic node 602.

The processing circuitry (for example, the controller module 206, the transaction module 208, and the active node management module 216) may be configured to create the node status indicator 614 associated with the proxy node 612. Subsequently, the processing circuitry (for example, the controller module 206, the transaction module 208, and the active node management module 216) may be configured to update the node status indicator 614 based on the loaded state or the unloaded state of the generic node 602.

In some embodiments, when the generic node 602 may be required to execute an operation associated with the overlay system 202, based on the load status being included in the load status indicator, the processing circuitry (for example, the controller module 206, the transaction module 208, and the active node management module 216) may determine that the generic node 602 is stored in the primary storage and hence can be loaded in the executable graph-based model 100.

In another instance, when the generic node 602 may be in the unloaded state, the processing circuitry (for example, the controller module 206, the transaction module 208, and the active node management module 216) may be configured to update the node status indicator 614 to indicate the storage location of the node state of the generic node 602. In such an instance, when the generic node 602 may be required to execute an operation associated with the overlay system 202, the processing circuitry (for example, the controller module 206, the transaction module 208, and the active node management module 216) may determine the storage location of the node state of the generic node 602 based on the node status indicator 614. Subsequently, based on the storage location of the node state being stored in the node status indicator 614, the processing circuitry (for example, the controller module 206, the transaction module 208, and the active node management module 216) may determine that the generic node 602 may be unloaded from the executable graph-based model 100 and may be stored in the secondary storage. Therefore, the proxy node 612 may currently represent the generic node 602.

The processing circuitry (for example, the controller module 206, the transaction module 208, and the active node management module 216) may be configured to implement the proxy node 612 in the executable graph-based model 100 by way of an actor interface 616. The actor interface 616 may represent the proxy node 612 in the executable graph-based model 100. The actor interface 616 may represent the proxy node 612 while acting as a contract (i.e., a set of constraints) that describes the generic node 602 associated with the proxy node 612. In other words, the actor interface 616 may include a description of a composition of the generic node 602. In an instance, the actor interface 616 may include a description of the set of attributes and a corresponding set of attribute values associated with the generic node 602. That is to say that the actor interface 616 may include a description of a standard structure of the generic node 602.

Subsequently, the processing circuitry (for example, the controller module 206, the transaction module 208, and the active node management module 216) may be configured to unload the generic node 602 from the executable graph-based model 100. To unload the generic node 602, the processing circuitry (for example, the controller module 206, the transaction module 208, and the active node management module 216) may be configured to transfer the generic node 602 from the primary storage to the secondary storage. Based on the unloading of the generic node 602 from the executable graph-based model 100, the generic node 602 may be represented by the proxy node 612 stored in the primary storage such that the proxy node 612 is implemented represented in the executable graph-based model 100 by way of the actor interface 616.

In some embodiments, the generic node 602 may be unloaded by executing the operation to load a generic node (as described in conjunction with FIG. 5) in reverse order. For example, the processing circuitry (for example, the memory management module 218 and the storage management module 220) may be configured to create a node state for the generic node and store the node state in the secondary storage. Subsequently, the processing circuitry (for example, the memory management module 218 and the storage management module 220) may be configured to create a manifest for the generic node 602 such that the manifest may include the storage location of the node state. The processing circuitry (for example, the memory management module 218 and the storage management module 220) may be further configured to create a manifest state for the manifest that may be used to re-create the manifest. The processing circuitry (for example, the memory management module 218 and the storage management module 220) may be further configured to remove the generic node 602 from the executable graph-based model 100.

Based on the unloading of the generic node 602, the overlay node 608 may also be unloaded from the executable graph-based model 100. For unloading the overlay node 608, a proxy node 618 may be created for the overlay node 608. Further, an actor interface 620 may be created to implement the proxy node 618 in the executable graph-based model 100 in turn representing the overlay node 608. Based on the representation of the generic node 602 by the actor interface 616 and the representation of the overlay node 608 by the actor interface 620, the actor interface 616 may be associated with the actor interface 620 such that the actor interface 620 is associated with the actor interface 616 as an overlay thereof. The unloading of the overlay node 608 may be performed by the processing circuitry (for example, the controller module 206, the transaction module 208, and the active node management module 216) in a manner similar to the unloading of the generic node 602.

In some embodiments, the generic node 602 may include an overlay manager (for example, the overlay manager 404). The processing circuitry (for example, the controller module 206, the transaction module 208, and the active node management module 216) may use the overlay manager of the generic node 602 to manage the association of the generic node 602 with the overlay node 608. In an instance, when the generic node 602 and/or the overlay node 608 may be unloaded from the executable graph-based model 100, the overlay manager may use actor interfaces 616 and 620 to manage the association between the generic node 602 and the overlay node 608.

The processing circuitry (for example, the controller module 206, the transaction module 208, and the active node management module 216) may identify, based on the association of the generic nodes 602 and 604 with the generic node 606, the association between the generic nodes 602 and 604. In some embodiments, the association may be based on the generic node 602 inheriting the generic node 604. In some embodiments, the association may be based on the generic node 602 depending on data and/or processing logic associated with the generic node 604 for one or more operations associated therewith. Based on the identified association with the generic node 602, the processing circuitry (for example, the controller module 206, the transaction module 208, and the active node management module 216) may be configured to unload the generic node 604. The processing circuitry (for example, the controller module 206, the transaction module 208, and the active node management module 216) may be configured to generate a proxy node 622 for the generic node 604 and an actor interface 624 for implementing the proxy node 622. Subsequently, the processing circuitry (for example, the controller module 206, the transaction module 208, the active node management module 216, the memory management module 218, and the storage management module 220) may be configured to unload the generic node 604 in a manner similar to the unloading of the generic node 602.

In some embodiments, based on the unloading of the generic node 604, the attribute 610 may also be unloaded. The processing circuitry (for example, the controller module 206, the transaction module 208, and the active node management module 216) may be configured to generate an attribute proxy 626 for the attribute 610. The attribute proxy 626 may have a description similar to the proxy node 612 with a difference being the attribute proxy being representative of the attribute 610 stored in an attribute object (not shown) associated with the generic node 604. Subsequently, the processing circuitry (for example, the controller module 206, the transaction module 208, and the active node management module 216) may be configured to create an attribute actor interface 628. The attribute actor interface 628 may have a description similar to the actor interface 616 with a difference being the attribute actor interface 628 being the implementation of the attribute proxy 626 that represents the attribute 610 which is a non-node component of the executable graph-based model 100. In some embodiments, the attribute object may be a value-shared attribute object and may be associated with a plurality of generic nodes including the generic node 604. In such embodiments, the attribute actor interface 628 may be associated with the plurality of generic nodes.

In some embodiments, based on the unloading of the generic node 602 and/or the generic node 604, the generic node 606 may be unloaded. For unloading the generic node 606, the processing circuitry (for example, the controller module 206, the transaction module 208, and the active node management module 216) may be further configured to generate a proxy node 630 for the generic node 606 and the proxy node 630 may be implemented in the executable graph-based model 100 by way of an actor interface 632. Subsequently, the processing circuitry (for example, the controller module 206, the transaction module 208, and the active node management module 216) may be configured to unload the generic node 606 in a manner similar to the unloading of the generic node 602. In such embodiments, the actor interface 632 may be indicative of the role 1 and role 2 associated with the generic nodes 602 and 604, respectively. The actor interface 632 may couple the actor interfaces 616 and 624 such that the actor interface 616 may be associated with the role 1 and the actor interface 624 may be associated with the role 2.

In some embodiments, the processing circuitry (for example, the stimuli management module 212) may receive a stimulus (for example, the stimulus 230) indicative of a loading operation associated with the generic node 602. Based on the stimulus, the processing circuitry (for example, the controller module 206, the transaction module 208, and the active node management module 216) may be configured to identify generic node 602. Further, the processing circuitry (for example, the controller module 206, the transaction module 208, and the active node management module 216) may be configured to identify the actor interface 616 associated with the generic node 602. Based on the identification, the processing circuitry (for example, the controller module 206, the transaction module 208, and the active node management module 216) may access the actor interface 616 and identify the proxy node 612 associated therewith. The processing circuitry (for example, the controller module 206, the transaction module 208, and the active node management module 216) may retrieve, from the proxy node 612, the node state of the generic node 602. Subsequently, the processing circuitry (for example, the memory management module 218 and the storage management module 220) may be configured to load (namely, re-generate) the generic node 602 in the executable graph-based model 100.

In some embodiments, based on the loading of the generic node 602 in the executable graph-based model 100, the processing circuitry (for example, the memory management module 218 and the storage management module 220) may be configured to associate the generic node 602 with the actor interface 620 of the overlay node 608. In such an embodiment, the overlay node 608 may not be required for executing any operation associated with the overlay system 202.

In some embodiments, the generic node 602 as well as the overlay node 608 may be required for the execution of one or more operations associated with overlay system 202. In such an embodiment, based on the loading of the generic node 602, the processing circuitry (for example, the memory management module 218 and the storage management module 220) may be further configured to load the overlay node 608. The overlay node 608 may be loaded based on the proxy node 618 and the actor interface 620 in a manner similar to the loading of the generic node 602.

In some embodiments, only the overlay node 608 may be required for the execution of one or more operations associated with the overlay system 202. In such an embodiment, the processing circuitry (for example, the memory management module 218 and the storage management module 220) may be configured to load the overlay node 608 and associate the overlay node 608 with the actor interface 616 of the generic node 602. Beneficially, this allows the overlay system 202 to load only essential nodes in the executable graph-based model 100. Therefore, an optimal use of resources is ensured.

In some embodiments, based on the loaded state of the generic node 602 and an unloaded state of the generic node 604. The processing circuitry (for example, the memory management module 218 and the storage management module 220) may be configured to associate the generic node 602 to the actor interface 624 of the generic node 604 via the generic node 606 or the actor interface 632.

In some embodiments, based on the loading of the generic node 602, the processing circuitry (for example, the memory management module 218 and the storage management module 220) may be further configured to load the generic node 604. The generic node 604 may be loaded based on the proxy node 622 and the actor interface 624 in a manner similar to the loading of the generic node 602.

In some embodiments, the processing circuitry (for example, the memory management module 218 and the storage management module 220) may be further configured to load the generic node 606. The generic node 606 may be loaded based on the proxy node 630 and the actor interface 632 in a manner similar to the loading of the generic node 602.

In an instance, the generic node 606 may have a loaded state while the generic nodes 602 and 604 may have unloaded states. In such an instance, the generic node 606 may couple the actor interfaces 616 and 624 such that the actor interface 616 may be associated with role 1 and the actor interface 624 may be associated with the role 2. In another instance, the generic nodes 602 and 606 may have a loaded state and the generic node 604 may have an unloaded state. In such an instance, the generic node 606 may associate the generic node 602 with the actor interface 624 such that the generic node 602 may be associated with role 1 and the actor interface 624 may be associated with the role 2. In another instance, the generic nodes 604 and 606 may have a loaded state and the generic node 602 may have an unloaded state. In such an instance, the generic node 606 may associate the generic node 604 with the actor interface 616 such that the generic node 604 may be associated with role 2 and the actor interface 616 may be associated with the role 1. Similarly, various other combinations of loaded and unloaded states of generic nodes 602-606 may be possible without deviating from the scope of the disclosure. It will be appreciated by a person skilled in the art that a proxy node and/or a corresponding actor interface replicate various associations of an associated node. Therefore, a loaded node may be associated with proxy nodes or actor interfaces of nodes or non-node structures associated therewith without deviating from the scope of the disclosure.

In some embodiments, based on the loading of the generic node 604, the processing circuitry (for example, the controller module 206, the transaction module 208, and the active node management module 216) may be configured to associate the generic node 604 with the attribute actor interface 628.

In some embodiments, based on the loading of the generic node 604, one or more attributes (for example, the attribute 610) of the set of attributes associated with the generic node 604 may also get loaded. The processing circuitry (for example, the controller module 206, the transaction module 208, and the active node management module 216) may be configured to access the attribute actor interface 628 and identify the attribute proxy 626 based on the attribute actor interface 628. Subsequently, the processing circuitry (for example, the controller module 206, the transaction module 208, and the active node management module 216) may be configured to retrieve a storage location of an attribute state of the attribute 610. The attribute state may include information required to load/re-generate the attribute 610 in the executable graph-based model 100. The processing circuitry (for example, the memory management module 218 and the storage management module 220) may be configured to load the attribute 610 using the attribute state. In some instances, the attribute 610 may not be required to be loaded. In such instances, the generic node 604 may be associated with the attribute actor interface 628. Beneficially, this allows the overlay system 202 to load only essential attributes associated with a node and ensure optimal utilization of resources (for example, storage, processing capacity, time, or the like) associated with the overlay system 202.

For the sake of brevity, a set of generic overlay nodes including, the overlay node 608, associated with the generic node 602 is shown herein. In other embodiments, the generic node 604 may also be associated with one or more generic overlay nodes such that based on the unloading of the generic node 604, the processing circuitry (for example, the controller module 206, the transaction module 208, and the active node management module 216) may identify and unload the one or more generic overlay nodes in a manner similar to the unloading of the overlay node 608. Also, based on the loading of the generic node 604, the one or more generic overlay nodes associated therewith may be loaded in a manner similar to the loading of the overlay node 608.

For the sake of brevity, only the generic node 604 is shown to be associated with the set of attributes (for example, the attribute 610). In other embodiments, the generic node 602 may also be associated with a corresponding set of attributes such that based on the unloading of the generic node 602. The processing circuitry (for example, the controller module 206, the transaction module 208, and the active node management module 216) may unload the set of attributes associated with the generic node 602 in a manner that may be similar to the unloading of the attribute 610. Also, based on the loading of the generic node 602, one or more attributes of the set of attributes associated therewith may also be loaded in a manner similar to the loading of the attribute 610.

To summarize, FIG. 6 depicts the unloading and loading of active nodes, that are generic nodes, by way of proxy nodes. The description now moves towards loading and unloading of active nodes that are generic run-time nodes using proxy nodes.

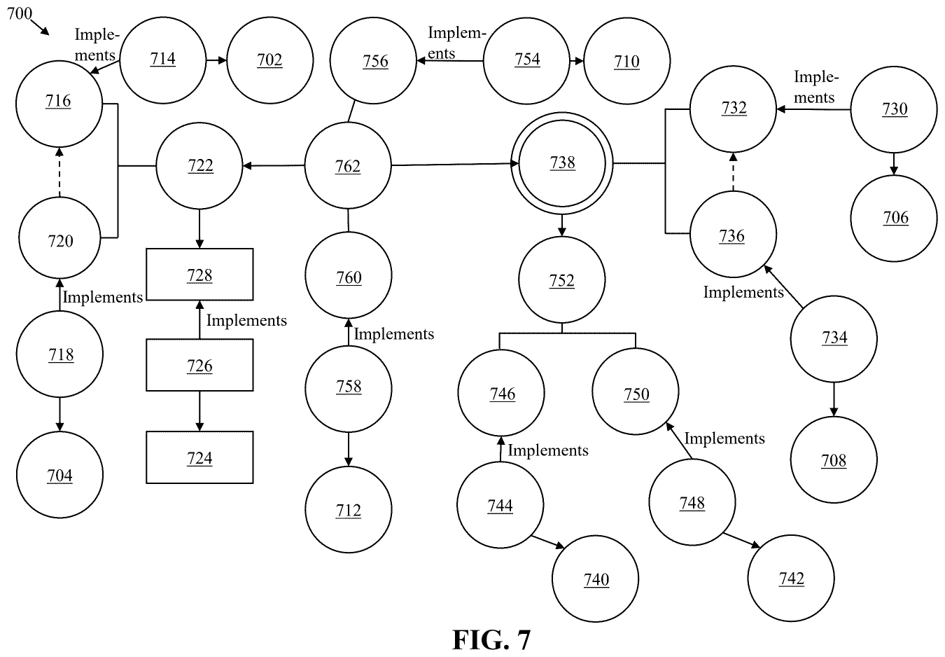

FIG. 7 illustrates a graph 700 that depicts a concept of unloading generic run-time nodes based on associated proxy nodes, consistent with disclosed embodiments of the present disclosure. Referring to FIG. 7, the graph 700 includes a plurality of generic run-time nodes including first through third generic run-time nodes (not shown). The first generic run-time node may be formed of a node template 702 and a node instance 704, the second generic run-time node may be formed of a node template 706 and a node instance 708, and the third generic run-time node may be formed of a node template 710 and a node instance 712. The node templates 702 and 706 may have the vertex node type template 351 whereas the node instances 704 and 708 may have the vertex node type instance 360. Therefore, the first and second generic run-time nodes may be generic run-time vertex nodes. Similarly, the node template 710 may have the edge node type template 352 and the node instance 712 may have the edge node type instance 361. Therefore, the third generic run-time node may be a generic run-time edge node. The first and second generic run-time nodes may be coupled by way of the third generic run-time node.

In an embodiment, the processing circuitry (for example, the stimuli management module 212) may receive a stimulus (for example, the stimulus 230) for unloading the first generic run-time node. Based on the stimulus, the processing circuitry (for example, the controller module 206, the transaction module 208, and the active node management module 216) may be configured to identify the first generic run-time node in the executable graph-based model 100. For identifying the first generic run-time node, the processing circuitry (for example, the controller module 206, the transaction module 208, and the active node management module 216) may identify the node template 702 and the node instance 704. Based on the identification of the node template 702, the processing circuitry (for example, the controller module 206, the transaction module 208, and the active node management module 216) may be configured to generate a proxy node 714 for the node template 702. Further, the processing circuitry (for example, the controller module 206, the transaction module 208, and the active node management module 216) may be configured to implement the proxy node 714 by way of an actor interface 716. The processing circuitry (for example, the controller module 206, the transaction module 208, and the active node management module 216) may be configured to unload the node template 702 based on the proxy node 714 and the actor interface 716 in a manner similar to the unloading of the generic node 602. Similarly, based on the identification of the node instance 704, the processing circuitry (for example, the controller module 206, the transaction module 208, and the active node management module 216) may be configured to generate a proxy node 718 for the node instance 704. Further, the processing circuitry (for example, the controller module 206, the transaction module 208, and the active node management module 216) may be configured to implement the proxy node 718 by way of an actor interface 720. The processing circuitry (for example, the controller module 206, the transaction module 208, and the active node management module 216) may be configured to unload the node instance 704 using the proxy node 718 and the actor interface 720 in a manner similar to the unloading of the generic node 602. Consequently, the first generic run-time node may get unloaded.

Based on the unloading of the first generic run-time node, the processing circuitry (for example, the controller module 206, the transaction module 208, and the active node management module 216) may be configured to create an actor interface 722 that represents the first generic run-time node in the executable graph-based model 100. The actor interface 722 may be associated with the actor interfaces 716 and 720 of the node template 702 and node instance 704, respectively. In some embodiments, the actor interface 722 may include a reference to the actor interface 720 of the node instance 704 and the actor interface 720 may include a reference to the actor interface 716 of the node template 702.

In some embodiments, the first generic run-time node may be associated with a set of attributes. Based on the unloading of the first generic run-time node, the actor interface 722 may be associated with the set of attributes. For the sake of brevity, a single attribute 724 is shown to be associated with the actor interface 722. The attribute 724 may include an attribute template and an attribute instance. For the sake of brevity, the attribute 724 is shown as a single element.

In some embodiments, based on the unloading of the first generic run-time node, the attribute 724 may also be unloaded. The attribute 724 may be unloaded based on the unloading of the attribute template and attribute instance associated therewith. The processing circuitry (for example, the controller module 206, the transaction module 208, the active node management module 216, the memory management module 218, and the storage management module 220) may be configured to create an attribute proxy 726 and an attribute actor interface 728 for the attribute 724 such that the attribute proxy 726 may be implemented by way of the attribute actor interface 728. The processing circuitry (for example, the controller module 206, the transaction module 208, the active node management module 216, the memory management module 218, and the storage management module 220) may be configured to unload the attribute 724 based on the attribute proxy 726 and the attribute actor interface 728 in a manner similar to the unloading of the attribute 610. The processing circuitry (for example, the controller module 206, the transaction module 208, the active node management module 216, the memory management module 218, and the storage management module 220) may be configured to unload the attribute 724 by unloading the attribute template and the attribute instance associated therewith in a manner similar to the unloading of the attribute 610. The attribute 724 may represent the attribute template or the attribute instance. Therefore, the unloading of each of the attribute template and/or the attribute instance may be performed in a manner similar to the unloading of the attribute 724 as described above. Although FIG. 7 depicts the attribute 724 associated with the first run-time generic node, in other embodiments, the second and/or third generic run-time nodes may also be associated with corresponding set of attributes.

Based on the association between the first generic run-time node and the second generic run-time node, the processing circuitry (for example, the controller module 206, the transaction module 208, the active node management module 216, the memory management module 218, and the storage management module 220) may be configured to unload the second generic run-time node. The processing circuitry (for example, the controller module 206, the transaction module 208, the active node management module 216, the memory management module 218, and the storage management module 220) may unload the second generic run-time node by unloading the node template 706 and the node instance 708. The processing circuitry (for example, the controller module 206, the transaction module 208, the active node management module 216, the memory management module 218, and the storage management module 220) may be configured to generate a proxy node 730 for the node template 706. The processing circuitry (for example, the controller module 206, the transaction module 208, the active node management module 216, the memory management module 218, and the storage management module 220) may be configured to implement the proxy node 730 by way of an actor interface 732. The processing circuitry (for example, the controller module 206, the transaction module 208, the active node management module 216, the memory management module 218, and the storage management module 220) may unload the node template 706 based on the proxy node 730 and the actor interface 732. The unloading of the node template 706 may be performed in a manner similar to the unloading of the generic node 602.

Further, the processing circuitry (for example, the controller module 206, the transaction module 208, the active node management module 216, the memory management module 218, and the storage management module 220) may be configured to generate a proxy node 734 for the node instance 708. The processing circuitry (for example, the controller module 206, the transaction module 208, the active node management module 216, the memory management module 218, and the storage management module 220) may be configured to implement the proxy node 734 by way of an actor interface 736. The processing circuitry (for example, the controller module 206, the transaction module 208, the active node management module 216, the memory management module 218, and the storage management module 220) may unload the node instance 708 based on the proxy node 734 and the actor interface 736. The unloading of the node instance 708 may be performed in a manner similar to the unloading of the generic node 602. Consequently, the second generic run-time node may be unloaded based on the unloading of the node template 706 and the node instance 708.

Based on the unloading of the second generic run-time node, the processing circuitry (for example, the controller module 206, the transaction module 208, and the active node management module 216) may be configured to create an actor interface 738 that represents the second generic run-time node in the executable graph-based model 100. The actor interface 738 may be associated with the actor interfaces 732 and 736 of the node template 706 and node instance 708, respectively. In some embodiments, the actor interface 738 may include a reference to the actor interface 736 of the node instance 708 and the actor interface 736 may include a reference to the actor interface 732 of the node template 706.

In some embodiments, the second generic run-time node may be associated with a run-time overlay node including an overlay node template 740 and an overlay node instance 742. Based on the unloading of the second generic run-time node, the processing circuitry (for example, the controller module 206, the transaction module 208, and the active node management module 216) may be configured to unload the run-time overlay node from the executable graph-based model 100. The run-time overlay node may be unloaded by unloading the overlay node template 740 and the overlay node instance 742.

For unloading the overlay node template 740, the processing circuitry (for example, the controller module 206, the transaction module 208, and the active node management module 216) may be configured to generate a proxy node 744 for the overlay node template 740. The processing circuitry (for example, the controller module 206, the transaction module 208, and the active node management module 216) may be configured to implement the proxy node 744 by way of an actor interface 746. The processing circuitry (for example, the controller module 206, the transaction module 208, and the active node management module 216) may be configured to unload the overlay node template 740 using the proxy node 744 and the actor interface 746. The overlay node template 740 may be unloaded in a manner similar to the unloading of the generic node 602. Similarly, the processing circuitry (for example, the controller module 206, the transaction module 208, and the active node management module 216) may be configured to generate a proxy node 748 for the overlay node instance 742. The processing circuitry (for example, the controller module 206, the transaction module 208, and the active node management module 216) may be configured to implement the proxy node 748 by way of an actor interface 750. The processing circuitry (for example, the controller module 206, the transaction module 208, and the active node management module 216) may be configured to unload the overlay node instance 742 using the proxy node 748 and the actor interface 750. The overlay node instance 742 may be unloaded in a manner similar to the unloading of the generic node 602. Consequently, the run-time overlay node may be unloaded.

Based on the unloading of the overlay node template 740 and the overlay node instance 742, the processing circuitry (for example, the controller module 206, the transaction module 208, and the active node management module 216) may be configured to create an actor interface 752 that represents the run-time overlay node in the executable graph-based model 100. The actor interface 752 may be associated with the actor interfaces 746 and 750 of the overlay node template 740 and the overlay node instance 742, respectively. In some embodiments, the actor interface 752 may include a reference to the actor interface 750 of the overlay node instance 742 and the actor interface 750 may include a reference to the actor interface 746 of the overlay node template 740.

Although FIG. 7 depicts the association of a run-time overlay node only with the second generic run-time node, in other embodiments, one or more run-time overlay nodes may be associated with any other run-time node (for example, the first and third generic run-time nodes, the run-time overlay node of the second generic run-time node).

Based on the unloading of the first and second run-time nodes, the processing circuitry (for example, the controller module 206, the transaction module 208, and the active node management module 216) may be configured to unload the third generic run-time node. The third generic run-time node may be unloaded by unloading the node template 710 and the node instance 712. The processing circuitry (for example, the controller module 206, the transaction module 208, and the active node management module 216) may be configured to generate a proxy node 754 for the node template 710. The processing circuitry (for example, the controller module 206, the transaction module 208, and the active node management module 216) may be further configured to implement the proxy node 754 by way of an actor interface 756. The processing circuitry (for example, the controller module 206, the transaction module 208, and the active node management module 216) may be configured to unload the node template 710 using the proxy node 754 and the actor interface 756. The node template 710 may be unloaded in a manner similar to the unloading of the generic node 602. Similarly, the processing circuitry (for example, the controller module 206, the transaction module 208, and the active node management module 216) may be configured to generate a proxy node 758 for the node instance 712. The processing circuitry (for example, the controller module 206, the transaction module 208, and the active node management module 216) may be configured to implement the proxy node 758 by way of an actor interface 760. The processing circuitry (for example, the controller module 206, the transaction module 208, and the active node management module 216) may be configured to unload the node instance 712 using the proxy node 758 and the actor interface 760. The node instance 712 may be unloaded in a manner similar to the unloading of the generic node 602.

Based on the unloading of the third generic run-time node, the processing circuitry (for example, the controller module 206, the transaction module 208, and the active node management module 216) may be configured to create an actor interface 762 that represents the third generic run-time node in the executable graph-based model 100. The actor interface 762 may be associated with the actor interfaces 756 and 760 of the node template 710 and the node instance 712, respectively. In some embodiments, the actor interface 762 may include a reference to the actor interface 760 of the node instance 712 and the actor interface 760 may include a reference to the actor interface 756 of the node template 710.

In some embodiments, the processing circuitry (for example, the stimuli management module 212) may receive another stimulus associated with loading the node instance 704 of the first generic run-time node. The processing circuitry (for example, the controller module 206, the transaction module 208, the active node management module 216, the memory management module 218, and the storage management module 220) may be configured to load the node instance 704 based on the proxy node 718 and the actor interface 720. The loading of the node instance 704 may be performed in a manner similar to the loading of the generic node 602. Notably, the proxy node 718 may include a reference (for example, a pointer, a storage location, or the like) associated with the proxy node 714. Similarly, the actor interface 720 may include a reference (for example, a pointer, a storage location, or the like) to the actor interface 716. Therefore, based on the node instance 704 being loaded in the executable graph-based model 100, the processing circuitry (for example, the controller module 206, the transaction module 208, the active node management module 216, the memory management module 218, and the storage management module 220) may be configured to load the node template 702 based on the proxy node 714 and the actor interface 716. The loading of the node template 702 may be performed in a manner similar to the loading of the generic node 602. The node template 702 may be loaded prior to the node instance 704.

It will be apparent to a person skilled in the art that various concepts described for the loading and the unloading of the generic nodes 602-606 in conjunction with FIG. 6 may be further applicable to the loading and unloading of the first through third generic run-time nodes described in conjunction with FIG. 7.

Having discussed various concepts associated with the active nodes that may be generic run-time nodes, the description now moves towards active nodes that may be bi-directional nodes.

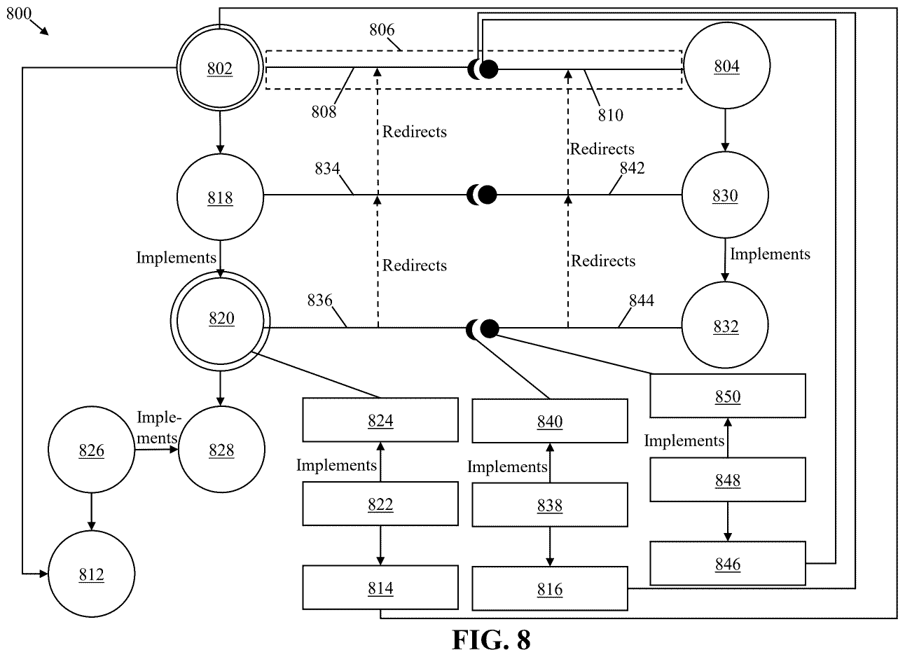

FIG. 8 illustrates a graph 800 that depicts a concept of unloading bi-directional nodes based on associated proxy nodes, consistent with disclosed embodiments of the present disclosure. Referring to FIG. 8, the graph 800 includes a plurality of active nodes including bi-directional nodes 802 and 804. Bi-directional nodes in the executable graph-based model 100 may be associated with each other by way of a plurality of connection links of the executable graph-based model 100. The plurality of connection links may include a connection link 806 that associates the bi-directional nodes 802 and 804. The connection link includes an outward connection object 808 and an inward connection object 810. The outward connection object 808 is shown to be associated with the bi-directional node 802 whereas the inward connection object 810 is shown to be associated with the bi-directional node 804. Therefore, the bi-directional node 802 may communicate with the bi-directional node 804 by way of the connection link 806.

In some embodiments, the association between the bi-directional nodes 802 and 804 may be based on the bi-directional node 802 inheriting data and/or processing logic associated with the bi-directional node 804. In some embodiments, the association between the bi-directional nodes 802 and 804 may be based on one or more operations associated with the bi-directional node 802 being dependent on the bi-directional node 804. The dependency between the bi-directional nodes 802 and 804 may be at least one of an own-owned dependency, a use-used dependency, or a share-shared dependency.

In some embodiments, when the dependency between the bi-directional nodes 802 and 804 may be the own-owned dependency, the bi-directional node 802 may own the bi-directional node 804. The bi-directional node 804 may be exclusive to the bi-directional node 802 which may exclusively use the bi-directional node 804. In other words, the bi-directional node 802 may exclusively use data and/or processing logic associated with the bi-directional node 804. In an instance, when the dependency between the bi-directional nodes 802 and 804 may be the own-owned dependency, a primary role associated with the bi-directional node 802 may be ‘own’ and a secondary role associated with the bi-directional node 804 may be ‘owned’.

In some embodiments, when the dependency between the bi-directional nodes 802 and 804 may be the use-used dependency, the bi-directional node 802 may exclusively use the bi-directional node 804 at a given time-instance. In other words, the bi-directional node 802 may exclusively use data and/or processing logic associated with the bi-directional node 804 at the given time-instance. The bi-directional node 804 may be used by another bi-directional node associated therewith at a time instance later or prior to the given time instance. In an instance, when the dependency between the bi-directional nodes 802 and 804 may be the use-used dependency, the primary role associated with the bi-directional node 802 may be ‘use’ and the secondary role associated with the bi-directional node 804 may be ‘used’.

In some embodiments, when the dependency between the bi-directional nodes 802 and 804 may be the share-shared dependency, the bi-directional node 802 may use the bi-directional node 804 while sharing the bi-directional node 804 with one or more other bi-directional nodes associated therewith. In other words, the bi-directional node 802 may use the data and/or processing logic associated with the bi-directional node 804 while sharing the bi-directional node 804 with the one or more other bi-directional nodes. In other words, the bi-directional node 804 may be simultaneously used by the bi-directional node 802 and the one or more other bi-directional nodes. In an instance, when the dependency between the bi-directional nodes 802 and 804 may be the share-shared dependency, the primary role associated with the bi-directional node 802 may be ‘share’ and the secondary role associated with the bi-directional node 804 may be ‘shared’.

Further, the bi-directional node 802 may be extended by way of one or more overlay nodes such as an overlay node 812. The overlay node 812 may be a generic overlay node or a bi-directional overlay node. Moreover, the bi-directional node 802 may be associated with a set of attributes including an attribute 814. For the sake of brevity, a single attribute is shown herein. In practical implementations, the bi-directional node 802 may be associated with additional attributes. The outward connection object 808 is also associated with a corresponding set of attributes including an attribute 816. For the sake of brevity, a single attribute is shown herein. In practical implementations, the outward connection object 808 may be associated with additional attributes. The set of attributes associated with the outward connection object 808 may be indicative of a loading strategy associated with the bi-directional node 802. The inward connection object 810 may also be associated with a corresponding set of attributes including an attribute 846 which may be indicative of a loading strategy associated with the bi-directional node 804. The loading strategy may be a proactive loading strategy or a lazy loading strategy. When loaded using the proactive loading strategy, a bi-directional node may be loaded proactively and hence gets loaded prior to a time instance of its use. When loaded using the lazy loading strategy, the loading of the bi-directional node may be deferred until a time instance of its use. In other words, the bi-directional node when loaded using the lazy loading strategy may be loaded based on a requirement thereof. The set of attributes associated with the outward connection object 808 may be accessed by the processing circuitry (for example, the memory management module 218 and the storage management module 220) of the overlay system 202 while loading the bi-directional node 802. Similarly, the set of attributes associated with the inward connection object 810 may be accessed by the processing circuitry (for example, the memory management module 218 and the storage management module 220) of the overlay system 202 while loading the bi-directional node 804.

In some embodiments, the processing circuitry (for example, the stimuli management module 212) may receive a stimulus indicative of the unloading of the bi-directional node 802. The stimulus may indicate that the bi-directional node 802 may be unloaded using a proxy node. Consequently, the processing circuitry (for example, the controller module 206, the transaction module 208, and the active node management module 216) may be configured to generate a proxy node 818 for the bi-directional node 802. The proxy node 818 may include a reference (for example, a pointer, a storage location) of a node state of the bi-directional node 802. In addition, the node state of the bi-directional node 802 may include a reference (for example, a pointer, an identifier, or the like) of one or more bi-directional nodes (for example, the bi-directional node 804) associated therewith.

The processing circuitry (for example, the controller module 206, the transaction module 208, and the active node management module 216) may be configured to implement the proxy node 818, in the executable graph-based model 100, by way of an actor interface 820. The actor interface 820 may point to the proxy node 818 and may include a description of a composition of the bi-directional node 802. The composition of the bi-directional node 802 may be indicative of constituents (for example, the set of attributes) thereof. Subsequently, the processing circuitry (for example, the controller module 206, the transaction module 208, the active node management module 216, the memory management module 218, and the storage management module 220) may be configured to unload the bi-directional node 802 using the proxy node 818 and the actor interface 820 in a manner similar to the unloading of the generic node 602.

In some embodiments, based on the unloading of the bi-directional node 802, the processing circuitry (for example, the controller module 206, the transaction module 208, the active node management module 216, the memory management module 218, and the storage management module 220) may be configured to unload the set of attributes associated therewith. The processing circuitry (for example, the controller module 206, the transaction module 208, the active node management module 216, the memory management module 218, and the storage management module 220) may be configured to generate an attribute proxy 822 for the attribute 814. The attribute proxy 822 may have a description similar to the attribute proxy 626. Subsequently, the processing circuitry (for example, the controller module 206, the transaction module 208, the active node management module 216, the memory management module 218, and the storage management module 220) may be configured to implement the attribute proxy 822, in the executable graph-based model 100, by way of an attribute actor interface 824. Subsequently, the processing circuitry (for example, the controller module 206, the transaction module 208, the active node management module 216, the memory management module 218, and the storage management module 220) may be configured to unload the attribute 814 using the attribute proxy 822 and the attribute actor interface 824 in a manner similar to the unloading of the generic node 602.

In some embodiments, based on the unloading of the bi-directional node 802, the processing circuitry (for example, the controller module 206, the transaction module 208, and the active node management module 216) may be configured to unload the overlay node 812. For unloading the overlay node 812, the processing circuitry (for example, the controller module 206, the transaction module 208, and the active node management module 216) may be configured to generate a proxy node 826 for the overlay node 812. Subsequently, the processing circuitry (for example, the controller module 206, the transaction module 208, and the active node management module 216) may be configured to implement the proxy node 826, in the executable graph-based model 100, by way of an actor interface 828. The processing circuitry (for example, the controller module 206, the transaction module 208, the active node management module 216, the memory management module 218, and the storage management module 220) may be configured to unload the overlay node 812 using the proxy node 826 and the actor interface 828 in a manner similar to the unloading of the generic node 602.

The bi-directional node 802 may include an overlay manager (for example, the overlay manager 426) configured to maintain an overlay ledger (for example, the overlay ledger 428) that includes an entry of the actor interface 828 of the overlay node 812. The entry of the actor interface 828 may be linked with a functionality of the overlay node 812. The entry of the overlay node 812 may be identified by the processing circuitry (for example, the controller module 206, the transaction module 208, and the overlay management module 236) based on the functionality linked therewith. The processing circuitry (for example, the controller module 206, the transaction module 208, and the overlay management module 236) may identify the entry of the overlay node 812 in response to a stimulus. Based on the identification of the entry of the actor interface 828, the overlay node 812 may be loaded and triggered.

The processing circuitry (for example, the controller module 206, the transaction module 208, and the active node management module 216) may be configured to traverse the connection link 806 to determine the association between the bi-directional nodes 802 and 804. Based on the determination of the association, the processing circuitry (for example, the controller module 206, the transaction module 208, and the active node management module 216) may be configured to unload the bi-directional node 804 based on the unloading of the bi-directional node 802. To unload the bi-directional node 804, the processing circuitry (for example, the controller module 206, the transaction module 208, and the active node management module 216) may be configured to generate a proxy node 830 for the bi-directional node 804. Subsequently, the processing circuitry (for example, the controller module 206, the transaction module 208, and the active node management module 216) may be configured to implement the proxy node 830, in the executable graph-based model 100, by way of an actor interface 832. The processing circuitry (for example, the controller module 206, the transaction module 208, the active node management module 216, the memory management module 218, and the storage management module 220) may be configured to unload the bi-directional node 804 using the proxy node 830 and the actor interface 832 in a manner similar to the unloading of the generic node 602.

In some embodiments, the connection link 806 may be integral to the bi-directional nodes 802 and 804. In such embodiments, the outward connection object 808 may be integral to the bi-directional node 802 and the inward connection object 810 may be integral to the bi-directional node 804.

In some embodiments, the connection link 806 may be implemented in the executable graph-based model as a bi-directional node with the role node-type 378. In such an embodiment, the outward connection object 808 and/or the inward connection object 810 may be unloaded using an outward connection object proxy 834 and an inward connection object proxy 842, respectively.

In some embodiments, the outward connection object 808 and the inward connection object 810 may be unloaded based on the unloading of the bi-directional node 802. In some instances, the inward connection object 810 may be unloaded based on the unloading of the bi-directional node 804. In some embodiments, the bi-directional node 804 may be unloaded based on the unloading of the outward connection object 808 and the inward connection object 810.

For unloading the outward connection object 808, the processing circuitry (for example, the controller module 206, the transaction module 208, and the active node management module 216) may be configured to identify the connection link 806. The identification of the connection link 806 may include identification of the outward connection object 808 and the inward connection object 810. Based on the identification of the outward connection object 808, processing circuitry (for example, the controller module 206, the transaction module 208, and the active node management module 216) may be configured to generate an outward connection object proxy 834 for the outward connection object 808. The outward connection object proxy 834 may represent the outward connection object 808 in the executable graph-based model 100. The outward connection object proxy 834 may include a reference to the outward connection object 808. Subsequently, the processing circuitry (for example, the controller module 206, the transaction module 208, and the active node management module 216) may be configured to implement the outward connection object proxy 834, in the executable graph-based model 100, by way of an outward connection object actor interface 836. The processing circuitry (for example, the controller module 206, the transaction module 208, the active node management module 216, the memory management module 218, and the storage management module 220) may be configured to unload the outward connection object 808 using the outward connection object proxy 834 and the outward connection object actor interface 836 in a manner similar to the unloading of the generic node 602.

In some embodiments, the outward connection object 808 may be associated with a dependency indicator that is indicative of a dependency between the executable bi-directional nodes 802 and 804. The outward connection object 808 may be further associated with a communication direction ‘OUT’ that is indicative of a direction of flow of a transaction associated with the transmission of the message between the executable bi-directional nodes 802 and 804. Further, the outward connection object 808 may be associated with a node identifier associated with the executable bi-directional node 804 to which the executable bi-directional node 802 may transmit messages using the outward connection object 808. Therefore, the outward connection object actor interface 836 may include a description of the dependency indicator, the direction of flow of transaction, and the identifier, associated with the outward connection object 808.

Based on the unloading of the outward connection object 808, the processing circuitry (for example, the controller module 206, the transaction module 208, the active node management module 216, the memory management module 218, and the storage management module 220) may be configured to unload the attribute 816. For unloading the attribute 816, the processing circuitry (for example, the controller module 206, the transaction module 208, and the active node management module 216) may be configured to generate an attribute proxy 838. The processing circuitry (for example, the controller module 206, the transaction module 208, and the active node management module 216) may be configured to implement the attribute proxy 838, in the executable graph-based model 100, by way of an attribute actor interface 840. Subsequently, the processing circuitry (for example, the controller module 206, the transaction module 208, the active node management module 216, the memory management module 218, and the storage management module 220) may be configured to unload the attribute 816 using the attribute proxy 838 and the attribute actor interface 840 in a manner similar to the unloading of the generic node 602.

Based on the identification of the inward connection object 810, the processing circuitry (for example, the controller module 206, the transaction module 208, and the active node management module 216) may be configured to generate an inward connection object proxy 842 for the inward connection object 810. The inward connection object proxy 842 may represent the inward connection object 810 in the executable graph-based model 100. The inward connection object proxy 842 may include a reference to the inward connection object 810. Subsequently, the processing circuitry (for example, the controller module 206, the transaction module 208, and the active node management module 216) may be configured to implement the inward connection object proxy 842, in the executable graph-based model 100, by way of an inward connection object actor interface 844. The processing circuitry (for example, the controller module 206, the transaction module 208, the active node management module 216, the memory management module 218, and the storage management module 220) may be configured to unload the inward connection object 810 using the inward connection object proxy 842 and the inward connection object actor interface 844 in a manner similar to the unloading of the generic node 602.

In some embodiments, the inward connection object 810 may be associated with a dependency indicator that is indicative of a dependency between the executable bi-directional nodes 802 and 804. The inward connection object 810 may be further associated with a communication direction ‘IN’ that is indicative of a direction of flow of a transaction associated with the transmission of the message between the executable bi-directional nodes 802 and 804. Further, the inward connection object 810 may be associated with a node identifier associated with the executable bi-directional node 802 from which the executable bi-directional node 804 may receive messages using the inward connection object 810. Therefore, the inward connection object actor interface 844 may include a description of the dependency indicator, the direction of flow of transaction, and the identifier, associated with the inward connection object 810.

In some embodiments, based on the unloading of the inward connection object 810, the processing circuitry (for example, the controller module 206, the transaction module 208, the active node management module 216, the memory management module 218, and the storage management module 220) may be configured to unload the set of attributes associated with the inward connection object 810. The processing circuitry (for example, the controller module 206, the transaction module 208, the active node management module 216, the memory management module 218, and the storage management module 220) may be configured to generate an attribute proxy 848 associated with the attribute 846. The processing circuitry (for example, the controller module 206, the transaction module 208, the active node management module 216, the memory management module 218, and the storage management module 220) may be configured to implement the attribute proxy 848 by way of an attribute actor interface 850. Subsequently, the processing circuitry (for example, the controller module 206, the transaction module 208, the active node management module 216, the memory management module 218, and the storage management module 220) may be configured to unload the attribute 846 based on the attribute proxy 848 and the attribute actor interface 850 in a manner similar to the unloading of the generic node 602.

In some embodiments, the processing circuitry (for example, the stimuli management module 212) may be configured to receive a stimulus (for example, the stimulus 230) that may be indicative of the loading of the bi-directional node 802. Based on the stimulus, the processing circuitry (for example, the stimuli management module 212) may be configured to identify the bi-directional node 802. Based on the identification of the bi-directional node 802, the processing circuitry (for example, the controller module 206, the transaction module 208, and the active node management module 216) may be configured to access the actor interface 820. Based on the actor interface 820, the processing circuitry (for example, the controller module 206, the transaction module 208, and the active node management module 216) may be configured to identify and retrieve the proxy node 818 from the primary storage. Subsequently, the processing circuitry (for example, the controller module 206, the transaction module 208, the active node management module 216, the memory management module 218, and the storage management module 220) may be configured to retrieve the node state of the bi-directional node 802 based on the reference to the node state included in the proxy node 818. The processing circuitry (for example, the controller module 206, the transaction module 208, the active node management module 216, the memory management module 218, and the storage management module 220) may be configured to load/re-generate the bi-directional node 802 in the executable graph-based model 100 based on the retrieved node state.

In some embodiments, based on the bi-directional node 802 being loaded in the executable graph-based model 100 and the attribute 814 being unloaded from the executable graph-based model 100, the processing circuitry (for example, the controller module 206, the transaction module 208, the active node management module 216, memory management module 218, and the storage management module 220) may be configured to associate the attribute actor interface 824 with the bi-directional node 802. Similarly, based on the bi-directional node 802 being loaded in the executable graph-based model 100 and the overlay node 812 being unloaded from the executable graph-based model 100, the processing circuitry (for example, the controller module 206, the transaction module 208, the active node management module 216, the memory management module 218, and the storage management module 220) may be configured to associate the actor interface 828 with the bi-directional node 802.

In some embodiments, based on the bi-directional node 802 being loaded in the executable graph-based model 100, the processing circuitry (for example, the controller module 206, the transaction module 208, the active node management module 216, the memory management module 218, and the storage management module 220) may be configured to load the attribute 814 in the executable graph-based model 100. The attribute 814 may be loaded using the attribute proxy 822 and the attribute actor interface 824 in a manner similar to the loading of the generic node 602.

In some embodiments, based on the bi-directional node 802 being loaded in the executable graph-based model 100, the processing circuitry (for example, the controller module 206, the transaction module 208, the active node management module 216, the memory management module 218, and the storage management module 220) may be configured to load the overlay node 812 in the executable graph-based model 100. The overlay node 812 may be loaded using the proxy node 826 and the actor interface 828 in a manner similar to the loading of the generic node 602.

In some embodiments, based on the bi-directional node 802 being loaded in the executable graph-based model 100, the processing circuitry (for example, the controller module 206, the transaction module 208, the active node management module 216, memory management module 218, and the storage management module 220) may be configured to load the outward connection object 808 in the executable graph-based model 100. The outward connection object 808 may be loaded using the outward connection object proxy 834 and the outward connection object actor interface 836 in a manner similar to the loading of the generic node 602. Notably, the outward connection object actor interface 836 redirects to the outward connection object proxy 834 whereas the outward connection object proxy 834 redirects to the outward connection object 808. Therefore, accessing the outward connection object actor interface 836 leads to the access of the outward connection object proxy 834. Similarly, accessing the outward connection object proxy 834 leads to access to the outward connection object 808. Notably, when the outward connection object 808 may be loaded while the inward connection object 810 may not be loaded, the outward connection object 808 may form the connection link 806 along with the inward connection object proxy 842 or the inward connection object actor interface 844.

In some embodiments, based on the loading of the outward connection object 808, the processing circuitry (for example, the controller module 206, the transaction module 208, the active node management module 216, the memory management module 218, and the storage management module 220) may be configured to load the attribute 814. The attribute 814 may be loaded using the attribute proxy 822 and the attribute actor interface 824 in a manner similar to the loading of the generic node 602.

In some embodiments, based on the loading of the outward connection object 808, the processing circuitry (for example, the controller module 206, the transaction module 208, the active node management module 216, the memory management module 218, and the storage management module 220) may be configured to load the inward connection object 810 in the executable graph-based model 100. The inward connection object 810 may be loaded using the inward connection object proxy 842 and the inward connection object actor interface 844 in a manner similar to the loading of the generic node 602. Notably, the inward connection object actor interface 844 redirects to the inward connection object proxy 842 whereas the inward connection object proxy 842 redirects to the inward connection object 810. Therefore, accessing the inward connection object actor interface 844 leads to access to the inward connection object proxy 842. Similarly, accessing the inward connection object proxy 842 leads to access to the inward connection object 810. In some embodiments, the inward connection object 810 may be loaded based on the loading of the bi-directional node 802. In some embodiments, the inward connection object 810 may be loaded based on the loading of the bi-directional node 804.

In some embodiments, based on the loading of the inward connection object 810, the processing circuitry (for example, the controller module 206, the transaction module 208, the active node management module 216, the memory management module 218, and the storage management module 220) may be configured to load the attribute 846. The attribute 846 may be loaded using the attribute proxy 848 and the attribute actor interface 850 in a manner similar to the loading of the generic node 602.

In some embodiments, based on the association with the bi-directional node 802, the processing circuitry (for example, the controller module 206, the transaction module 208, the active node management module 216, the memory management module 218, and the storage management module 220) may be configured to load the bi-directional node 804. The processing circuitry (for example, the controller module 206, the transaction module 208, the active node management module 216, the memory management module 218, and the storage management module 220) may load the bi-directional node 804 using the proxy node 830 and the actor interface 832 in a manner similar to the loading of the generic node 602.

Although not shown in FIG. 8, the bi-directional node 804 may also be extended by one or more overlay nodes (for example, generic overlay nodes and/or bi-directional overlay nodes). The overlay nodes associated with the bi-directional node 804 may be loaded and unloaded in a manner similar to the loading and the unloading of the overlay node 812.

Although not shown in FIG. 8, the bi-directional node 802 may also be associated with a corresponding set of attributes. The set of attributes associated with the bi-directional node 804 may be loaded and unloaded in a manner similar to the loading and the unloading of the attribute 814.

It will be apparent to a person skilled in the art that various concepts of loading and unloading of active nodes described in conjunction with FIGS. 6 and 7 may also be applicable to the active nodes depicted in FIG. 8.

Having discussed various concepts of loading and unloading of active nodes that may be bi-directional nodes, the description now moves towards active nodes that may be run-time bi-directional nodes (for example, the run-time bi-directional node 379).

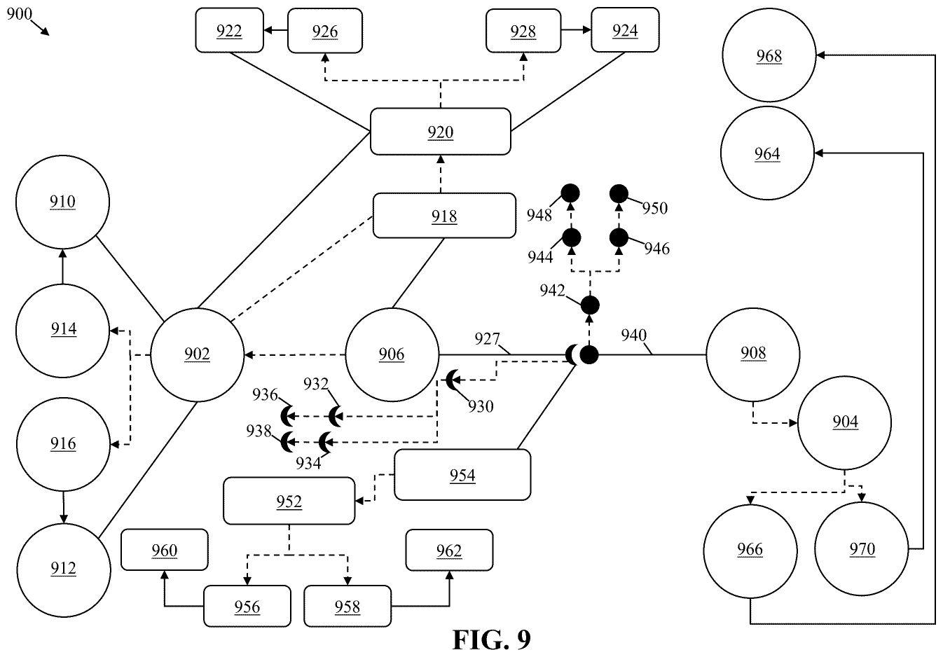

FIG. 9 illustrates a graph 900 that depicts various features of unloading of run-time bi-directional nodes based on associated proxy nodes, consistent with disclosed embodiments of the present disclosure. Referring to FIG. 9, shown are the plurality of active nodes including run-time bi-directional nodes 902 and 904 that may be coupled by way of a run-time connection link. For the sake of brevity, it may be assumed that the run-time bi-directional nodes 902 and 904 are unloaded from the executable graph-based model using corresponding proxy nodes. Also, although the proxy nodes are implemented by way of corresponding actor interfaces, for the sake of brevity, the actor interfaces are not shown herein and the graph 900 is shown to include only the proxy nodes.

When unloaded from the executable graph-based model 100, the run-time bi-directional node 902 may be represented in the executable graph-based model 100 by a proxy node 906 whereas the run-time bi-directional node 904 may be represented by a proxy node 908.

In an instance, when an actor interface associated with the proxy node 906 may be accessed, the actor interface may redirect the access to the proxy node 906, which may lead to access of the proxy node 906. Based on the proxy node 906 being accessed, the processing circuitry (for example, the memory management module 218 and the storage management module 220) may be configured to load the run-time bi-directional node 902 using the proxy node 906 and the actor interface associated therewith. The run-time bi-directional node 902 may include a node template 910 and a node instance 912. Based on the node template 910 and the node instance 912 being unloaded from the executable graph-based model 100, the run-time bi-directional node 902 may be composed of a proxy node 914 for the node template 910 and a proxy node 916 for the node instance 912. The proxy nodes 914 and 916 may be implemented by corresponding actor interfaces. For loading of the run-time bi-directional node 902, the processing circuitry (for example, the memory management module 218 and the storage management module 220) may be configured to load the node template 910 and the node instance 912 based on the proxy nodes 914 and 916, and actor interfaces associated with the proxy nodes 914 and 916, respectively.

The proxy node 906 is shown to be associated with an attribute proxy 918. Based on the run-time bi-directional node 902 being loaded in the executable graph-based model 100, the run-time bi-directional node 902 may be associated with the attribute proxy 918. The attribute proxy 918 may represent an attribute 920 associated with the run-time bi-directional node 902. The attribute 920 being an attribute of a run-time node may include an attribute template 922 and an attribute instance 924. The attribute template 922 and the attribute instance 924 may be represented in the executable graph-based model 100 by attribute template proxy 926 and attribute instance proxy 928, respectively. Based on a requirement of the attribute 920, the processing circuitry (for example, the memory management module 218 and the storage management module 220) may be configured to load the attribute 920 using the attribute proxy 918. Accessing the attribute proxy 918 may redirect the processing circuitry (for example, the controller module 206 and the transaction module 208) to the attribute 920. For loading the attribute 920, the attribute template 922 and the attribute instance 924 are required to be loaded. Therefore, the processing circuitry (for example, the memory management module 218 and the storage management module 220) may be configured to load the attribute template 922 and the attribute instance 924 using the attribute template proxy 926 and attribute instance proxy 928, respectively.

A run-time bi-directional node may be associated with another run-time bi-directional node by way of a run-time connection link. The run-time connection link may be composed of a run-time outward connection object and a run-time inward connection object. The run-time outward connection object may include an outward connection object template and an outward connection object instance. Similarly, the run-time inward connection object may include an inward connection object template and an inward connection object instance. In addition, the run-time connection link may have a description similar to the description of a connection link described in conjunction with FIG. 8.

In some instances, the run-time connection link may be unloaded from the executable graph-based model 100. For unloading the run-time connection link, the run-time outward connection object and/or the run-time inward connection object may be unloaded. The run-time outward connection object may be unloaded based on the unloading of the outward connection object template and the outward connection object instance. Similarly, the run-time inward connection object may be unloaded based on the unloading of the inward connection object template and the inward connection object instance. The processing circuitry (for example, the controller module 206, the transaction module 208, the active node management module 216, the memory management module 218, and the storage management module 220) may be configured to perform the unloading of each of the outward connection object template, the outward connection object instance, the inward connection object template, and the inward connection object instance based on generation of corresponding proxy and implementation of the corresponding proxy by way of associated actor interfaces.

As shown the proxy node 906 is associated with a run-time outward connection object proxy 927 (shown by way of a line with a half-moon end). An outward connection object/a run-time outward connection object is depicted by way of a line associated with a bi-directional node at one end and half-moon at another end. Based on the loading of the run-time bi-directional node 902, the run-time outward connection object proxy 927 may be associated with the run-time bi-directional node 902. When accessed by the processing circuitry (for example, the controller module 206, the transaction module 208, and the active node management module 216), the run-time outward connection object proxy 927 may redirect the processing circuitry (for example, the controller module 206, the transaction module 208, and the active node management module 216), to a run-time outward connection object 930 (depicted by way of a line with a half-moon end) being represented thereby. The run-time outward connection object 930 may be composed of an outward connection object template proxy 932 (depicted by way of a line with a half-moon end) and an outward connection object instance proxy 934 (depicted by way of a line with a half-moon end). The processing circuitry (for example, the controller module 206, the transaction module 208, the active node management module 216, the memory management module 218, and the storage management module 220) may be configured to load an outward connection object template 936 of the run-time outward connection object 930 using the outward connection object template proxy 932. Similarly, the processing circuitry (for example, the controller module 206, the transaction module 208, the active node management module 216, the memory management module 218, and the storage management module 220) may be configured to load an outward connection object instance 938 of the run-time outward connection object 930 using the outward connection object instance proxy 934.

The run-time outward connection object proxy 927 is shown to be associated with a run-time inward connection object proxy 940. Based on access to the run-time outward connection object proxy 927, the run-time inward connection object proxy 940 may be accessed by the processing circuitry (for example, the controller module 206, the transaction module 208, and the active node management module 216).

When accessed by the processing circuitry (for example, the controller module 206, the transaction module 208, and the active node management module 216), the run-time inward connection object proxy 940 may redirect the processing circuitry (for example, the controller module 206, the transaction module 208, and the active node management module 216), to a run-time inward connection object 942 (depicted by a circle) being represented thereby. An inward-connection object/a run-time inward connection object is depicted by a line associated with a bi-directional node at one end and a circle at another end. The inward connection object/run-time inward connection object may meet an associated outward connection object/run-time outward connection object at a connection point. The run-time inward connection object 942 may be composed of an inward connection object template proxy 944 (depicted by a circle) and an inward connection object instance proxy 946 (depicted by a circle). The processing circuitry (for example, the controller module 206, the transaction module 208, the active node management module 216, the memory management module 218, and the storage management module 220) may be configured to load an inward connection object template 948 of the run-time inward connection object 942 using the inward connection object template proxy 944. Similarly, the processing circuitry (for example, the controller module 206, the transaction module 208, the active node management module 216, the memory management module 218, and the storage management module 220) may be configured to load an inward connection object instance 950 of the run-time inward connection object 942 using the inward connection object instance proxy 946.

In some embodiments, the run-time outward connection object 930 and/or the run-time inward connection object 942 may be associated with a corresponding set of attributes indicative of a loading strategy associated with the run-time bi-directional nodes 902 and 904, respectively. For the sake of brevity, FIG. 9 depicts only the run-time outward connection object 930 to be associated with a set of attributes including an attribute 952.

The attribute 952, being unloaded from the executable graph-based model 100, may be represented by an attribute proxy 954 associated with the run-time outward connection object proxy 927. When accessed by the processing circuitry (for example, the controller module 206, the transaction module 208, and the active node management module 216), the attribute proxy 954 may redirect the processing circuitry (for example, the controller module 206, the transaction module 208, and the active node management module 216), to the attribute 952. The attribute 952 may be composed of an attribute template proxy 956 and an attribute instance proxy 958. The processing circuitry (for example, the controller module 206, the transaction module 208, the active node management module 216, the memory management module 218, and the storage management module 220) may be configured to load an attribute template 960 of the attribute 952 using the attribute template proxy 956. Similarly, the processing circuitry (for example, the controller module 206, the transaction module 208, the active node management module 216, the memory management module 218, and the storage management module 220) may be configured to load an attribute instance 962 of the attribute 952 using the attribute instance proxy 958.

It will be appreciated by a person skilled in the art that one or more attributes associated with the run-time inward connection object 942 may be loaded in a manner similar to the loading of the attribute 952.

As mentioned previously, the run-time bi-directional node 904 may have been unloaded using the proxy node 908. Therefore, an access to an actor interface of the proxy node 908 may redirect the processing circuitry (for example, the controller module 206, the transaction module 208, the active node management module 216, the memory management module 218, and the storage management module 220) to the proxy node 908. An access to the proxy node 908 may redirect the processing circuitry (for example, the controller module 206, the transaction module 208, the active node management module 216, the memory management module 218, and the storage management module 220) to the run-time bi-directional node 904 that may include a node template 964 represented by a proxy node 966 and a node instance 968 represented by a proxy node 970. The processing circuitry (for example, the memory management module 218, and the storage management module 220) may be configured to use the proxy nodes 966 and 970 to load the node template 964 and the node instance 968. The loading of the node template 964 and the node instance 968 may result in the loading of the run-time bi-directional node 904.

In some embodiments, the run-time bi-directional node 902, the run-time bi-directional node 904, the run-time outward connection object 930, and/or the run-time inward connection object 942 may be associated with one or more generic run-time overlay nodes and/or one or more run-time bi-directional overlay nodes. The one or more generic run-time overlay nodes may be loaded in a manner similar to the loading of the first through third generic run-time nodes described in conjunction with FIG. 7. The one or more run-time bi-directional node may be loaded in a manner similar to the loading of the run-time bi-directional nodes 902 and 904.

While loading a bi-directional node and/or a run-time bi-directional node, one or more associated bi-directional nodes and/or one or more run-time bi-directional nodes may also be loaded based on reference thereof included in node states of the bi-directional node and/or the run-time bi-directional node.

It will be apparent to a person skilled in the art that various concepts of loading and unloading of active nodes described in conjunction with FIGS. 6, 7, and 8 may also be applicable to the active nodes depicted in FIG. 9.

To summarize, FIGS. 6-9 describe the loading of the plurality of active nodes based on corresponding proxy nodes and actor interfaces. Such loading may be performed when one or more components (for example, a base node of the active node, one or more attributes of the active node, one or more overlay nodes associated with the active node, or the like) of the active nodes may be required to be loaded. In instances, when a logical structure of an active node may have to be loaded in its entirety, the active node may be loaded as described in conjunction with FIG. 5. The logical structure of the active node may include the base node of the active node, the one or more attributes of the active node, the one or more overlay nodes associated with the active node, or the like.

FIGS. 1-9 describe various concepts of unloading and loading the plurality of active nodes of the executable graph-based model 100. The plurality of active nodes may include the generic nodes (for example, the generic nodes 302, 602, and 604), the generic run-time nodes (for example, the generic run-time nodes 336, and the first and second generic run-time nodes described in conjunction with FIG. 7), the bi-directional nodes (for example, the bi-directional nodes 363, 802, and 804), and the run-time bi-directional nodes (for example, the run-time bi-directional nodes 379, 902, and 904). The description now moves towards a use-case scenario of the above-discussed concepts.

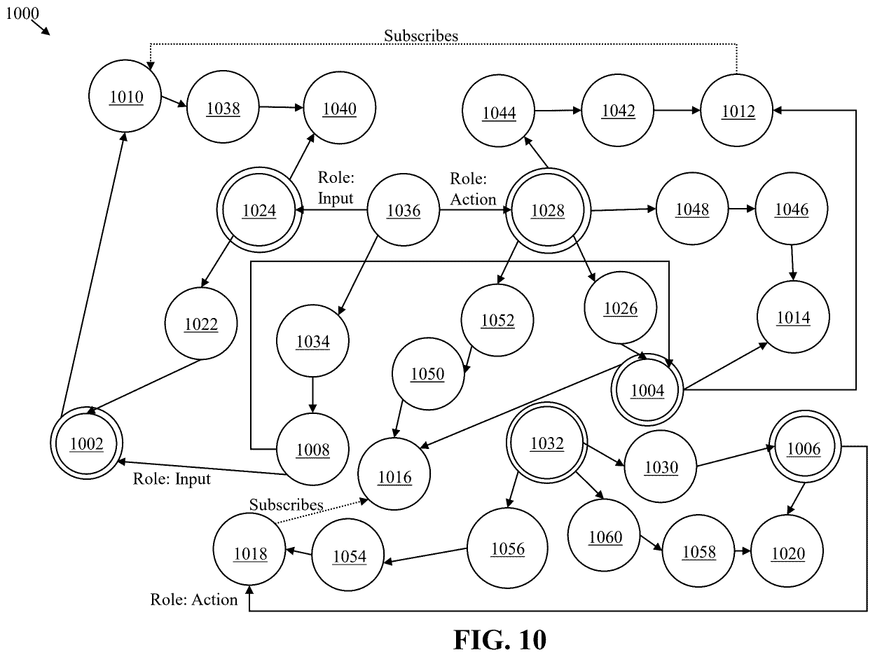

FIG. 10 illustrates a graph that depicts a security system 1000 implemented using the executable graph-based model 100, consistent with disclosed embodiments of the present disclosure. Referring to FIG. 10, shown are a plurality of active nodes that implement a plurality of components of the security system. The plurality of active nodes includes a motion detector node 1002, a camera node 1004, and an alarm node 1006 that may have the vertex node-type 328. The plurality of active nodes may further include an edge node 1008 that associates the motion detector node 1002 and the camera node 1004. The edge node 1008 may include a role ‘Input’ for the motion detector node 1002 and another role ‘Action’ for the camera node 1004. Further, the motion detector node 1002 may be extended by way of a publisher overlay node 1010, the camera node 1004 may be extended by way of a subscriber overlay node 1012, an object detector overlay node 1014, and a publisher overlay node 1016, and the alarm node 1006 may be extended by way of a subscriber overlay node 1018 and an actuator overlay node 1020.

It is assumed that each node of the plurality of active nodes of the security system 1000 may be unloaded from the executable graph-based model 100. Therefore, each node may be represented by a corresponding proxy node such that each proxy node may be implemented by way of a corresponding actor interface. Notably, an arrow from an actor interface to a proxy node indicates redirection from the actor interface to the proxy node and another arrow from the proxy node to an associated active node indicates redirection from the proxy node to the active node.

The motion detector node 1002 may be represented by way of a proxy node 1022 implemented by way of an actor interface 1024. The camera node 1004 may be represented by way of a proxy node 1026 implemented by way of an actor interface 1028. The alarm node 1006 may be represented by way of a proxy node 1030 implemented by way of an actor interface 1032. The edge node 1008 may be represented by way of a proxy node 1034 implemented by way of an actor interface 1036. The publisher overlay node 1010 may be represented by way of a proxy node 1038 implemented by way of an actor interface 1040. The subscriber overlay node 1012 may be represented by way of a proxy node 1042 implemented by way of an actor interface 1044. The object detector overlay node 1014 may be represented by way of a proxy node 1046 implemented by way of an actor interface 1048. The publisher overlay node 1016 may be represented by way of a proxy node 1050 implemented by way of an actor interface 1052. The subscriber overlay node 1018 may be represented by way of a proxy node 1054 implemented by way of an actor interface 1056. The actuator overlay node 1020 may be represented by way of a proxy node 1058 implemented by way of an actor interface 1060.

In operation, the processing circuitry (for example, the stimuli management module 212) may receive a stimulus to monitor a coverage area associated with the security system 1000. The coverage area may be an area around the security system 1000 that may be monitored by the plurality of components of the security system 1000. Based on the stimulus, the processing circuitry (for example, the memory management module 218 and the storage management module 220) may be configured to access the actor interface 1024 and identify the proxy node 1022 based on the actor interface 1024. Subsequently, the processing circuitry (for example, the memory management module 218 and the storage management module 220) may be configured to load the motion detector node 1002 based on the actor interface 1024 and the proxy node 1022 as described throughout the description. Based on the detection of a motion within the coverage area, the motion detector node 1002 may be required to publish an event of motion detection. Therefore, the processing circuitry (for example, the memory management module 218 and the storage management module 220) may be configured to access the actor interface 1040 and identify the proxy node 1038 based on the actor interface 1040. Subsequently, the processing circuitry (for example, the memory management module 218 and the storage management module 220) may be configured to load the publisher overlay node 1010 based on the actor interface 1040 and the proxy node 1038. The publisher overlay node 1010 may publish an event of motion detection.

The camera node 1004 may be required to subscribe to the event of the motion detection. Therefore, the processing circuitry (for example, the memory management module 218 and the storage management module 220) may be configured to access the actor interface 1028 and identify the proxy node 1026 based on the actor interface 1028. Subsequently, the processing circuitry (for example, the memory management module 218 and the storage management module 220) may be configured to load the camera node 1004 based on the actor interface 1028 and the proxy node 1026. The camera node 1004 may be required to subscribe to the event by way of the subscriber overlay node 1012. Therefore, the processing circuitry (for example, the memory management module 218 and the storage management module 220) may be configured to access the actor interface 1044 and identify the proxy node 1042 based on the actor interface 1044. Subsequently, the processing circuitry (for example, the memory management module 218 and the storage management module 220) may be configured to load the subscriber overlay node 1012 based on the actor interface 1044 and the proxy node 1042. The camera node 1004 may use the subscriber overlay node 1012 to subscribe to the motion detection event. Based on the motion detection event, the camera node 1004 may have to perform object detection in a video stream or images of the coverage area. Therefore, the processing circuitry (for example, the memory management module 218 and the storage management module 220) may be configured to access the actor interface 1048 and identify the proxy node 1046 based on the actor interface 1048. Subsequently, the processing circuitry (for example, the memory management module 218 and the storage management module 220) may be configured to load the object detector overlay node 1014 based on the actor interface 1048 and the proxy node 1046. The object detector overlay node 1014 may perform object detection in the coverage area. Based on the detection of an object, the camera node 1004 may be required to publish an event of object detection. Therefore, the processing circuitry (for example, the memory management module 218 and the storage management module 220) may be configured to access the actor interface 1052 and identify the proxy node 1050 based on the actor interface 1052. Subsequently, the processing circuitry (for example, the memory management module 218 and the storage management module 220) may be configured to load the publisher overlay node 1016 based on the actor interface 1052 and the proxy node 1050. The publisher overlay node 1016 may publish the event of the object detection.

The alarm node 1006 may be required to subscribe to the event of the object detection. Therefore, the processing circuitry (for example, the memory management module 218 and the storage management module 220) may be configured to access the actor interface 1032 and identify the proxy node 1030 based on the actor interface 1032. Subsequently, the processing circuitry (for example, the memory management module 218 and the storage management module 220) may be configured to load the alarm node 1006 based on the actor interface 1032 and the proxy node 1030. The alarm node 1006 may subscribe to the event by way of the subscriber overlay node 1018. Therefore, the processing circuitry (for example, the memory management module 218 and the storage management module 220) may access the actor interface 1056 and identify the proxy node 1054 based on the actor interface 1056. Subsequently, the processing circuitry (for example, the memory management module 218 and the storage management module 220) may be configured to be configured to load the subscriber overlay node 1018 based on the actor interface 1056 and the proxy node 1054. The alarm node 1006 may use the subscriber overlay node 1018 to subscribe to the object detection event. Based on the object detection event, the alarm node 1006 may be required to raise an alarm by actuating a physical alarm of the security system 1000. The physical alarm may be actuated by the actuator overlay node 1020 of the alarm node 1006. Therefore, the processing circuitry (for example, the memory management module 218 and the storage management module 220) may access the actor interface 1060 and identify the proxy node 1058 based on the actor interface 1060. Subsequently, the processing circuitry (for example, the memory management module 218 and the storage management module 220) may be configured to be configured to load the actuator overlay node 1020 based on the actor interface 1060 and the proxy node 1058. The alarm node 1006 may use the actuator overlay node 1020 to actuate the physical alarm to indicate the detection of an object within the coverage area being monitored by the security system 1000. Beneficially, the abovementioned approach of loading nodes as and when required allows for an optimal use of resources associated with the overlay system 202.

Having discussed the implementation of the executable graph-based model 100, the description now moves towards a computing system that may be used for such implementations of the executable graph-based model 100.

FIG. 11 shows an example computing system 1100 for carrying out the methods of the present disclosure, consistent with disclosed embodiments of the present disclosure. Specifically, FIG. 11 shows a block diagram of an embodiment of the computing system 1100 according to example embodiments of the present disclosure.

The computing system 1100 may be configured to perform any of the operations disclosed herein, such as, for example, any of the operations discussed with reference to the functional modules described in relation to FIG. 2. The computing system 1100 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 1100 is a distributed system configured to function using multiple computing machines interconnected via a data network or bus system.

The computing system 1100 includes computing devices (such as a computing device 1102). The computing device 1102 includes one or more processors (such as a processor 1104) and a memory 1106. The processor 1104 may be any general-purpose processor(s) configured to execute a set of instructions. For example, the processor 1104 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 1104 may be multiple processing units, a single processing core, multiple processing cores, special purpose processing cores, co-processors, or any combination thereof. The processor 1104 may be communicatively coupled to the memory 1106 via an address bus 1108, a control bus 1110, a data bus 1112, and a messaging bus 1111.

The memory 1106 may include non-volatile memories such as a read-only memory (ROM), a programable read-only memory (PROM), an erasable programmable read-only memory (EPROM), a flash memory, or any other device capable of storing program instructions or data with or without applied power. The memory 1106 may also include volatile memories, such as a random-access memory (RAM), a static random-access memory (SRAM), a dynamic random-access memory (DRAM), and a synchronous dynamic random-access memory (SDRAM). The memory 1106 may include single or multiple memory modules. While the memory 1106 is depicted as part of the computing device 1102, a person skilled in the art will recognize that the memory 1106 can be separate from the computing device 1102.

The memory 1106 may store information that can be accessed by the processor 1104. For instance, the memory 1106 (e.g., one or more non-transitory computer-readable storage mediums, memory devices) may include computer-readable instructions (not shown) that can be executed by the processor 1104. The computer-readable instructions may be software written in any suitable programming language or may be implemented in hardware. Additionally, or alternatively, the computer-readable instructions may be executed in logically and/or virtually separate threads on the processor 1104. For example, the memory 1106 may store instructions (not shown) that when executed by the processor 1104 cause the processor 1104 to perform operations such as any of the operations and functions for which the computing system 1100 is configured, as described herein. Additionally, or alternatively, the memory 1106 may store data (not shown) that can be obtained, received, accessed, written, manipulated, created, and/or stored. The data can include, for instance, the data and/or information described herein in relation to FIGS. 1-10. In some implementations, the computing device 1102 may obtain from and/or store data in one or more memory device(s) that are remote from the computing system 1100.

The computing device 1102 may further include an input/output (I/O) interface 1116 communicatively coupled to the address bus 1108, the control bus 1110, and the data bus 1112. The data bus 1112 and messaging bus 1114 may include a plurality of tunnels that may support parallel execution of messages by the overlay system 202. The I/O interface 1116 is configured to couple to one or more external devices (e.g., to receive and send data from/to one or more external devices). Such external devices, along with the various internal devices, may also be known as peripheral devices. The I/O interface 1116 may include both electrical and physical connections for operably coupling the various peripheral devices to the computing device 1102. The I/O interface 1116 may be configured to communicate data, addresses, and control signals between the peripheral devices and the computing device 1102. The I/O interface 1116 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, Fire Wire, various video buses, or the like. The I/O interface 1116 is configured to implement only one interface or bus technology. Alternatively, the I/O interface 1116 is configured to implement multiple interfaces or bus technologies. The I/O interface 1116 may include one or more buffers for buffering transmissions between one or more external devices, internal devices, the computing device 1102, or the processor 1104. The I/O interface 1116 may couple the computing device 1102 to various input devices, including mice, touch screens, scanners, biometric readers, electronic digitizers, sensors, receivers, touchpads, trackballs, cameras, microphones, keyboards, any other pointing devices, or any combinations thereof. The I/O interface 1116 may couple the computing device 1102 to various output devices, including video displays, speakers, printers, projectors, tactile feedback devices, automation control, robotic components, actuators, motors, fans, solenoids, valves, pumps, transmitters, signal emitters, lights, and so forth.

The computing system 1100 may further include a storage unit 1118, a network interface 1120, an input controller 1122, and an output controller 1124. The storage unit 1118, the network interface 1120, the input controller 1122, and the output controller 1124 are communicatively coupled to the central control unit (e.g., the memory 1106, the address bus 1108, the control bus 1110, and the data bus 1112) via the I/O interface 1116. The network interface 1120 communicatively couples the computing system 1100 to one or more networks such as wide area networks (WAN), local area networks (LAN), intranets, the Internet, wireless access networks, wired networks, mobile networks, telephone networks, optical networks, or combinations thereof. The network interface 1120 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 1118 is a computer-readable medium, preferably a non-transitory computer-readable medium, comprising one or more programs, the one or more programs comprising instructions which when executed by the processor 1104 cause the computing system 1100 to perform the method steps of the present disclosure. Alternatively, the storage unit 1118 is a transitory computer-readable medium. The storage unit 1118 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 1118 stores one or more operating systems, application programs, program modules, data, or any other information. The storage unit 1118 is part of the computing device 1102. Alternatively, the storage unit 1118 is part of one or more other computing machines that are in communication with the computing device 1102, such as servers, database servers, cloud storage, network attached storage, and so forth.

The input controller 1122 may include suitable logic, circuitry, interfaces, and/or code, executable by the circuitry, that may be configured to control one or more input devices that may be configured to receive an input (the stimulus 230) for the overlay system 202. The output controller 1124 may include suitable logic, circuitry, interfaces, and/or code, executable by the circuitry, that may be configured to control one or more output devices that may be configured to render/output the outcome of the operation executed to process the received input (the stimulus 230).

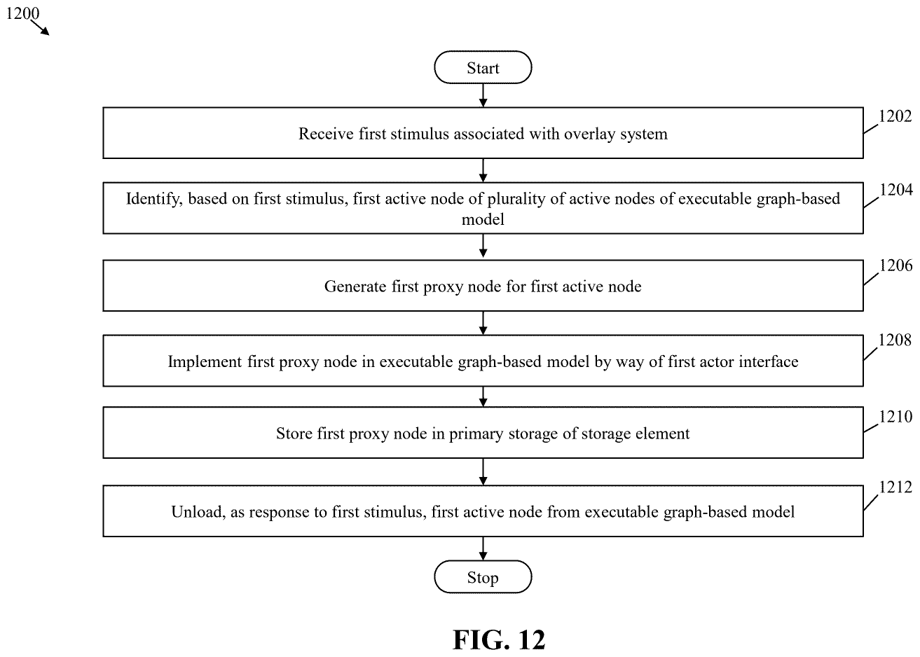

FIG. 12 illustrates a flowchart 1200 of a method of unloading a first active node based on a proxy node, consistent with disclosed embodiments of the present disclosure. Referring to FIG. 12, at 1202, a first stimulus associated with the overlay system 202 may be received. The processing logic (such as the controller module 206 and the stimuli management module 212) may receive the first stimulus associated with the overlay system 202. The first stimulus may be indicative of an operation to unload a first active node (for example, a generic node 602, the first generic run-time node, the first bi-directional node, and the first run-time bi-directional node) of the plurality of active nodes of the executable graph-based model 100 based on an associated proxy node (for example, a first proxy node).

At 1204, the first active node of the plurality of active nodes may be identified based on the stimulus. The processing circuitry (such as the controller module 206 and the stimuli management module 212) may identify the first active node of the plurality of active nodes based on a context of the first stimulus.

At 1206, the first proxy node may be generated for the first active node. The processing circuitry (for example, the controller module 206, the transaction module 208, and the active node management module 216) may be configured to generate the first proxy node for the first active node. The first proxy node may include a reference to a node state of the first active node such that the node state may be used to load/re-generate the first active node in the executable graph-based model 100. The reference may be a pointer to a storage location of the node state, a physical address of a storage location of the node state, a logical address of the storage location of the node state, or the like.

At 1208, the first proxy node may be implemented in the executable graph-based model 100 by way of a first actor interface. The first actor interface may act as a contract for the proxy node in the executable graph-based model 100. The first actor interface may include a description of the first active node. In an example, a set of attributes associated with the first active node may include metadata and a label. Therefore, the first actor interface may be indicative of the metadata and the label being included in the set of attributes associated with the first active node. In another example, the set of attributes associated with the first active node may not include an icon. Therefore, the first actor interface may be indicative of the icon being absent from the set of attributes associated with the first active node.

At 1210, the first proxy node may be stored in the primary storage of the storage element. The processing circuitry (for example, the memory management module 218 and the storage management module 220) may be configured to store the first proxy node in the primary storage of the storage element. Notably, the first proxy node being stored in the primary storage may be indicative of the first proxy node being loaded in the executable graph-based model 100.

At 1212, the first active node may be unloaded from the executable graph-based model 100 as a response to the first stimulus. The processing circuitry (for example, the memory management module 218 and the storage management module 220) may be configured to unload the first active node from the executable graph-based model 100 as the response to the first stimulus. Notably, for unloading the first active node, the first active node may be transferred from the primary storage of the storage element to the secondary storage of the storage element. Notably, storage of the first active node in the secondary storage may be indicative of the first active node being unloaded from the executable graph-based model 100.

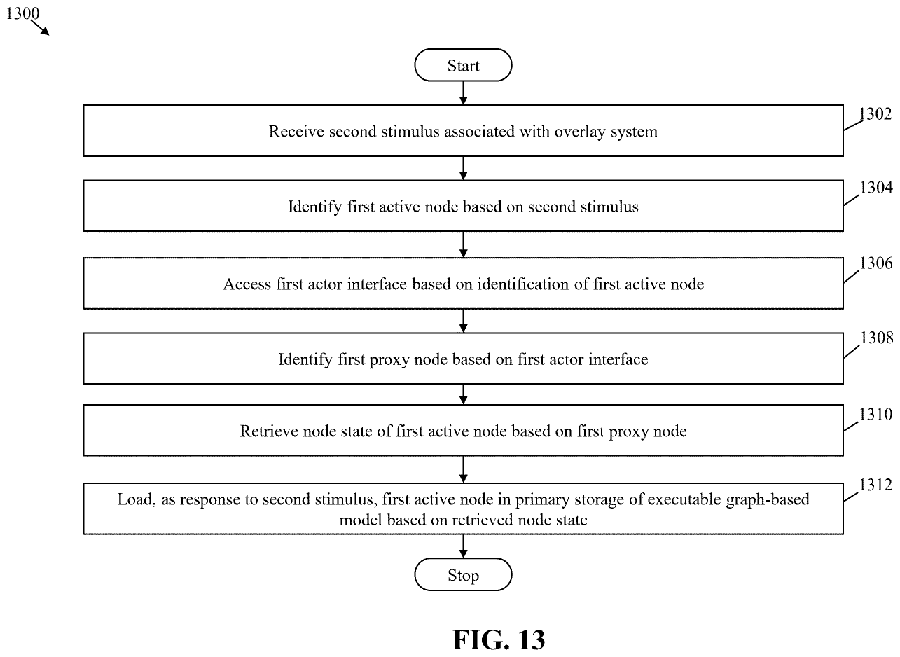

FIG. 13 illustrates a flowchart 1300 of a method of loading the first active node based on the proxy node, consistent with disclosed embodiments of the present disclosure. Referring to FIG. 13, at 1302, a second stimulus associated with the overlay system 202 may be received. The processing circuitry (such as the controller module 206 and the stimuli management module 212) may receive the second stimulus associated with the overlay system 202. The second stimulus may be indicative of an operation to load the first active node (for example, a generic node 602, the first generic run-time node, the first bi-directional node, and the first run-time bi-directional node) of the plurality of active nodes of the executable graph-based model 100.

At 1304, the first active node may be identified based on the second stimulus. The processing circuitry (such as the controller module 206 and the stimuli management module 212) may identify the first active node of the plurality of active nodes based on a context of the second stimulus.

At 1306, the first actor interface may be accessed based on the identification of the first active node. The processing circuitry (such as the controller module 206 and the stimuli management module 212) may be configured to access the first actor interface in the executable graph-based model 100, based on the identification of the first active node.

At 1308, the first proxy node associated with the first active node may be identified based on the first actor interface. The processing circuitry (for example, the controller module 206 and the transaction module 208) may identify the first proxy node based on the first actor interface. The first actor interface may implement and point to the first proxy node based on which the first proxy node may be identified.

At 1310, the node state of the first active node may be retrieved based on the first proxy node. The processing circuitry (for example, the memory management module 218 and the storage management module 220) may be configured to retrieve the node state of the first active node based on the first proxy node. The node state may be retrieved based on the reference to the node state included in the first proxy node.

At 1312, as a response to the second stimulus, the first active node may be loaded in the primary storage of the storage element of the executable graph-based model 100. The processing circuitry (for example, the memory management module 218 and the storage management module 220) may be configured to load the first active node in the primary storage as the response to the second stimulus. The loading of the first active node may be performed by transferring the first active node from the secondary storage to the primary storage.

The disclosed embodiments encompass numerous advantages including a simple and user-friendly implementation of the executable graph-based model 100 that may be in turn used to implement various complex and advanced applications. The disclosed systems and methods allow for the facilitation of active nodes in the executable graph-based model 100. The disclosed systems and methods further allow the unloading and loading of the active nodes by way of proxy nodes. Unloading an active node based on the generation of a corresponding proxy node allows the overlay system 202 to create an illusion of the active node still being loaded in the executable graph-based model 100. The proxy may be created for each component of a logical structure of the active node. Hence, the active node may be partially loaded by loading one or more desired components (for example, base node, one or more overlays, one or more attributes, or the like) of the logical structure of the active node. Also, since the proxy may be implemented by way of a corresponding actor interface which includes a description of the logical structure of the active node, the desired components of the logical structure of the active node may be identified correctly before loading. Therefore, only those components of active nodes may be loaded that may be required for the execution of one or more operations associated with the overlay system 202. Since, the proxy node includes the storage location of the node state of the associated active node, the loading time associated with the active node may be significantly reduced. Therefore, latency, wait time, processing time, and turn-around time associated with the overlay system 202 may be significantly reduced whereas throughput may be significantly increased.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for facilitating the loading and unloading of active nodes in executable graph-based models using proxy nodes. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:

1. An overlay system, comprising:
a storage element that comprises a primary storage configured to store an executable graph-based model that includes a plurality of active nodes;
processing circuitry that is coupled to the storage element, and configured to:
   receive a first stimulus associated with the overlay system;
   identify, based on the first stimulus, a first active node of the plurality of active nodes;
   generate a first proxy node for the first active node, wherein the first proxy node includes a reference to the first active node;
   implement the first proxy node in the executable graph-based model by way of a first actor interface;
   store the first proxy node in the primary storage of the storage element; and
   unload, as a response to the first stimulus, the first active node from the executable graph-based model.

2. The overlay system of 1,
wherein the reference to the first active node corresponds to a storage location of a node state of the first active node, and
wherein the node state includes data required to load the first active node in the executable graph-based model.

3. The overlay system of 1, wherein the storage element further comprises a secondary storage, and wherein the first active node is unloaded from the executable graph-based model to the secondary storage of the storage element.

4. The overlay system of 1, wherein the processing circuitry is further configured to:
receive a second stimulus associated with the overlay system, wherein the second stimulus is indicative of a loading operation;
identify the first active node associated with the second stimulus;
access the first actor interface based on the identification of the first active node;
identify the first proxy node based on the first actor interface;
retrieve a node state of the first active node based on the first proxy node; and
load, as a response to the second stimulus, the first active node in the primary storage of the executable graph-based model based on the retrieved node state.

5. The overlay system of 4, wherein the processing circuitry is further configured to:
identify a second active node that is associated with the first active node; and
load, based on the loading of the first active node, the second active node in the primary storage of the executable graph-based model.

6. The overlay system of 1,
wherein the executable graph-based model further includes a plurality of overlay nodes, and
wherein the processing circuitry is further configured to:
   identify, from the plurality of overlay nodes, a first overlay node that is associated with the first active node;
   generate a second proxy node for the first overlay node;
   implement the second proxy node in the executable graph-based model by way of a second actor interface;
   store the second proxy node in the primary storage of the storage element; and
   unload, based on the unloading of the first active node, the first overlay node from the executable graph-based model.

7. The overlay system of 6, wherein based on the first active node being loaded in the executable graph-based model, the processing circuitry is further configured to associate the first active node with the second actor interface.

8. The overlay system of 6, wherein based on the first active node being loaded in the executable graph-based model, the processing circuitry is further configured to load the first overlay node in the primary storage of the executable graph-based model using the second actor interface.

9. The overlay system of 6,
wherein the first active node is associated with an overlay manager, and
wherein the overlay manager is configured to maintain an overlay ledger including an entry for the second actor interface linked with a functionality of the first overlay node that is associated with the second proxy node.

10. The overlay system of 1,
wherein the first proxy node is associated with a node status indicator, and
wherein the node status indicator indicates one of a group consisting of (i) a storage location of a node state of the first active node which includes data required to load the first active node, or (ii) a load status indicative of the first active node being stored in the primary storage.

11. The overlay system of 10,
wherein the storage element further comprises a secondary storage,
wherein based on the storage location of the node state of the first active node being included in the node status indicator, the node status indicator indicates that the first active node is unloaded and stored in the secondary storage of the storage element, and
wherein based on the load status being included in the node status indicator, the node status indicator indicates that the first active node is loaded in the executable graph-based model.

12. The overlay system of 1, wherein the first active node corresponds to one of a group consisting of a generic node, a generic run-time node, a bi-directional node, or a run-time bi-directional node.

13. The overlay system of 1, wherein the processing circuitry is further configured to:
identify at least a first attribute associated with the first active node;
generate an attribute proxy for the first attribute;
implement the attribute proxy in the executable graph-based model by way of an attribute actor interface;
store the attribute proxy in the primary storage; and
unload, based on the unloading of the first active node, the first attribute from the executable graph-based model.

14. The overlay system of 13, wherein based on the first active node being loaded in the executable graph-based model, the processing circuitry is further configured to associate the first active node with the attribute actor interface.

15. The overlay system of 13, wherein based on the first active node being loaded in the executable graph-based model, the processing circuitry is further configured to load the first attribute in the primary storage of the executable graph-based model using the attribute actor interface.

16. The overlay system of 1, wherein the processing circuitry is further configured to:
identify, from the plurality of active nodes, a second active node that is associated with the first active node; and
unload, based on the unloading of the first active node, the second active node from the executable graph-based model.

17. The overlay system of 16,
wherein the executable graph-based model further includes a plurality of overlay nodes, and
wherein the processing circuitry is further configured to:
   identify, from the plurality of overlay nodes, a second overlay node that is associated with the second active node; and
   unload, based on the unloading of the second active node, the second overlay node from the executable graph-based model.

18. The overlay system of 16, wherein the processing circuitry is further configured to:
identify at least a second attribute associated with the second active node; and
unload, based on the unloading of the second active node, the second attribute from the executable graph-based model.

19. The overlay system of 16, wherein the first active node inherits the second active node.

20. The overlay system of 16,
wherein the first active node has a dependency with the second active node, and
wherein the dependency is one of a group consisting of an own-owned dependency, a share-shared dependency, or a use-used dependency.

21. The overlay system of 16,
wherein the first active node corresponds to a first node instance that corresponds to an implementation of a predefined node structure, and the second active node corresponds to a first node template that corresponds to the predefined node structure, and
wherein the first active node and the second active node, collectively, constitute a run-time node.

22. The overlay system of 21,
wherein the first proxy node includes a reference to a third proxy node and the first actor interface includes a reference to a third actor interface, and
wherein the third proxy node is generated for the first node template, and the third proxy node is implemented in the executable graph-based model by way of the third actor interface.

23. The overlay system of 22, wherein based on the first active node being loaded in the executable graph-based model, the processing circuitry is further configured to load the second active node in the primary storage of the executable graph-based model using the third actor interface.

24. The overlay system of 16,
wherein the executable graph-based model further includes a plurality of connection links,
wherein the first active node corresponds to a bi-directional node, and is associated with the second active node by way of a connection link, of the plurality of connection links,
wherein the connection link includes an outward connection object that is associated with the first active node and an inward connection object that is associated with the second active node,
wherein the outward connection object is indicative of a primary role associated with the first active node and the inward connection object is indicative of a secondary role associated with the second active node, and
wherein the primary role and the secondary role, collectively, indicate a capacity in which the first active node is associated with the second active node.

25. The overlay system of 24, wherein the processing circuitry is further configured to:
identify the connection link associated with the first active node;
generate an outward connection object proxy for the outward connection object, and an inward connection object proxy for the inward connection object;
implement the outward connection object proxy and the inward connection object proxy in the executable graph-based model by way of a fourth actor interface and a fifth actor interface, respectively;
store the outward connection object proxy and the inward connection object proxy in the primary storage; and
unload, based on the unloading of the first active node, the outward connection object and the inward connection object from the executable graph-based model.

26. The overlay system of 25, wherein the second active node is unloaded further based on the unloading of the outward connection object and the inward connection object.

27. The overlay system of 24,
wherein at least one of the group consisting of the outward connection object or the inward connection object is associated with a set of attributes,
wherein the set of attributes associated with the outward connection object pertains to a first loading strategy associated with the first active node,
wherein the set of attributes associated with the inward connection object pertains to a second loading strategy associated with the second active node, and
wherein the first loading strategy and second loading strategy correspond to one of a group consisting of a proactive loading strategy or a lazy loading strategy.

28. A method, comprising:
receiving, by processing circuitry of an overlay system, a stimulus associated with the overlay system, wherein an executable graph-based model is stored in a primary storage of a storage element of the overlay system, and wherein the executable graph-based model includes a plurality of active nodes;
identifying, by the processing circuitry, based on the stimulus, a first active node of the plurality of active nodes;
generating, by the processing circuitry, a proxy node for the first active node, wherein the proxy node includes a reference to the first active node;
implementing, by the processing circuitry, the proxy node in the executable graph-based model by way of an actor interface;
storing, by the processing circuitry, the proxy node in the primary storage of the storage element; and
unloading, by the processing circuitry, as a response to the stimulus, the first active node from the executable graph-based model.

1. An overlay system, comprising:
a storage element that comprises a primary storage and a secondary storage, wherein the primary storage is configured to store an executable graph-based model that includes a plurality of active nodes, and wherein
each active node is associated with a corresponding executable processing logic and a node state; and
processing circuitry coupled to the storage element, and configured to:
receive a first stimulus associated with the overlay system;
identify, based on the first stimulus, a first active node of the plurality of active nodes;
generate a first proxy node for the first active node, wherein the first proxy node includes a reference to the first active node;
execute the executable graph-based model based on the generated first proxy node, wherein for the execution of the executable graph-based model, the processing circuitry is further configured to implement the first proxy node in place of the first active node based on a first actor interface;
store the first proxy node in the primary storage of the storage element; and
unload, as a response to the first stimulus, the first active node from the executable graph-based model, wherein the unloading comprises transfer of the first active node from the primary storage to the secondary storage.

2. The overlay system of claim 1,
wherein the reference to the first active node corresponds to a storage location of the node state of the first active node,
wherein the node state includes data required to load the first active node in the executable graph-based model.

3. (canceled)

4. The overlay system of claim 1, wherein the processing circuitry is further configured to:
receive a second stimulus associated with the overlay system, wherein the second stimulus is indicative of a loading operation;
identify the first active node associated with the second stimulus;
access the first actor interface based on the identification of the first active node;
identify the first proxy node based on the first actor interface;
retrieve the node state of the first active node based on the first proxy node; and
load, as a response to the second stimulus, the first active node in the primary storage of the executable graph-based model based on the retrieved node state.

5. The overlay system of 4, wherein the processing circuitry is further configured to:
identify a second active node that is associated with the first active node; and
load, based on the loading of the first active node, the second active node in the primary storage of the executable graph-based model.

6. The overlay system of claim 1,
wherein the executable graph-based model further includes a plurality of overlay nodes, and
wherein the processing circuitry is further configured to:
identify, from the plurality of overlay nodes, a first overlay node that is associated with the first active node;
generate a second proxy node for the first overlay node;
implement the second proxy node in the executable graph-based model by way of a second actor interface;
store the second proxy node in the primary storage of the storage element; and
unload, based on the unloading of the first active node, the first overlay node from the executable graph-based model.

7. The overlay system of 6, wherein the first active node is associated with an overlay manager, and wherein the overlay manager is configured to maintain an overlay ledger including an entry for the second actor interface linked with a functionality of the first overlay node that is associated with the second proxy node.

8. The overlay system of 1. wherein the first proxy node is associated with a node status indicator, and wherein the node status indicator indicates one of a group consisting of (i) a storage location of the node state of the first active node which includes data required to load the first active node, or (ii) a load status indicative of the first active node being stored in the primary storage.

9. The overlay system of claim 8,
wherein based on the storage location of the node state of the first active node being included in the node status indicator, the node status indicator indicates that the first active node is unloaded and stored in the secondary storage of the storage element, and
wherein based on the load status being included in the node status indicator, the node status indicator indicates that the first active node is loaded in the executable graph-based model.

10. The overlay system of claim 1, wherein the processing circuitry is further configured to:
identify, from the plurality of active nodes, a second active node that is associated with the first active node;
generate an attribute proxy for the second active node;
implement the attribute proxy in the executable graph-based model by way of an attribute actor interface;
store the attribute proxy in the primary storage; and
unload, based on the unloading of the first active node, the second active node from the executable graph-based model,
wherein the unloading the second active node comprises transfer of the second active node from the primary storage to the secondary storage

11. The overlay system of claim 10, wherein based on the first active node being loaded in the executable graph-based model, the processing circuitry is further configured to load a first attribute in the primary storage of the executable graph-based model using the attribute actor interface.

12. The overlay system of claim 1, wherein the processing circuitry is further configured to:
identify, from the plurality of active nodes, a second active node that is associated with the first active node; and
unload, based on the unloading of the first active node, the second active node from the executable graph-based model.

13. The overlay system of claim 12,
wherein the first active node corresponds to a first node instance that corresponds to an implementation of a predefined node structure, and the second active node corresponds to a first node template that corresponds to the predefined node structure, and
wherein the first active node and the second active node, collectively, constitute a run-time node.

14. The overlay system of claim 13,
wherein the first proxy node includes a reference to a third proxy node and the first actor interface includes a reference to a third actor interface, and
wherein the third proxy node is generated for the first node template, and the third proxy node is implemented in the executable graph-based model by way of the third actor interface.

15. The overlay system of claim 14, wherein based on the first active node being loaded in the executable graph-based model, the processing circuitry is further configured to load the second active node in the primary storage of the executable graph-based model using the third actor interface.

16. The overlay system of claim 12,
wherein the executable graph-based model further includes a plurality of connection links,
wherein the first active node corresponds to a bi-directional node, and is associated with the second active node by way of a connection link, of the plurality of connection links,
wherein the connection link includes an outward connection object that is associated with the first active node and an inward connection object that is associated with the second active node,
wherein the outward connection object is indicative of a primary role associated with the first active node and the inward connection object is indicative of a secondary role associated with the second active node, and
wherein the primary role and the secondary role, collectively, indicate a capacity in which the first active node is associated with the second active node.

17. The overlay system of claim 16, wherein the processing circuitry is further configured to:
identify the connection link associated with the first active node;
generate an outward connection object proxy for the outward connection object, and an inward connection object proxy for the inward connection object;
implement the outward connection object proxy and the inward connection object proxy in the executable graph-based model by way of a fourth actor interface and a fifth actor interface, respectively;
store the outward connection object proxy and the inward connection object proxy in the primary storage; and
unload, based on the unloading of the first active node, the outward connection object and the inward connection object from the executable graph-based model.

18. The overlay system of claim 16, wherein the second active node is unloaded further based on the unloading of the outward connection object and the inward connection object.

19. The overlay system of claim 16,
wherein at least one of a group consisting of the outward connection object or the inward connection object is associated with a set of attributes,
wherein the set of attributes associated with the outward connection object pertains to a first loading strategy associated with the first active node,
wherein the set of attributes associated with the inward connection object pertains to a second loading strategy associated with the second active node, and
wherein the first loading strategy and the second loading strategy correspond to one of a group consisting of a proactive loading strategy or a lazy loading strategy.

20. A method, comprising:
receiving, by processing circuitry of an overlay system, a stimulus associated with the overlay system, wherein an executable graph-based model is stored in a primary storage of a storage element of the overlay system, and wherein the executable graph-based model includes a plurality of active nodes, and each active node is associated with a corresponding executable processing logic and a node state;
identifying, by the processing circuitry, based on the stimulus, a first active node of the plurality of active nodes;
generating, by the processing circuitry, a first proxy node for the first active node, wherein the first proxy node includes a reference to the first active node;
executing, by the processing circuitry, the executable graph-based model based on the generated first proxy node, wherein the execution of the executable graph-based model comprises implementing the first proxy node in place of the first active node based on a first actor interface;
storing, by the processing circuitry, the first proxy node in the primary storage of the storage element; and
unloading, by the processing circuitry, as a response to the stimulus, the first active node from the executable graph-based model, wherein the unloading comprises transferring of the first active node from the primary storage to a secondary storage of the storage element.

21. The overlay system of 6, wherein based on the first active node being loaded in the executable graph-based model, the processing circuitry is further configured to associate the first active node with the second actor interface.

22. The overlay system of 6, wherein based on the first active node being loaded in the executable graph-based model, the processing circuitry is further configured to load the first overlay node in the primary storage of the executable graph-based model using the second actor interface.

23. The overlay system of 1, wherein the first active node corresponds to one of a group consisting of a generic node, a generic run-time node, a bi-directional node, or a run-time bi-directional node.

24. The overlay system of 10, wherein based on the first active node being loaded in the executable graph-based model, the processing circuitry is further configured to associate the first active node with the attribute actor interface.

25. The overlay system of 12,
wherein the executable graph-based model further includes a plurality of overlay nodes, and
wherein the processing circuitry is further configured to:
identify, from the plurality of overlay nodes, a second overlay node that is associated with the second active node; and
unload, based on the unloading of the second active node, the second overlay node from the executable graph-based model.

26. The overlay system of 12, wherein the processing circuitry is further configured to:
identify at least a second attribute associated with the second active node; and
unload, based on the unloading of the second active node, the second attribute from the executable graph-based model.

27. The overlay system of 12, wherein the first active node inherits the second active node.

28. The overlay system of 12,
wherein the first active node has a dependency with the second active node, and
wherein the dependency is one of a group consisting of an own-owned dependency, a share-shared dependency, or a use-used dependency.
